(19) United States
(12) Patent Application Publication
(10) Pub. No.: US 2026/0307396 A1
(43) Pub. Date: Oct. 8, 2026

(54) LIQUID EJECTION HEAD AND LIQUID EJECTION APPARATUS

(71) Applicant: CANON KABUSHIKI KAISHA, Tokyo (JP)

(72) Inventors: YOSHITO FUSE, Kanagawa (JP); KOICHI KUBO, Kanagawa (JP); KAZUYA YOSHII, Kanagawa (JP); YUSHI KITASE, Kanagawa (JP); MANABU OHARA, Tokyo (JP); NAOZUMI NABESHIMA, Tokyo (JP)

(21) Appl. No.: 19/641,928

(22) Filed: Apr. 8, 2026

(30) Foreign Application Priority Data
Apr. 8, 2025 (JP) 2025-063927

(51) Int. Cl. B41J 2/18; B41J 2/15; B41J 2/175; B41J 2/19

(52) U.S. Cl. CPC B41J 2/18; B41J 2/15; B41J 2/17596; B41J 2/19; B41P 2251/10

(57) ABSTRACT

A technique capable of performing stable ejection is provided. To this end, a second pressure control chamber-side inlet of a pump inlet flow path is arranged vertically above a pump supply hole, and a first pressure control chamber-side connecting portion of a pump outlet flow path is arranged vertically above a pump discharge hole.

### BACKGROUND

### Field of the Technology

The present disclosure relates to a liquid ejection head and a liquid ejection apparatus that circulate liquid in the liquid ejection head.

### Description of the Related Art

A circulation-type liquid ejection apparatus is known that circulates liquid between a liquid ejection head and a liquid storage portion to prevent air bubbles from being discharged in a flow path and ink from being thickened near ejection ports. In the configuration of Japanese Patent Laid-Open No. 2023-90627, ink is supplied from a circulation pump to an ink chamber communicating with a nozzle, and the ink that has not been ejected is collected into the circulation pump through a pressure chamber and a second pressure-adjusting unit.

However, the liquid ejection head of Japanese Patent Laid-Open No. 2023-90627 is configured such that air bubbles generated in the pressure chamber are likely to flow into the circulation pump via the second pressure-adjusting unit. In particular, in a case where a pump that pumps liquid by changing the inner volume, such as a piezoelectric pump, is used as a circulation pump, when air bubbles flow into the pump, the pressure in the pump chamber during a pumping operation may be changed, and changes in the discharge flow rate of the pump may occur. As a result, there is a risk that the circulation flow rate in a circulation flow path is changed, and stable ejection cannot be performed.

### SUMMARY

Therefore, the present disclosure provides a technique that can perform stable ejection in a circulation-type liquid ejection head.

Therefore, a liquid ejection head of the present disclosure includes ejection ports for ejecting a liquid, a pressure chamber that communicates with the ejection port, and applies pressure to the liquid ejected from the ejection port, a first liquid reservoir chamber that communicates with the pressure chamber, a second liquid reservoir chamber that communicates with the pressure chamber at a position different from the first liquid reservoir chamber, and a pump that is arranged in a circulation path including the pressure chamber, the first liquid reservoir chamber, and the second liquid reservoir chamber, and that circulates the liquid in the circulation path, the circulation path including a first flow path connecting the pump and the first liquid reservoir chamber, and a second flow path connecting the pump and the second liquid reservoir chamber, in which in a used state of the liquid ejection head, a first connection portion connecting the first flow path and the first liquid reservoir chamber is located vertically above a second connection portion connecting the first flow path and the pump, and a third connecting portion connecting the second flow path and the second liquid reservoir chamber is located vertically above a fourth connecting portion connecting the second flow path and the pump.

According to the present disclosure, it is possible to provide a technique that can perform stable ejection.

Features of the present disclosure will become apparent from the following description of embodiments with reference to the attached drawings. The following description of embodiments is described by way of example.

### BRIEF DESCRIPTION OF THE DRAWINGS

FIG. 1A is an enlarged view of a liquid ejection head of a liquid ejection apparatus and its surroundings;

FIG. 1B is a block diagram of the liquid ejection apparatus;

FIG. 2 is a schematic diagram showing a flow path of an ink supply unit;

FIG. 3 is a schematic diagram illustrating a pressurizing operation of a pressure chamber;

FIG. 4 is a schematic diagram illustrating a pressurization maintaining operation;

FIG. 5 is a schematic diagram illustrating an ink refilling operation;

FIG. 6 is a schematic diagram illustrating a bubble-removing and depressurizing operation;

FIG. 7 is an exploded perspective view of the liquid ejection head;

FIG. 8A is a cross-sectional view of the liquid ejection head;

FIG. 8B is a cross-sectional view of an ejection module;

FIG. 9 is a schematic view showing the appearance of a circulation unit;

FIG. 10A is a vertical cross-sectional view schematically showing a circulation path;

FIG. 10B is a vertical cross-sectional view schematically showing the circulation path;

FIG. 11 is a block diagram schematically showing the circulation path shown in FIG. 10;

FIG. 12A is a cross-sectional view showing an example of a pressure-adjusting unit;

FIG. 12B is a cross-sectional view showing an example of the pressure-adjusting unit;

FIG. 12C is a cross-sectional view showing an example of the pressure-adjusting unit;

FIG. 13A is a perspective view of the appearance of a circulation pump;

FIG. 13B is a perspective view of the appearance of the circulation pump;

FIG. 14 is a cross-sectional view of the circulation pump;

FIG. 15A is a diagram illustrating the flow of ink inside the liquid ejection head;

FIG. 15B is a diagram illustrating the flow of ink inside the liquid ejection head;

FIG. 15C is a diagram illustrating the flow of ink inside the liquid ejection head;

FIG. 15D is a diagram illustrating the flow of ink inside the liquid ejection head;

FIG. 15E is a diagram illustrating the flow of ink inside the liquid ejection head;

FIG. 16A is a schematic diagram showing the circulation path;

FIG. 16B is a schematic diagram showing the circulation path;

FIG. 17 is a diagram showing an opening plate;

FIG. 18 is a diagram showing an ejection element substrate;

FIG. 19A is a cross-sectional view showing ink flow in different portions of an ejection unit;

FIG. 19B is a cross-sectional view showing ink flow in different portions of the ejection unit;

FIG. 19C is a cross-sectional view showing ink flow in different portions of the ejection unit;

FIG. 20A is a cross-sectional view showing the vicinity of an ejection port in an ejection module;

FIG. 20B is a cross-sectional view showing the vicinity of the ejection port in the ejection module;

FIG. 21A is a cross-sectional view showing an ejection module as a comparative example;

FIG. 21B is a cross-sectional view showing the ejection module as the comparative example;

FIG. 22 is a diagram showing an ejection element substrate as a comparative example;

FIG. 23A is a diagram showing a flow path configuration of the liquid ejection head;

FIG. 23B is a diagram showing the flow path configuration of the liquid ejection head;

FIG. 24A is a diagram schematically showing backflow of ink near the ejection port;

FIG. 24B is a diagram schematically showing the backflow of the ink near the ejection port;

FIG. 25A is a diagram illustrating ink supply in the ejection module;

FIG. 25B is a diagram illustrating ink supply in the ejection module;

FIG. 26 is a schematic diagram showing a connection state between the ink supply unit and the liquid ejection head;

FIG. 27A is a schematic diagram of a bubble-removing unit;

FIG. 27B is a schematic diagram of the bubble-removing unit;

FIG. 28A is a diagram showing a modification of the bubble-removing unit;

FIG. 28B is a diagram showing a modification of the bubble-removing unit;

FIG. 29 is a cross-sectional view showing a first modification of a deformation-suppressing member;

FIG. 30A is a schematic view showing another modification of the deformation-suppressing member;

FIG. 30B is a schematic view showing another modification of the deformation-suppressing member;

FIG. 30C is a schematic view showing the other modification of the deformation-suppressing member;

FIG. 31A is a schematic diagram showing an operation of an initial filling and bubble-removing unit;

FIG. 31B is a schematic diagram showing an operation of the initial filling and bubble-removing unit;

FIG. 31C is a schematic diagram showing an operation of the initial filling and bubble-removing unit;

FIG. 32 is a diagram schematically illustrating a first configuration example of an ink path;

FIG. 33 is a diagram schematically showing a first modification of a circulation path;

FIG. 34A is a diagram schematically showing the vicinity of a heating circulation pump;

FIG. 34B is a diagram schematically showing the vicinity of the heating circulation pump;

FIG. 34C is a diagram schematically showing the vicinity of the heating circulation pump;

FIG. 34D is a diagram schematically showing the vicinity of the heating circulation pump;

FIG. 35 is a diagram schematically showing a first modification of the circulation path;

FIG. 36 is a diagram schematically showing a second modification of the circulation path;

FIG. 37 is a diagram schematically showing the second modification of the circulation path;

FIG. 38 is a diagram schematically showing a third modification of the circulation path;

FIG. 39 is a diagram schematically showing the third modification of the circulation path;

FIG. 40 is a diagram schematically showing a second configuration example of the ink path;

FIG. 41 is a diagram schematically showing a fourth modification of the circulation path;

FIG. 42 is a diagram schematically showing the fourth modification of the circulation path;

FIG. 43 is a diagram schematically showing a fifth modification of the circulation path;

FIG. 44 is a diagram schematically showing the fifth modification of the circulation path;

FIG. 45 is a diagram schematically showing a sixth modification of the circulation path;

FIG. 46 is a diagram schematically showing the sixth modification of the circulation path;

FIG. 47 is a block diagram schematically showing another modification of the circulation path;

FIG. 48 is a block diagram schematically showing another modification of the circulation path;

FIG. 49 is a block diagram schematically showing another modification of the circulation path;

FIG. 50 is a schematic diagram showing the appearance of the circulation unit; and

FIG. 51 is a vertical cross-sectional view schematically showing the circulation path constituted inside the liquid ejection head.

### DESCRIPTION OF THE EMBODIMENTS

Hereinafter, preferred embodiments of the present disclosure will be described in detail with reference to the accompanying drawings. It should be noted that the following embodiments do not limit the matters of the present disclosure, and not all combinations of features described in the embodiments are necessarily essential to the solutions of the present disclosure. It should be noted that the same reference numbers are given to the same components. In the present embodiment, a description will be given of an ejection element for ejecting liquid by using an example that employs a thermal method in which air bubbles are generated by an electrothermal converting element to eject liquid, but this is not a limitation. The present embodiment can also be applied to a liquid ejection head that employs an ejection method that uses a piezoelectric element (piezo) to eject liquid, or other ejection methods. Furthermore, pumps and pressure-adjusting units that will be described below are not limited to the configurations per se described in the embodiments and the drawings. In the following description, the basic configuration of the present disclosure will be described first, and then the features of the present disclosure will be described.

### <Liquid Ejection Apparatus>

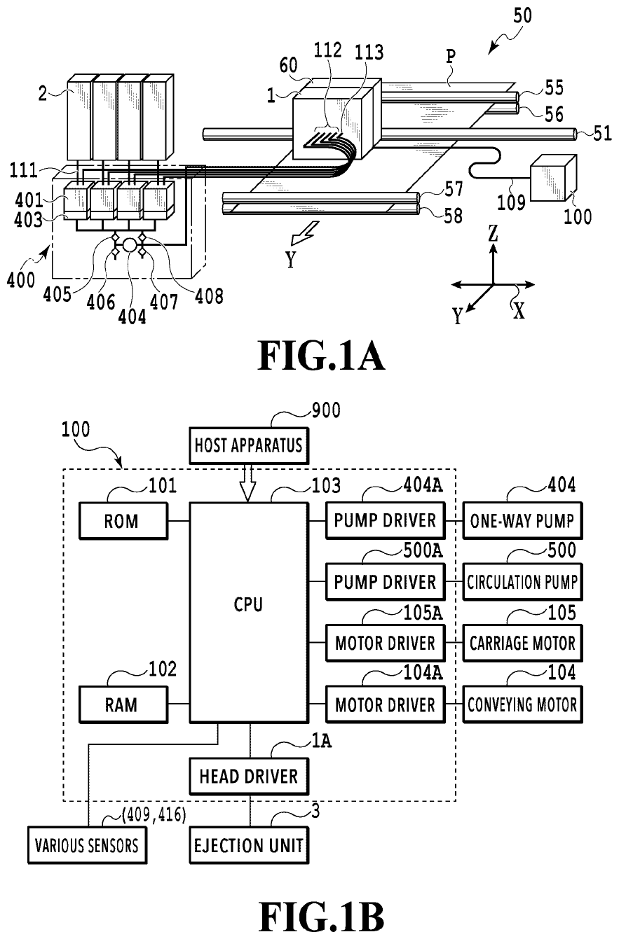

FIGS. 1A and 1B are diagrams for describing a liquid ejection apparatus, and are enlarged views of a liquid ejection head of the liquid ejection apparatus and its surroundings. First, the schematic configuration of a liquid ejection apparatus 50 according to the present embodiment will be described with reference to FIGS. 1A and 1B. FIG. 1A is a perspective view schematically showing the liquid ejection apparatus to which a liquid ejection head 1 can be mounted. The liquid ejection apparatus 50 in the present embodiment constitutes a serial-type inkjet printing apparatus that performs printing on a printing medium P by ejecting ink as liquid while scanning the liquid ejection head 1.

The liquid ejection head 1 is mounted on a carriage 60. The carriage 60 moves back and forth along a guide shaft 51 in a main scanning direction (an X direction). The printing medium P is conveyed by upstream conveying rollers 55 and 56 and downstream conveying rollers 57 and 58 in a sub-scanning direction (a Y direction) that intersects (in this example, orthogonal to) the main scanning direction. It should be noted that in each figure referred to in the following, a Z direction indicates a vertical direction, and intersects (in this example, orthogonal to) an XY plane defined by the X direction and the Y direction. The liquid ejection head 1 is configured so as to be detachable from and attachable to the carriage 60 by a user.

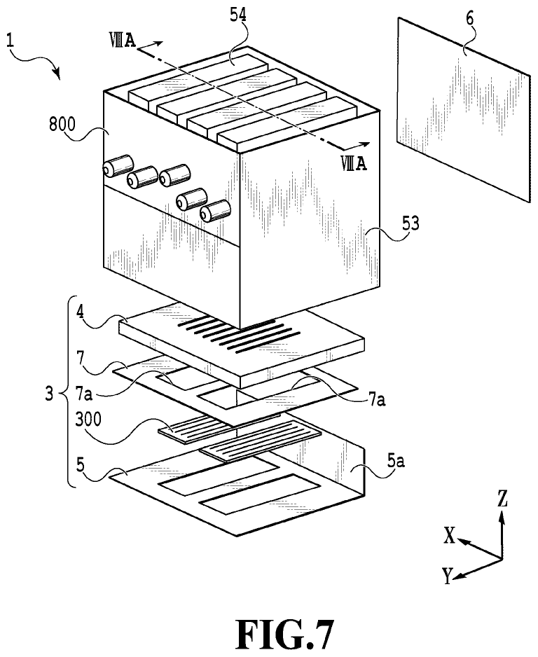

The liquid ejection head 1 is constituted by including a circulation unit 54 (refer to FIG. 7, which will be described later) and an ejection unit 3 (refer to FIG. 7, which will be described later), which will be described later. The specific configuration will be described later, but the ejection unit 3 is provided with a plurality of ejection ports and an energy-generating element (hereinafter referred to as the ejection element) that generates ejection energy for ejecting liquid from each ejection port.

In addition, the liquid ejection apparatus 50 is provided with an ink tank 2 that is an ink supply source, and an ink supply unit 400. The ink stored in the ink tank 2 is supplied to the liquid ejection head 1 by the ink supply unit 400 via a first supply path 111 and a second supply path 112. In addition, gas such as bubbles generated in the liquid ejection head 1 is discharged to the outside of the liquid ejection head 1 via a third air flow path 113 by the ink supply unit 400.

The liquid ejection apparatus 50 forms a predetermined image on the recording medium P by repeating print scanning in which the liquid ejection head 1 mounted on the carriage 60 ejects ink to perform printing while moving in the main scanning direction, and a conveying operation in which the printing medium P is conveyed in the sub-scanning direction. It should be noted that the liquid ejection head 1 in the present embodiment is capable of ejecting four types of inks, i.e., black (K), cyan (C), magenta (M), and yellow (Y), and is capable of printing full-color images using these inks. However, the inks that can be ejected from the liquid ejection head 1 are not limited to the above-described four types of ink. The present disclosure is also applicable to liquid ejection heads for ejecting other types of inks. That is, the types and number of inks ejected from the liquid ejection head are not limited. For example, the types of inks ejected from the liquid ejection head may be one, two, three, or five or more.

In addition, the liquid ejection apparatus 50 is also provided with a control unit 100 and a cap member (not shown) that can cover an ejection port surface on which the ejection ports of the liquid ejection head 1 are formed. The cap member is provided at a position offset in the X direction from a conveying path of the printing medium P in the liquid ejection apparatus 50. The cap member covers the ejection port surface of the liquid ejection head 1 during a non-print operation, and is used for preventing the ejection ports from drying out, for protecting the ejection ports, for an ink suction operation from the ejection ports, and the like. A signal that is output from the control unit 100 is transmitted to the liquid ejection head 1 and the like via a signal line 109.

FIG. 1B is a block diagram showing a control system of the liquid ejection apparatus 50. The control unit 100 of the liquid ejection apparatus 50 includes a CPU 103, a RAM 102, a ROM 101, a head driver 1A, motor drivers 104A and 105A, and pump drivers 404A and 500A. The CPU 103 functions as a control unit that controls the operation of each part of the liquid ejection apparatus 50 based on a program for processing procedures and the like stored in the ROM 101. The RAM 102 is used as a work area when the CPU 103 executes processing, and the like. The CPU 103 receives image data from a host apparatus 900 external to the liquid ejection apparatus 50 to control the head driver 1A, and controls the driving of the ejection element provided to the ejection unit 3. In addition, the CPU 103 also performs control of drivers of various actuators provided to the liquid ejection apparatus. For example, the CPU 103 controls the motor driver 104A that drives a conveying motor 104 for conveying the printing medium P. The CPU 103 controls the motor driver 105A that drives a carriage motor 105 for moving the carriage 60. The CPU 103 controls the pump driver 500A that drives a circulation pump 500, which will be described later. The CPU 103 controls the pump driver 404A that drives a one-way pump 404, which will be described later. In addition, the control unit 100 receives signals that are output from various sensors such as a volume sensor, a pressure sensor 409, and a liquid sensor 416, which will be described later. It should be noted that although FIG. 1B shows a mode in which image data received from the host apparatus 900 is processed, the liquid ejection apparatus 50 may perform processing independently of the data from the host apparatus 900.

### <Ink Supply Unit>

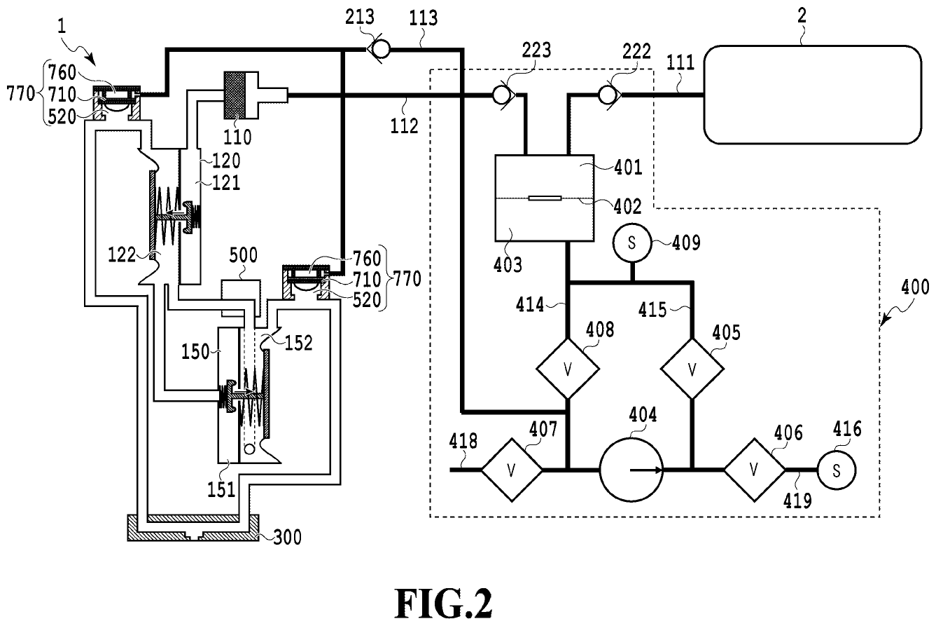

Next, the configuration of the ink supply unit 400 will be described with reference to FIG. 2. FIG. 2 is a schematic diagram showing flow paths of the ink supply unit 400. It should be noted that the flow path configurations and pump arrangements illustrated below with reference to FIGS. 2 to 49 will be described as reference examples.

The ink supply unit 400 includes an intermediate tank 401 that temporarily stores ink supplied through the first supply path 111 from the ink tank 2 that is configured to be attachable to and detachable from the liquid ejection apparatus 50. A first check valve 222 is provided in the middle of the first supply path 111, and the first check valve 222 regulates backflow of the ink from the intermediate tank 401 to the ink tank 2. At least one surface of the intermediate tank 401 is formed by a flexible membrane 402, and the inner volume of the intermediate tank 401 can be changed. The intermediate tank 401 is provided with a volume sensor (not shown). The volume sensor can detect the inner volume of the intermediate tank 401 by measuring the displacement of the flexible membrane 402. The amount of ink in the intermediate tank 401 can be estimated from a detection result of the inner volume of the intermediate tank 401 obtained by the volume sensor. The amount of ink in the intermediate tank 401 may be estimated from the detection result of the inner volume of the intermediate tank 401 obtained by the volume sensor and the amount of ink consumed by forming an image on a printing medium, suctioning ink by the cap member, and the like.

The intermediate tank 401 is in contact with a pressure chamber filled with air via the flexible membrane 402. Hereinafter, the pressure chamber of the intermediate tank 401 will be referred to as the intermediate pressure chamber 403. By changing the pressure of the gas (air) in the intermediate pressure chamber 403, the pressure of the ink stored in the intermediate tank 401 can be changed. The ink stored in the intermediate tank 401 is supplied to the liquid ejection head 1 through the second supply path 112 that is connected to the intermediate tank 401 and a filter 110 of the liquid ejection head 1. A second check valve 223 is provided in the middle of the second supply path 112, and the second check valve 223 regulates the backflow of ink from the liquid ejection head 1 to the intermediate tank 401. The ink supply unit 400 includes the one-way pump 404 driven by the pump driver 404A. The one-way pump 404 is configured using, for example, a diaphragm pump, and is capable of suctioning and squirting air in one direction when driven by the pump driver 404A.

The intermediate pressure chamber 403 and a suction side of the one-way pump 404 are connected via a first air flow path 414. A first on-off valve 408 is provided in the middle of the first air flow path 414, and communication and blockage of the first air flow path 414 can be switched by an opening or closing operation of the first on-off valve 408. The first air flow path 414 is provided with a first branch air flow path 418 that branches off between the first on-off valve 408 and the one-way pump 404, and has one end that communicates with the atmosphere. A third on-off valve 407 is provided in the first branch air flow path 418, and sealing of the suction side of the one-way pump 404 and opening of the suction side of the one-way pump 404 to the atmosphere can be switched by an opening or closing operation of the third on-off valve 407.

In addition, the intermediate pressure chamber 403 and an squirting side of the one-way pump 404 are connected via a second air flow path 415. A second on-off valve 405 is provided in the middle of the second air flow path 415, and communication and blockage of the second air flow path 415 can be switched by an opening or closing operation of the second on-off valve 405. The second air flow path 415 is provided with a second branch air flow path 419 that branches off between the second on-off valve 405 and the one-way pump 404, and has one end that communicates with the atmosphere. A fourth on-off valve 406 is provided in the second branch air flow path 419, and sealing of the squirting side of the one-way pump 404 and opening of the squirting side of the one-way pump 404 to the atmosphere can be switched by an opening or closing operation of the fourth on-off valve 406. A liquid sensor 416 is provided at an end portion of the second branch air flow path 419 that is open to the atmosphere. The liquid sensor 416 can detect the ink that has entered the air flow path. A pressure sensor 409 is provided at an arbitrary position communicating with the intermediate pressure chamber 403. The pressure sensor 409 can detect the pressure of the gas (air) in the intermediate pressure chamber 403. The one-way pump 404 and a decompression chamber 760 of a bubble-removing unit 770 in the liquid ejection head 1, which will be described later, are connected via the third air flow path 113. A third check valve 213 is provided in the middle of the third air flow path 113, and the third check valve 213 regulates backflow of gas (air) from the ink supply unit 400 to the decompression chamber 760.

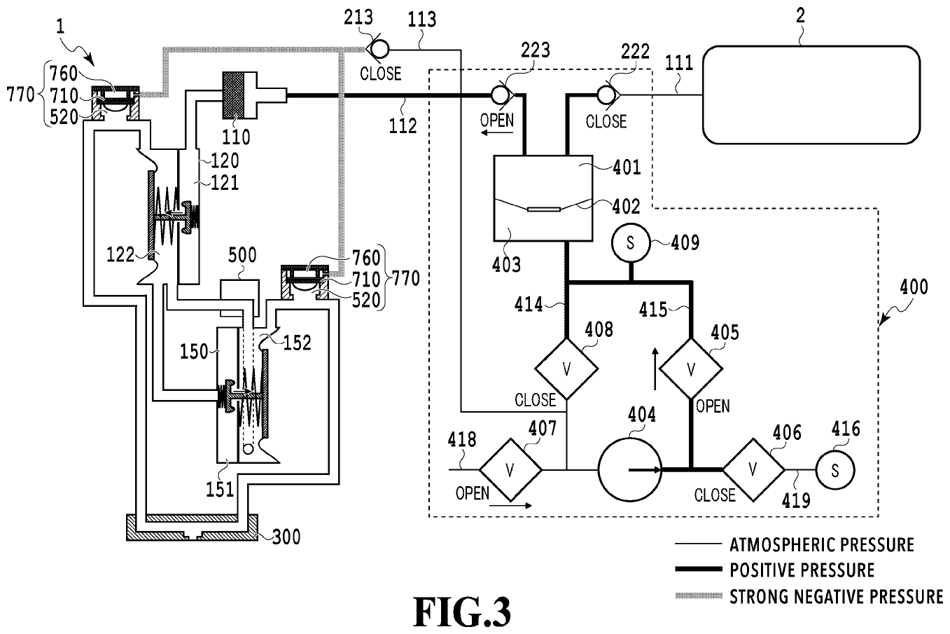

Next, the operation of the ink supply unit 400 will be described with reference to FIGS. 3 to 6. In the present embodiment, in order to perform printing on the printing medium P, the ink supply unit 400 mainly performs four operations (a pressure chamber pressurizing operation, a pressurization maintaining operation, an ink refilling operation, and a bubble-removing and depressurizing operation). It should be noted that based on the detection results of the volume sensor (not shown), the pressure sensor 409, and the like, the CPU 103 controls the one-way pump 404 and the first to fourth on-off valves to perform the pressure chamber pressurizing operation, the pressure maintaining operation, the ink refilling operation, and the bubble-removing and depressurizing operation, which will be described later.

### <Pressure Chamber Pressurizing Operation>

First, the pressure chamber pressurizing operation will be described with reference to FIG. 3. FIG. 3 is a schematic diagram illustrating the pressure chamber pressurizing operation. In the liquid ejection head 1 according to the present embodiment, since the ink is supplied under pressure, the ink can be stably ejected regardless of fluctuations in ink flow rate due to differences in the amount of ink ejected from the liquid ejection head 1, and fluctuations in ink pressure loss due to the viscosity of the ink, or the like. The pressure chamber pressurizing operation is an operation for pressurizing the intermediate pressure chamber 403 to pressurize the ink in the intermediate tank 401 via the flexible membrane 402, and to supply the pressurized ink to the liquid ejection head 1 through the second supply path 112. When the ink in the intermediate tank 401 is consumed, and the inner volume of the intermediate pressure chamber 403 that is in contact with the intermediate tank 401 via the flexible membrane 402 is increased, the pressure of the gas in the intermediate pressure chamber 403 is decreased. In addition, after the pressure of the gas in the intermediate pressure chamber 403 is reduced during the ink refilling operation, which will be described later, when the first on-off valve 408 and the third on-off valve 407 are opened so that the intermediate pressure chamber 403 is opened to the atmosphere, the pressure of the gas in the intermediate pressure chamber 403 becomes atmospheric pressure. When the pressure of the gas in the intermediate pressure chamber 403 becomes low, or when the pressure of the gas in the intermediate pressure chamber 403 becomes atmospheric pressure, the pressure chamber pressurizing operation is required. The pressure of the gas in the intermediate pressure chamber 403 is monitored by the pressure sensor 409, and the pressure of the gas in the intermediate pressure chamber 403 is lower than a predetermined pressure required for stable ejection by the liquid ejection head 1, the ink supply unit 400 performs the pressure chamber pressurizing operation. During the pressure chamber pressurizing operation, the ink supply unit 400 drives the one-way pump 404 to increase the pressure of the gas in the intermediate pressure chamber 403, with the first on-off valve 408 in a closed state, the second on-off valve 405 in an open state, the third on-off valve 407 in an open state, and the fourth on-off valve 406 in a closed state. When the pressure of the gas in the intermediate pressure chamber 403 is increased, since the ink in the intermediate tank 401 is pressurized via the flexible membrane 402, and the ink in the second supply path 112 is pressurized via the second check valve 223, the ink can be supplied under pressure to the liquid ejection head 1. The pressure of the gas in the intermediate pressure chamber 403 is monitored by the pressure sensor 409, and when the pressure of the gas in the intermediate pressure chamber 403 is equal to or greater than a predetermined pressure, the ink supply unit 400 stops driving of the one-way pump 404. During this time, since the decompression chamber 760 is closed by the third check valve 213, the pressure inside the decompression chamber 760 is maintained at a low pressure (negative pressure).

### <Pressurization Maintaining Operation>

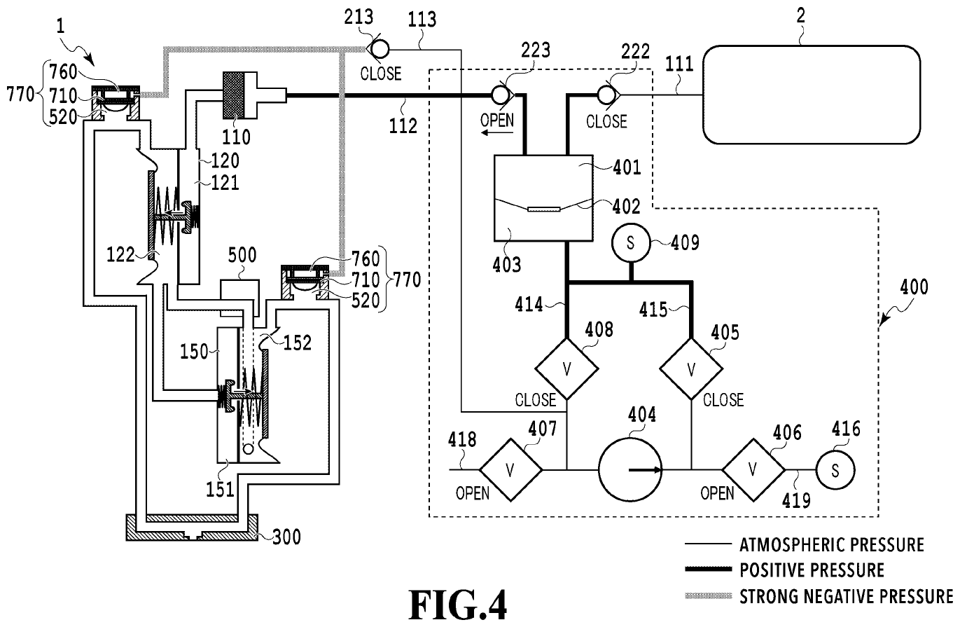

Next, the pressurization maintaining operation will be described with reference to FIG. 4. FIG. 4 is a schematic diagram illustrating the pressurization maintaining operation. The pressurization maintaining operation is an operation for maintaining the pressure of the gas in the intermediate pressure chamber 403 that has been increased by the pressure chamber pressurizing operation at a high level. When printing on a printing medium is performed, when the pressure of the gas in the intermediate pressure chamber 403 is equal to or greater than the predetermined pressure, the ink supply unit 400 performs the pressurization maintaining operation. In addition, in a case where the pressure of the gas in the intermediate pressure chamber 403 remains high when starting the next printing, the next printing can be started earlier without performing the pressure chamber pressurizing operation. Accordingly, it is desirable to maintain the pressure of the gas in the intermediate pressure chamber 403 at a high level. Therefore, even in a stand-by time during which no printing is being performed on the priming medium, when the pressure of the gas in the intermediate pressure chamber 403 is equal to or greater than the predetermined pressure, the ink supply unit 400 performs the pressurization maintaining operation. After the pressure chamber pressurization operation is performed, when the pressure of the gas in the intermediate pressure chamber 403 is equal to or greater than the predetermined pressure, the ink supply unit 400 switches the first on-off valve 408 to the closed state and the second on-off valve 405 to the closed state as the pressurization maintaining operation. At this time, the third on-off valve 407 and the fourth on-off valve 406 may be in the closed state or in the open state. Accordingly, the pressure of the gas in the intermediate pressure chamber 403 that has been increased by the pressure chamber pressurizing operation can be maintained at a high pressure. Thereafter, the pressure fluctuations due to the inner volume change in the intermediate pressure chamber 403 is monitored by the pressure sensor 409, and when the pressure of the gas in the intermediate pressure chamber 403 is lower than the predetermined pressure, the ink supply unit 400 performs the pressure chamber pressurizing operation again. During this time, since the decompression chamber 760 is closed by the third check valve 213, the pressure inside the decompression chamber 760 is maintained at a low pressure (negative pressure).

### <Ink Refilling Operation>

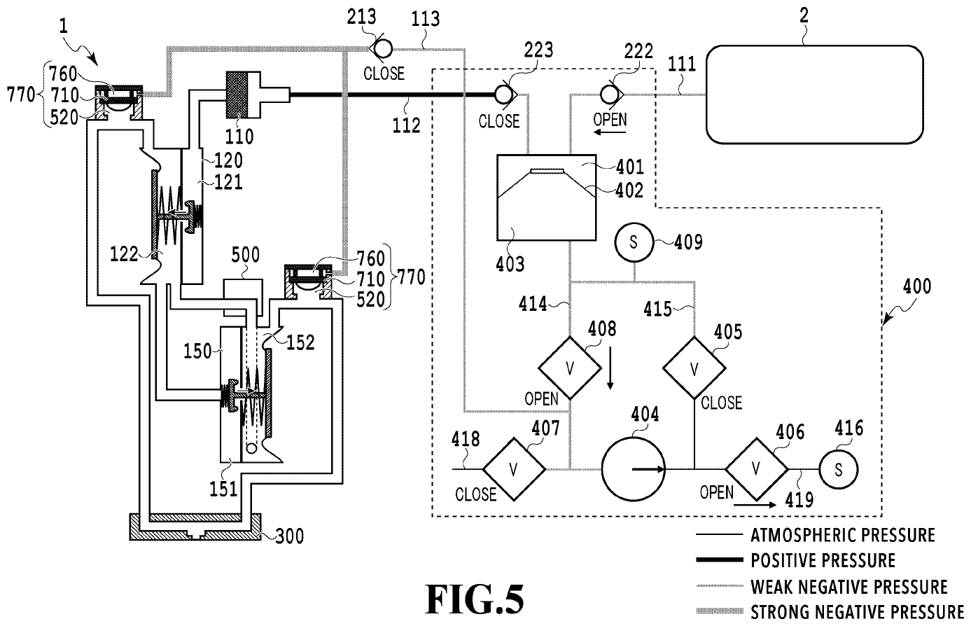

Next, the ink refilling operation will be described with reference to FIG. 5. FIG. 5 is a schematic diagram illustrating the ink refilling operation. The ink refilling operation is an operation in which the ink stored in the ink tank 2 is drawn into the intermediate tank 401 via the first supply path 111 when the amount of ink in the intermediate tank 401 decreases below an amount of ink sufficient for performing printing. Based on the detection result of the inner volume of the intermediate tank 401 obtained by the volume sensor (not shown), when the amount of ink in the intermediate tank 401 is less than a predetermined amount of ink sufficient for performing printing, the ink supply unit 400 performs the ink refilling operation. During ink refilling operation, the ink supply unit 400 operates the one-way pump 404 to reduce the pressure of the gas in the intermediate pressure chamber 403 with the first on-off valve 408 in the opened state, the second on-off valve 405 in the closed state, the third on-off valve 407 in the closed state, and the fourth on-off valve 406 in the opened state. When the pressure of the gas in the intermediate pressure chamber 403 is decreased, the pressure of the ink in the intermediate tank 401 is decreased via the flexible membrane 402. By setting the ink pressure in the intermediate tank 401 to a low pressure (negative pressure), the ink stored in the ink tank 2 can be drawn into the intermediate tank 401 via the first supply path 111. Based on the detection result of the inner volume of the intermediate tank 401 obtained by the volume sensor, when the amount of ink in the intermediate tank 401 is equal to or greater than the predetermined amount of ink, the ink supply unit 400 stops driving of the one-way pump 404. Furthermore, the ink supply unit 400 opens the first on-off valve 408 and the third on-off valve 407 so that the intermediate pressure chamber 403 is opened to the atmosphere, and drawing of the ink into the intermediate tank 401 is stopped. After opening the intermediate pressure chamber 403 to the atmosphere, the ink supply unit 400 performs the above-described pressure chamber pressurizing operation to increase the pressure of the gas in the intermediate pressure chamber 403 from atmospheric pressure. During this time, since the decompression chamber 760 is closed by the third check valve 213, the pressure inside the decompression chamber 760 is maintained at a low pressure (negative pressure).

### <Bubble-Removing and Depressurizing Operation>

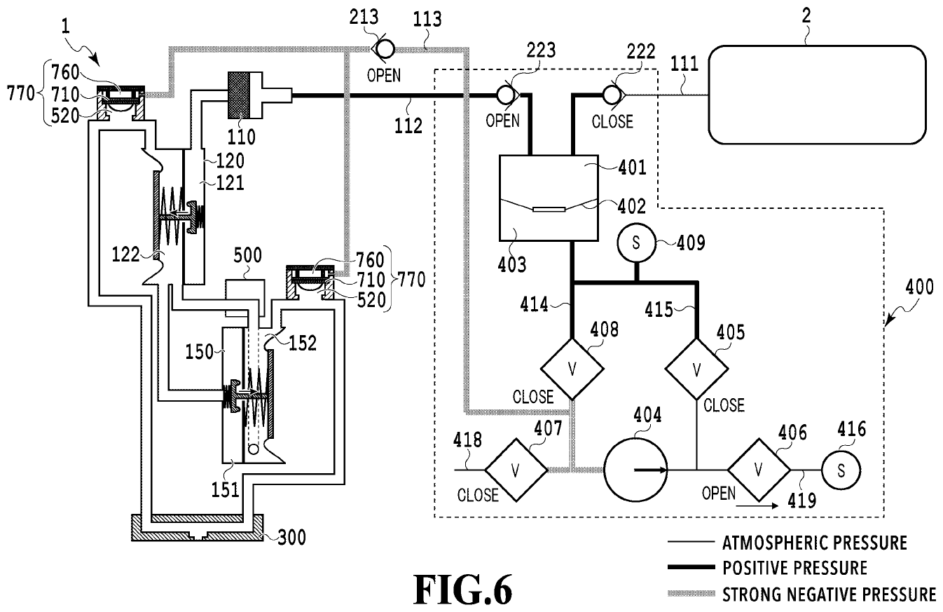

Next, the bubble-removing and depressurizing operation will be described with reference to FIG. 6. FIG. 6 is a schematic diagram illustrating the bubble-removing and depressurizing operation. The bubble-removing and depressurizing operation is an operation for reducing the pressure inside the decompression chamber 760. The moving speed at which gas moves from a bubble reservoir chamber 520 of the bubble-removing unit 770 in the liquid ejection head 1 through a gas-permeable membrane 710 to the decompression chamber 760 is proportional to the difference between the pressure in the bubble reservoir chamber 520 and the pressure in the decompression chamber 760. Therefore, it is desirable that the pressure inside the decompression chamber 760 be maintained at a low pressure. The third check valve 213 provided in the middle of the third air flow path 113 regulates the flow of gas from the third air flow path 113 into the decompression chamber 760. However, due to the inflow of gas from the bubble reservoir chamber 520 through the gas-permeable membrane 710 and the inflow of gas that slightly permeates a member that constitutes the decompression chamber 760, the pressure inside the decompression chamber 760 is gradually increased over time. When the pressure inside the decompression chamber 760 is gradually increased over time in this manner, the bubble-removing and depressurizing operation to reduce the pressure inside the decompression chamber 760 is required. When it is estimated that the pressure inside the decompression chamber 760 is more than the predetermined pressure based on the time elapsed since the previous bubble-removing and depressurizing operation, the ink supply unit 400 performs the bubble-removing and depressurizing operation. During the bubble-removing and depressurizing operation, the ink supply unit 400 drives the one-way pump 404 to reduce the pressure in the decompression chamber 760 with the first on-off valve 408 in the closed state, the second on-off valve 405 in the closed state, the third on-off valve 407 in the closed state, and the fourth on-off valve 406 in the open state. When a predetermined time elapses after the one-way pump 404 is driven, and it is estimated that the pressure inside the decompression chamber 760 has become the predetermined pressure or less, the ink supply unit 400 stops driving of the one-way pump 404. During this time, since the first on-off valve 408 and the second on-off valve 405 are closed, the pressure of the gas in the intermediate pressure chamber 403 is maintained at a positive pressure. After the bubble-removing and depressurizing operation, even if the pressure in the intermediate pressure chamber 403 and the first to third air flow paths fluctuates due to the pressure chamber pressurizing operation, the pressurization maintaining operation, the ink refilling operation, and the like described above, the pressure in the decompression chamber 760 is maintained at a low pressure (negative pressure) since the third check valve 213 is closed. The bubble-removing and depressurizing operation in the present embodiment is performed once a day. However, this is not a limitation, and the frequency of the bubble-removing and depressurizing operation may be increased, for example, after delivery or after cleaning, when bubbles are likely to be generated. The frequency of the bubble-removing and depressurizing operation may be reduced over time after delivery or after cleaning. In addition, the frequency of the bubble-removing and depressurizing operation may be changed depending on the temperature, the state of use, and the like.

### <Liquid Ejection Head>

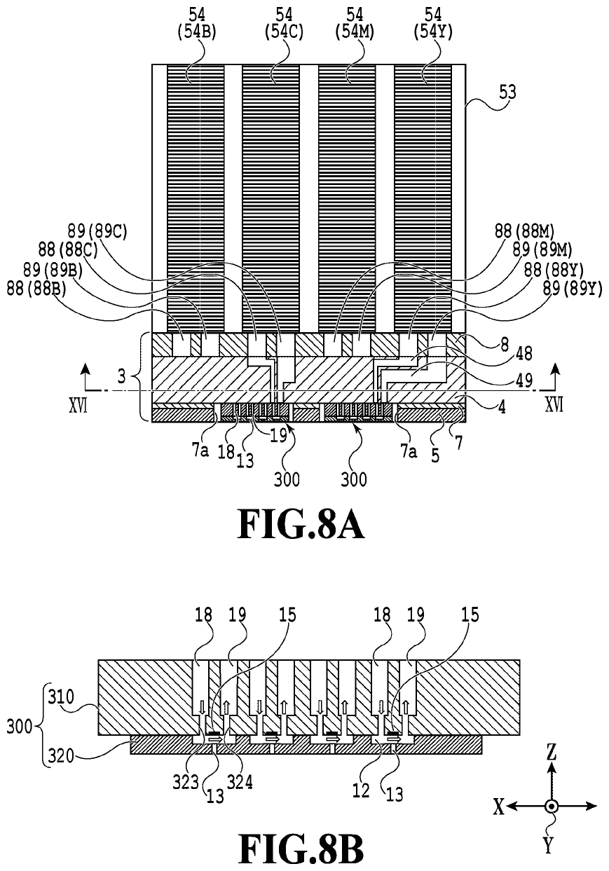

FIG. 7 is an exploded perspective view of the liquid ejection head 1 in the present embodiment. FIG. 8A is a cross-sectional view of the liquid ejection head 1, and FIG. 8B is a cross-sectional view of an ejection module 300. In addition, FIG. 8A is a cross-sectional view of the liquid ejection head 1 shown in FIG. 7 taken along line VIIIA-VIIIA. FIG. 8B is an enlarged cross-sectional view of the ejection module 300 shown in FIG. 8A. Hereinafter, the basic configuration of the liquid ejection head 1 according to the present embodiment will be described mainly with reference to FIGS. 7, 8A, and 8B, and also with reference to FIG. 1A as appropriate.

As shown in FIG. 7, the liquid ejection head 1 includes the circulation unit 54 and the ejection unit 3 for ejecting ink supplied from the circulation unit 54 onto the printing medium P. The liquid ejection head 1 in the present embodiment is fixedly supported on the carriage 60 of the liquid ejection apparatus 50 by a positioning device and electrical contacts (not shown) provided to the carriage 60. The liquid ejection head 1 ejects ink while moving together with the carriage 60 in the main scanning direction (the X direction) shown in FIG. 1A, and performs printing on the printing medium P.

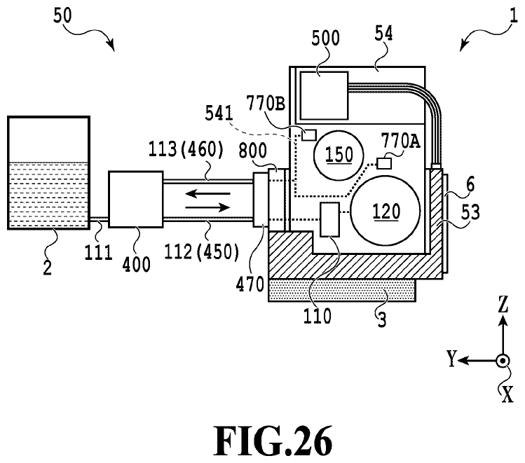

The ink supply unit 400 connected to the ink tank 2 serving as an ink supply source (liquid supply source) is provided with the first supply path 111 and the second supply path 112. A main body-side connecting member 470 (refer to FIG. 26) is provided at a tip of the second supply path 112. When the liquid ejection head 1 is mounted on the liquid ejection apparatus 50, the main body-side connecting member 470 provided at the tip of the second supply path 112 is detachably connected to a head-side connecting member 800 provided to a head housing 53 of the liquid ejection head 1. Accordingly, an ink supply path (the first supply path 111 and the second supply path 112) from the ink tank 2 through the ink supply unit 400 to the liquid ejection head 1 is formed. In the present embodiment, since the four types of inks are used, four sets of ink tanks 2, first supply paths 111, second supply paths 112, and circulation units 54 are provided corresponding to the respective inks, and four ink supply paths corresponding to the respective inks are formed independently. As described above, the liquid ejection apparatus 50 in the present embodiment is provided with an ink supply system to which the inks are supplied from the ink tanks 2 provided outside the liquid ejection head 1.

As shown in FIG. 8A, a circulation unit 54B for black ink, a circulation unit 54C for cyan ink, a circulation unit 54M for magenta ink, and a circulation unit 54Y for yellow ink are provided as the circulation units 54. Each circulation units has substantially the same configuration, and in the present embodiment, when there is no need to particularly distinguish between the circulation units, they will all be written as the circulation unit 54. It should be noted that the liquid ejection head 1 shown in FIG. 8A shows an example in which the liquid ejection head 1 is provided with the four circulation units 54 corresponding to the four types of inks, but the liquid ejection head 1 may be provided with circulation units 54 corresponding to the types of liquid to be ejected. In addition, a plurality of circulation units 54 may be provided for the same type of liquid. That is, the liquid ejection head 1 can be configured to include one or more circulation units. It is also possible to have a configuration in which at least one ink is circulated, without circulating all four types of inks.

In FIGS. 7 and 8A, the ejection unit 3 includes two ejection modules 300, a first support member 4, a second support member 7, an electric wiring member (electric wiring tape) 5, and an electric contact substrate 6. As shown in FIG. 8B, the ejection module 300 includes a silicon substrate 310 having a thickness of 0.5 mm to 1 mm, and a plurality of ejection elements 15 provided on one surface of the silicon substrate 310. The ejection elements 15 in the present embodiment are constituted by electrothermal conversion elements (heaters) that generate thermal energy as ejection energy for ejecting liquid. Electric power is supplied to each ejection element 15 via electrical wiring formed on the silicon substrate 310 by a film deposition technique.

In addition, an ejection port forming member 320 is formed on a surface (a lower surface in FIG. 8B) of the silicon substrate 310. In the ejection port forming member 320, a plurality of pressure chambers 12 and a plurality of ejection ports 13 for ejecting inks are formed by the photolithography technique so as to correspond to the plurality of ejection elements 15. Furthermore, common supply flow paths 18 and common collecting flow paths 19 are formed in the silicon substrate 310. In addition, the silicon substrate 310 is formed with supply connection flow paths 323 that each communicate a corresponding one of the common supply flow paths 18 to a corresponding one of the pressure chambers 12, and collecting connection flow paths 324 that each communicate a corresponding one of the common collecting flow paths 19 to a corresponding one of the pressure chambers 12. In the present embodiment, a single ejection module 300 is configured to eject two types of inks. That is, of the two ejection modules shown in FIG. 8A, the ejection module 300 located on the left side of the figure ejects a black ink and a cyan ink, and the ejection module 300 located on the right side of the figure ejects a magenta ink and a yellow ink. It should be noted that this combination is an example, and inks may be combined in any manner. A single ejection module may be configured to eject one type of ink, or may be configured to eject three or more types of inks. The two ejection modules 300 may not eject the same number of types of inks. The configuration may include one ejection module 300, or may include three or more ejection modules 300. Furthermore, in the example shown in FIG. 8A, two ejection port arrays extending in the Y direction are formed for one color of ink. The pressure chamber 12, the common supply flow path 18, and the common collecting flow path 19 are formed for each of the plurality of ejection ports 13 that constitute the ejection port arrays.

An ink supply port and an ink-collecting port, which will be described later, are formed on a rear surface (an upper surface in FIG. 8B) side of the silicon substrate 310. The ink supply port supplies ink from an ink supply flow path 48 to the plurality of common supply flow paths 18, and the ink-collecting port collects ink from the plurality of common collecting flow paths 19 to an ink-collecting flow path 49.

It should be noted that the ink supply port and the ink-collecting port described here refer to openings that supply and collect ink during forward direction ink circulation, which will be described later. That is, during the forward direction ink circulation, ink is supplied from the ink supply ports to each common supply flow path 18, and the ink is collected from each common collecting flow path 19 to the ink-collecting port. However, there are also cases where ink is circulated in the opposite direction. In this case, ink is supplied from the ink-collecting port described above to the common collecting flow path 19, and the ink is collected from the common supply flow path 18 to the ink supply port.

As shown in FIG. 8A, the ejection module 300 has its rear surface (an upper surface in FIG. 8A) adhesively fixed to one surface (a lower surface in FIG. 8A) of the first support member 4. The first support member 4 is formed with the ink supply flow path 48 and the ink-collecting flow path 49 that penetrate from its one surface to the other surface. One opening of the ink supply flow path 48 communicates with the above-described ink supply port in the silicon substrate 310, and one opening of the ink-collecting flow path 49 communicates with the above-described ink-collecting port in the silicon substrate 310. It should be noted that the ink supply flow path 48 and the ink-collecting flow path 49 are independently provided for each type of ink.

In addition, the second support member 7 having openings 7a (refer to FIG. 7) through which the ejection modules 300 are inserted, respectively, is adhesively fixed to the one surface (the lower surface in FIG. 8A) of the first support member 4. The second support member 7 holds an electrical wiring member 5 that is electrically connected to the ejection modules 300. The electrical wiring member 5 is a member for applying an electrical signal to the ejection modules 300 for ejecting ink. An electrical connection portion between the ejection module 300 and the electrical wiring member 5 is sealed with a sealant (not shown), and is protected from corrosion by ink and external impacts.

In addition, the electrical contact substrate 6 is thermocompression bonded to an end portion 5a (refer to FIG. 7) of the electrical wiring member 5 by using an anisotropic conductive film that is not shown, and the electrical wiring member 5 and the electrical contact substrate 6 are electrically connected. The electrical contact substrate 6 includes an external signal input terminal (not shown) for receiving an electrical signal from the liquid ejection apparatus 50.

Furthermore, a joint member 8 (refer to FIG. 8A) is provided between the first support member 4 and the circulation unit 54. The joint member 8 is formed with a supply port 88 and a collecting port 89 for each type of ink. The supply port 88 and the collecting port 89 communicate the ink supply flow path 48 and the ink-collecting flow path 49 of the first support member 4 to the flow paths formed in the circulation unit 54. It should be noted that in FIG. 8A, a supply port 88B and a collecting port 89B correspond to the black ink, and a supply port 88C and a collecting port 89C correspond to the cyan ink. In addition, a supply port 88M and a collecting port 89M correspond to the magenta ink, and a supply port 88Y and a collecting port 89Y correspond to the yellow ink.

It should be noted that the openings at one end portions of the ink supply flow path 48 and the ink-collecting flow path 49 of the first support member 4 have small opening areas that match the ink supply port and the ink-collecting port in the silicon substrate 310, respectively. In contrast, the openings at the other end portions of the ink supply flow path 48 and the ink-collecting flow path 49 of the first support member 4 have shapes that are enlarged to the same opening area as the large opening area of the joint member 8 formed to match the flow path of the circulation unit 54. By adopting such a configuration, it is possible to suppress an increase in flow path resistance for ink collected from each collecting flow path. However, the shapes of the openings at the one end portion and the other end portion of each of the ink supply flow path 48 and the ink-collecting flow path 49 are not limited to the above example.

In the liquid ejection head 1 having the above-described configuration, the ink supplied to the circulation unit 54 passes through the supply port 88 of the joint member 8 and the ink supply flow path 48 of the first support member 4, and flows into the common supply flow path 18 from the ink supply port of the ejection module 300. Subsequently, the ink flows from the common supply flow path 18 through the supply connection flow path 323 into the pressure chamber 12, and a part of the ink that has flowed into the pressure chamber is ejected from the ejection port 13 by driving the ejection element 15. The remaining ink that has not been ejected flows from the pressure chamber 12 through the collecting connection flow path 324 and the common collecting flow path 19 and flows into the ink-collecting flow path 49 of the first support member 4 from the ink-collecting port. Then, the ink that has flowed into the ink-collecting flow path 49 flows into the circulation unit 54 through the collecting port 89 of the joint member 8, and is collected.

### <Components of Circulation Unit>

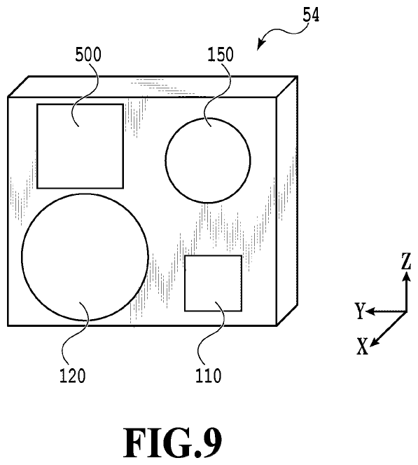

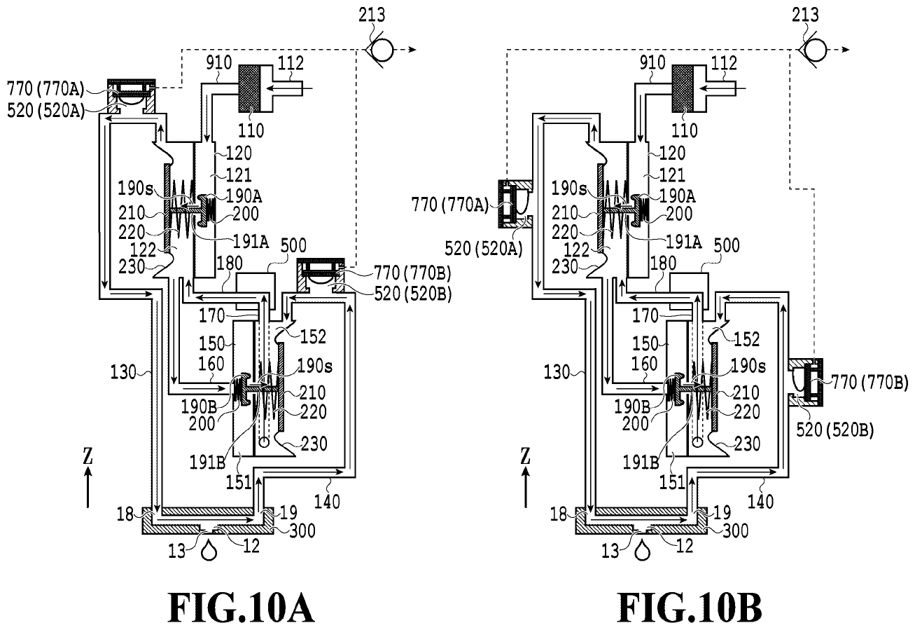

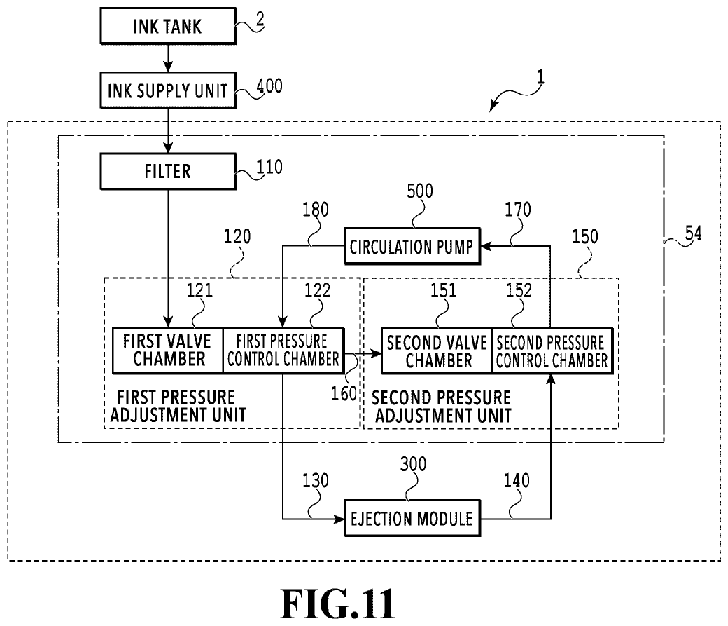

FIG. 9 is a schematic view showing the appearance of one circulation unit 54 corresponding to one type of ink that is applied to the liquid ejection apparatus 50 in the present embodiment. The circulation unit 54 includes the filter 110, a first pressure-adjusting unit 120, a second pressure-adjusting unit 150, and the circulation pump 500. These components are connected by respective flow paths as shown in FIGS. 10A, 10B, and 11, and form a circulation path that supplies and collects ink to and from the ejection module 300 in the liquid ejection head 1.

### <Circulation Path in Liquid Ejection Head>

FIGS. 10A and 10B are vertical cross-sectional views that schematically show the circulation path for one type of ink (one color of ink) that is constituted within the liquid ejection head 1. In order to more clearly describe the circulation path, the relative positions of the components (the first pressure-adjusting unit 120, the second pressure-adjusting unit 150, the circulation pump 500, and the like) in FIGS. 10A and 10B are simplified. Therefore, the relative positions of the components are different from those in FIG. 9. In addition, FIG. 11 is a block diagram that schematically shows the circulation path shown in FIGS. 10A and 10B. As shown in FIGS. 10A, 10B, and 11, the first pressure-adjusting unit 120 includes a first valve chamber 121 and a first pressure control chamber 122. The second pressure-adjusting unit 150 includes a second valve chamber 151 and a second pressure control chamber 152. The first pressure-adjusting unit 120 is configured to have a relatively higher control pressure than the second pressure-adjusting unit 150. In the present embodiment, by using these two pressure-adjusting units 120 and 150, circulation within a certain pressure range is achieved within the circulation path. In addition, a configuration is adopted in which the ink flows through the pressure chamber 12 (the ejection element 15) at a flow rate corresponding to the pressure difference between the first pressure-adjusting unit 120 and the second pressure-adjusting unit 150. Hereinafter, the circulation path in the liquid ejection head 1 and the flow of ink within the circulation path will be described with reference to FIGS. 10A, 10B, and 11. It should be noted that the arrows in each figure indicate the directions of ink flow.

In addition, in the present embodiment, the bubble-removing unit 770 is provided in the liquid ejection head 1, and is configured to discharge bubbles generated in the liquid ejection head 1 to the outside of the liquid ejection head 1. Although FIGS. 10A and 10B show configurations in which two bubble-removing units 770 are provided at different positions, the number of the bubble-removing units may be one, and its arrangement is not limited to this configuration as long as bubbles can be discharged to the outside of the liquid ejection head 1. The specific configuration of the bubble-removing unit 770 will be described later.

It should be noted that in the examples shown in FIGS. 10A and 10B, one of the two bubble-removing units 770 is referred to as a first bubble-removing unit 770A, and the other of the two bubble-removing units 770 is referred to as a second bubble-removing unit 770B. As described above, the number of the bubble-removing units 770 is not limited to two, and the liquid ejection head 1 may be provided with only one bubble-removing unit 770, or the liquid ejection head 1 may be provided with three or more bubble-removing units 770. In addition, the first bubble-removing unit 770A and the second bubble-removing unit 770B are each provided with one bubble reservoir chamber 520, which will be described later. The bubble reservoir chamber 520 provided in the first bubble-removing unit 770A is referred to as a first bubble reservoir chamber (a first bubble discharging unit) 520A, and the bubble reservoir chamber 520 provided in the second bubble-removing unit 770B is referred to as a second bubble reservoir chamber (a second bubble discharging unit) 520B. In FIG. 11, illustration of the bubble-removing units 770 and the gas flow paths connected to the bubble-removing units 770 (for example, the third air flow path 113, and the like) are omitted.

First, the connection state of each component in the liquid ejection head 1 will be described.

The ink supply unit 400 that supplies the ink stored in the ink tank 2 outside the liquid ejection head 1 to the liquid ejection head 1 is connected to the circulation unit 54 via the second supply path 112 (refer to FIG. 26). The filter 110 is provided in the ink flow path located upstream of the circulation unit 54. An ink supply path (a third supply path 910) located downstream of the filter 110 is connected to the first valve chamber 121 of the first pressure-adjusting unit 120. The first valve chamber 121 communicates with the first pressure control chamber 122 via a communication port 191A that can be opened and closed by a valve 190A shown in FIGS. 10A and 10B.

The first pressure control chamber 122 is connected to a supply flow path 130, a bypass flow path 160, and a pump outlet flow path 180 of the circulation pump 500. The supply flow path 130 is connected to the common supply flow path 18 via the above-described ink supply port provided in the ejection module 300. In addition, the bypass flow path 160 is connected to the second valve chamber 151 provided in the second pressure-adjusting unit 150. The second valve chamber 151 communicates with the second pressure control chamber 152 via a communication port 191B that is opened and closed by a valve 190B shown in FIGS. 10A and 10B. It should be noted that FIGS. 10A, 10B, and 11 show an example in which one end of the bypass flow path 160 is connected to the first pressure control chamber 122 of the first pressure-adjusting unit 120, and the other end of the bypass flow path 160 is connected to the second valve chamber 151 of the second pressure-adjusting unit 150. However, one end of the bypass flow path 160 may be connected to the supply flow path 130, and the other end of the bypass flow path may be connected to the second valve chamber 151.

The second pressure control chamber 152 is connected to a first collecting flow path 140. The first collecting flow path 140 is connected to the common collecting flow path 19 via the above-described ink-collecting port provided in the ejection module 300. Furthermore, the second pressure control chamber 152 is connected to the circulation pump 500 via a pump inlet flow path 170.

Next, the flow of ink in the liquid ejection head 1 having the above configuration will be described. As shown in FIG. 11, the ink stored in the ink tank 2 is pressurized by the one-way pump 404 (refer to FIG. 2) of the ink supply unit 400 provided in the liquid ejection apparatus 50, and is supplied to the circulation unit 54 of the liquid ejection head 1 as a positive pressure ink flow.

The ink supplied to the circulation unit 54 passes through the filter 110 to remove foreign matter such as dust and air bubbles, and thereafter flows into the first valve chamber 121 provided in the first pressure-adjusting unit 120. Although the pressure of the ink is decreased due to pressure loss at the time of passing through the filter 110, the ink pressure at this stage is in a positive state. Thereafter, the ink that has flowed into the first valve chamber 121 passes through the communication port 191A and flows into the first pressure control chamber 122 when the valve 190A is in an open state. Due to the pressure loss at the time of passing through the communication port 191A, the ink that has flowed into the first pressure control chamber 122 is switched from positive pressure to negative pressure.

Next, the flow of ink in the circulation path will be described. The circulation pump 500 operates to suction the ink from the pump inlet flow path 170 on the upstream side thereof and send the ink to the pump outlet flow path 180 on the downstream side thereof. This pump inlet flow path 170 is located vertically below the second pressure-adjusting unit 150, so that bubbles flowing from the bypass flow path 160 into the second pressure-adjusting unit 150 rise without being carried by the ink flow, and remain vertically above the second pressure-adjusting unit 150. It should be noted that this pump inlet flow path 170 does not necessarily have to be located vertically below the second pressure-adjusting unit 150, as long as the configuration allows bubbles that flow into the second pressure-adjusting unit 150 to rise and be collected in the second bubble reservoir chamber 520B. When the pump is driven, the ink supplied to the first pressure control chamber 122 flows into the supply flow path 130 and the bypass flow path 160 together with the ink sent from the pump outlet flow path 180. It should be noted that although details will be described later, in the present embodiment, a piezoelectric diaphragm pump using a piezoelectric element attached to a diaphragm as a drive source is used as a circulation pump capable of sending liquid. The piezoelectric diaphragm pump is a pump that changes the inner volume in a pump chamber by inputting a drive voltage to a piezoelectric element, and delivers liquid by alternately moving two check valves due to pressure fluctuations.

The ink that has flowed into the supply flow path 130 flows from the ink supply port of the ejection module 300 through the common supply flow path 18 into the pressure chamber 12, and a part of the ink is ejected from the ejection port 13 by driving (heat generation) of the ejection element 15. In addition, the remaining ink that has not been used for ejection flows through the pressure chamber 12, passes through the common collecting flow path 19, and thereafter flows into the first collecting flow path 140 connected to the ejection module 300. The ink that has flowed into the first collecting flow path 140 flows into the second pressure control chamber 152 of the second pressure-adjusting unit 150.

On the other hand, the ink that has flowed from the first pressure control chamber 122 into the bypass flow path 160 flows into the second valve chamber 151, and thereafter passes through the communication port 191B and flows into the second pressure control chamber 152. The ink that flows into the second pressure control chamber 152 via the bypass flow path 160 and the ink collected from the first collecting flow path 140 are suctioned into the circulation pump 500 via the pump inlet flow path 170 by driving of the circulation pump 500. Then, the ink suctioned into the circulation pump 500 is sent to the pump outlet flow path 180, and flows into the first pressure control chamber 122 again. Thereafter, the ink that flows from the first pressure control chamber 122 through the supply flow path 130 and the ejection module 300 into the second pressure control chamber 152 and the ink that flows into the second pressure control chamber 152 through the bypass flow path 160 flow into the circulation pump 500. Then, the ink is sent from the circulation pump 500 to the first pressure control chamber 122. In this manner, the circulation of ink is performed in the circulation path.

Here, the flow path that communicates the first pressure-adjusting unit 120 and the pressure chamber 12 is referred to as a first flow path, and the flow path that communicates the pressure chamber 12 and the circulation pump 500 is referred to as a second flow path. That is, the supply flow path 130 is referred to as the first flow path, and the first collecting flow path 140, the second pressure-adjusting unit 150, and the pump inlet flow path 170 are collectively referred to as the second flow path. It should be noted that the second flow path does not necessarily have to include the second pressure-adjusting unit 150 and the pump inlet flow path 170. In addition, the pump outlet flow path 180 is also referred to as a third flow path. Accordingly, in the present embodiment, the ink flows through the circulation path of the circulation pump 500, the third flow path, the first pressure-adjusting unit 120, the first flow path, the pressure chamber 12, the second flow path, and the circulation pump 500 in this order.

As described above, in the present embodiment, the circulation pump 500 can circulate the liquid (ink) along the circulation path formed inside the liquid ejection head 1. Therefore, it becomes possible to suppress the thickening of ink and the accumulation of precipitation components of color material ink in the ejection module 300, which makes it possible to maintain the fluidity of ink and the ejection characteristics at the ejection port in the ejection module 300 in a good state.

In addition, since the circulation path in the present embodiment is configured to be completed within the liquid ejection head 1, the length of the circulation path can be significantly shortened compared to a case where ink is circulated between the ink tank 2 provided outside the liquid ejection head and the liquid ejection head 1. Therefore, the circulation of ink can be performed with a small circulation pump.

Furthermore, the connection flow path between the liquid ejection head 1 and the ink tank 2 is configured to include only a flow path for supplying the ink. That is, the configuration is adopted in which a flow path for collecting the ink from the liquid ejection head 1 to the ink tank 2 is not required. Therefore, only a tube for supplying the ink needs to be provided to connect the ink tank 2 and the liquid ejection head 1, and there is no need to provide a tube for collecting the ink. Accordingly, the interior of the liquid ejection apparatus 50 can be simplified with a reduced number of tubes, and the reduction of size of the entire apparatus can be achieved. Furthermore, by reducing the number of tubes, it becomes possible to reduce the fluctuation in ink pressure due to the vibration of the tubes caused by main scanning of the liquid ejection head 1. In addition, the oscillation of the tubes during main scanning of the liquid ejection head 1 becomes a driving load on the carriage motor that drives the carriage 60. Therefore, the driving load on the carriage motor is reduced by reducing the number of the tubes, and it becomes possible to simplify a main scanning mechanism including the carriage motor and the like. Furthermore, since it becomes unnecessary to collect the ink from the liquid ejection head to the ink tank, it also becomes possible to reduce the size of the one-way pump 404 (refer to FIG. 2) of the ink supply unit 400. As described above, according to the present embodiment, it is possible to achieve the reduction of size and cost of the liquid ejection apparatus 50.

### <Pressure-Adjusting Unit>

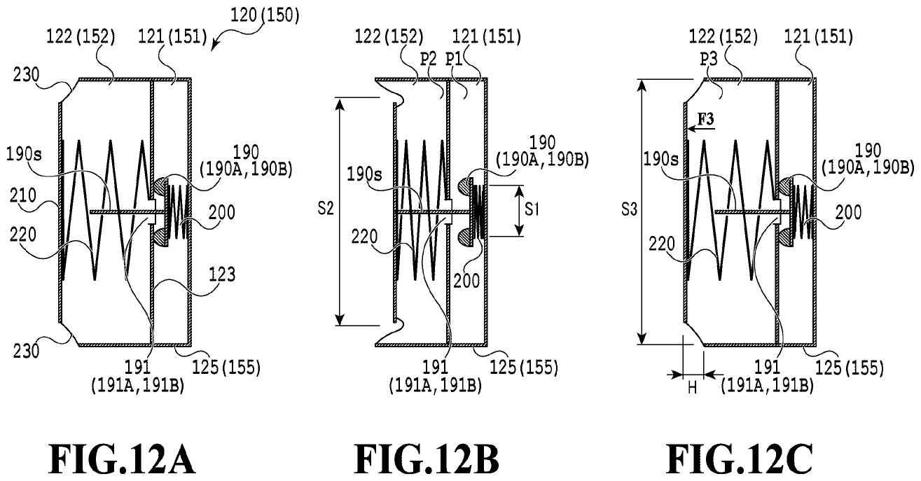

FIGS. 12A to 12C are cross-sectional views showing examples of the pressure-adjusting unit. Referring to FIGS. 12A to 12C, the configurations and operations of the pressure-adjusting units (the first pressure-adjusting unit 120 and the second pressure-adjusting unit 150) built into the above-described liquid ejection head 1 will be described in more detail. It should be noted that the first pressure-adjusting unit 120 and the second pressure-adjusting unit 150 have substantially the same configuration. Therefore, in the following, a description will be given by taking the first pressure-adjusting unit 120 as an example, and only the reference numerals of the parts of the second pressure-adjusting unit 150 corresponding to those of the first pressure-adjusting unit will be written together in FIGS. 12A to 12C. In the case of the second pressure-adjusting unit 150, the first valve chamber 121 described below will be read as the second valve chamber 151, and the first pressure control chamber 122 will be read as the second pressure control chamber 152.

The first pressure-adjusting unit 120 includes the first valve chamber 121 and the first pressure control chamber 122 formed in a cylindrical housing 125. The first valve chamber 121 and the first pressure control chamber 122 are separated by a partition wall 123 provided inside the cylindrical housing 125. However, the first valve chamber 121 communicates with the first pressure control chamber 122 via the communication port 191 formed in the partition wall 123. The first valve chamber 121 is provided with a valve 190 that switches between communication and blocking between the first valve chamber 121 and the first pressure control chamber 122 at the communication port 191. The valve 190 is held at a position facing the communication port 191 by a valve spring 200, and is configured to be able to come into close contact with the partition wall 123 by the biasing force of the valve spring 200. When the valve 190 is in close contact with the partition wall 123, the flow of ink through the communication port 191 is blocked. It should be noted that in order to improve the closeness of contact with the partition wall 123, a contact portion of the valve 190 with the partition wall 123 is preferably formed of an elastic material. In addition, a valve shaft 190s, which is inserted into the communication port 191, protrudes from a center portion of the valve 190. By pressing the valve shaft 190s against the biasing force of the valve spring 200, the valve 190 moves away from the partition wall 123, and the ink is allowed to flow through the communication port 191. Hereinafter, the state in which the valve 190 blocks the flow of ink through the communication port 191 will be referred to as a “closed state,” and the state in which the valve 190 allows the flow of ink through the communication port 191 will be referred to as an “open state.”

An opening of the cylindrical housing 125 is closed by a flexible member 230 and a pressing plate 210. The flexible member 230, the pressing plate 210, a peripheral wall of the housing 125, and the partition wall 123 form the first pressure control chamber 122. The first pressure control chamber 122 can vary its inner volume, and the pressing plate 210 is configured to be displaceable in accordance with the displacement of the flexible member 230. Although the materials of the pressing plate 210 and the flexible member 230 are not particularly limited, for example, the pressing plate 210 can be made of a resin molded part, and the flexible member 230 can be made of a resin film. In this case, the pressing plate 210 can be fixed to the flexible member 230 by thermal welding.

A pressure-adjusting spring 220 (biasing member) is provided between the pressing plate 210 and the partition wall 123. The biasing force of the pressure-adjusting spring 220 biases the pressing plate 210 and the flexible member 230 in a direction that expands the inner volume of the first pressure control chamber 122 as shown in FIG. 12A. In addition, when the pressure inside the first pressure control chamber 122 is decreased, the pressing plate 210 and the flexible member 230 are displaced against the pressure of the pressure-adjusting spring 220 in a direction that reduces the inner volume of the first pressure control chamber 122. In addition, when the inner volume of the first pressure control chamber 122 is decreased to a certain amount, the pressing plate 210 comes into contact with the valve shaft 190s of the valve 190. Thereafter, when the inner volume of the first pressure control chamber 122 is further decreased, the valve 190 moves together with the valve shaft 190s against the biasing force of the valve spring 200, and moves away from the partition wall 123. Accordingly, the communication port 191 is in the open state (the state of FIG. 12B).

In the present embodiment, the connection setting in the circulation path is set so that the pressure in the first valve chamber 121 at the time when the communication port 191 is in the open state becomes higher than the pressure in the first pressure control chamber 122. Accordingly, when the communication port 191 is in the open state, the ink flows from the first valve chamber 121 into the first pressure control chamber 122. This ink inflow displaces the flexible member 230 and the pressing plate 210 in a direction that increases the inner volume of the first pressure control chamber 122. As a result, the pressing plate 210 moves away from the valve shaft 190s of the valve 190, the valve 190 comes into close contact with the partition wall 123 by the biasing force of the valve spring 200, and the communication port 191 is brought into the closed state (the state of FIG. 12C).

In this manner, in the first pressure-adjusting unit 120 in the present embodiment, when the pressure in the first pressure control chamber 122 is decreased to a certain pressure or less (for example, when negative pressure becomes strong), the ink flows in from the first valve chamber 121 via the communication port 191. Accordingly, a configuration is adopted in which the pressure in the first pressure control chamber 122 is prevented from being decreased any further. Therefore, the pressure in the first pressure control chamber 122 is controlled to be kept within a certain range.

Next, the pressure in the first pressure control chamber 122 will be described in more detail.

As described above, a state will be considered in which the flexible member 230 and the pressing plate 210 are displaced in response to the pressure in the first pressure control chamber 122, and the pressing plate 210 abuts against the valve shaft 190s to bring the communication port 191 into the open state (the state of FIG. 12B). At this time, the relationship of the forces acting on the pressing plate 210 is expressed by the following equation (1).

P2×S2+F2+(P1−P2)×S1+F1=0 (1)
P1: the pressure (gauge pressure) of the first valve chamber 121
P2: the pressure (gauge pressure) of the first pressure control chamber 122
F1: the spring force of the valve spring 200
F2: the spring force of the pressure-adjusting spring 220
S1: the pressure-receiving area of the valve 190
S2: the pressure-receiving area of the pressing plate 210

Furthermore, when the equation (1) is rearranged for P2, the following equation (2) is obtained.

P2=−(F1+F2+P1×S1)/(S2−S1) (2)

Here, a spring force F1 of the valve spring 200 and a spring force F2 of the pressure-adjusting spring 220 are positive in the direction in which they press the valve 190 and the pressing plate 210 (the left direction in FIGS. 12A to 12C). In addition, a pressure P1 in the first valve chamber 121 and a pressure P2 in the first pressure control chamber 122 are configured to have a relationship of P1≥P2.

The pressure P2 in the first pressure control chamber 122 at the time when the communication port 191 is in the open state is determined by the equation (2). When the communication port 191 is in the open state, since the relationship P1≥P2 is satisfied, the ink flows from the first valve chamber 121 into the first pressure control chamber 122. As a result, the pressure P2 in the first pressure control chamber 122 is not decreased any further and is kept at a pressure within a certain range.

As shown in FIG. 12C, when the pressing plate 210 is not in contact with the valve shaft 190s and the communication port 191 is in the closed state, the relationship of the forces acting on the pressing plate 210 is expressed by the following equation (3).

P3×S3+F3=0 (3)
F3: the spring force of the pressure-adjusting spring 220 at the time when the pressing plate 210 and the valve shaft 190s are not in contact with each other
P3: the pressure (gauge pressure) in the first pressure control chamber 122 at the time when the pressing plate 210 and the valve shaft 190s are not in contact with each other
S3: the pressure-receiving area of the pressing plate 210 at the time when the pressing plate 210 and the valve 190 are not in contact with each other

Here, when the equation (3) is rearranged for P3, the following formula (4) is obtained.

P3=−F3/S3 (4)

It should be noted that FIG. 12C shows a state in which the pressing plate 210 and the flexible member 230 have been displaced to the left direction in the figure to the limit to which they can be displaced. The pressure P3 in the first pressure control chamber 122, the spring force F3 of the pressure-adjusting spring 220, and the pressure-receiving area S3 of the pressing plate 210 are changed depending on the amount of displacement of the pressing plate 210 and the flexible member 230 while they are displaced to the state of FIG. 12C. Specifically, when the pressing plate 210 and the flexible member 230 are located further to the right direction in FIG. 12C than in FIG. 12C, the pressure-receiving area S3 of the pressing plate 210 is decreased, and the spring force F3 of the pressure-adjusting spring 220 is increased. As a result, the pressure P3 in the first pressure control chamber 122 is decreased according to the relationship in the equation (4). Therefore, according to the equations (2) and (4), the pressure in the first pressure control chamber 122 is gradually increased from the state of FIG. 12B to the state of FIG. 12C (that is, the negative pressure is weakened to be a value closer to the positive pressure side). That is, from the state in which the communication port 191 is in the open state, the pressing plate 210 and the flexible member 230 are gradually displaced to the left direction, and the pressure in the first pressure control chamber is gradually increased until the inner volume of the first pressure control chamber 122 finally reaches the limit to which it can be displaced. In other words, the negative pressure is gradually weakened. In the present embodiment, the first pressure-adjusting unit 120 adjusts the pressure of the liquid in the first flow path, and the second pressure-adjusting unit 150 adjusts the pressure of the liquid in the pump inlet flow path 170 (in the inlet flow path).

### <Circulation Pump>

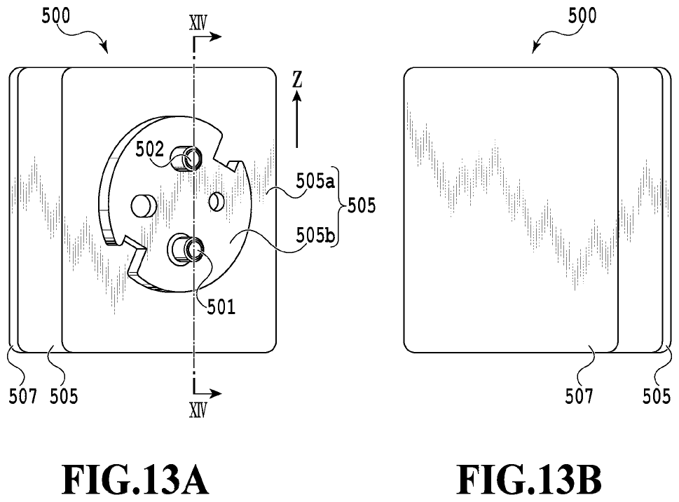

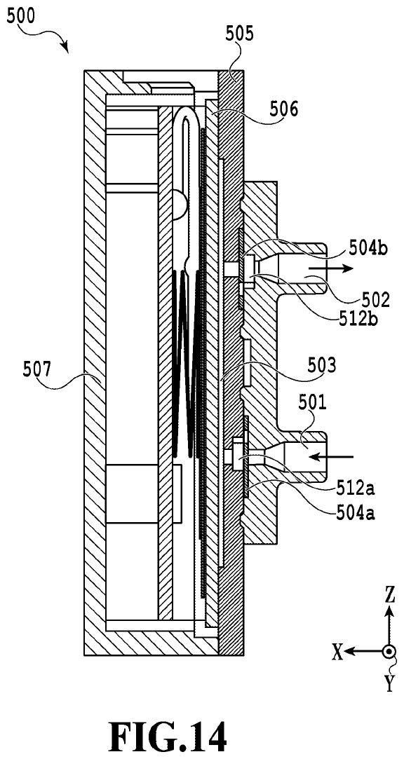

Next, referring to FIGS. 13A, 13B and 14, the configuration and operation of the circulation pump 500 built into the above-described liquid ejection head 1 will be described in detail.

FIGS. 13A and 13B are perspective views of the appearance of the circulation pump 500. FIG. 13A is a perspective view showing the appearance of a front side of the circulation pump 500, and FIG. 13B is a perspective view showing the appearance of a rear side of the circulation pump 500. The outer shell of the circulation pump 500 is constituted by a pump housing 505 and a cover 507 fixed to the pump housing 505. The pump housing 505 is constituted by a housing main body 505a and a flow path connecting member 505b adhesively fixed to an outer surface of the housing main body 505a. Each of the housing main body 505a and the flow path connecting member 505b has a pair of through holes communicating with each other provided at two different positions. One of the pair of through holes provided at one position forms a pump supply hole 501, and the other of the pair of through holes provided at the other position forms a pump discharge hole 502. The pump supply hole 501 is connected to the pump inlet flow path 170 connected to the second pressure control chamber 152, and the pump discharge hole 502 is connected to the pump outlet flow path 180 connected to the first pressure control chamber 122. The ink suctioned in from the pump supply hole 501 passes through a pump chamber 503 (refer to FIG. 14), which will be described later, and is discharged from the pump discharge hole 502.

FIG. 14 is a cross-sectional view of the circulation pump 500 shown in FIG. 13A taken along line XIV-XIV. A diaphragm 506 is bonded to an inner surface of the pump housing 505, and the pump chamber 503 is formed between the diaphragm 506 and a recess portion formed in the inner surface of the pump housing 505. The pump chamber 503 communicates with the pump supply hole 501 and the pump discharge hole 502 formed in the pump housing 505. In addition, a check valve 504a is provided in a middle portion of the pump supply hole 501, and a check valve 504b is provided in a middle portion of the pump discharge hole 502. That is, the circulation pump 500 is provided with the check valves in the flow paths that communicate the second flow path and the third flow path. Specifically, the check valve 504a is arranged so that a part of it can move to the left direction in the figure in a space 512a formed in the middle portion of the pump supply hole 501. In addition, the check valve 504b is arranged so that a part of it can move to the right direction in the figure in a space 512b formed in the middle portion of the pump discharge hole 502.

When the diaphragm 506 is displaced and the inner volume of the pump chamber 503 is increased to reduce the pressure in the pump chamber 503, the check valve 504a moves away from an opening of the pump supply hole 501 in the space 512a (that is, moves to the left direction in the figure). When the check valve 504a moves away from the opening of the pump supply hole 501 in the space 512a, the check valve 504a is brought into an open state that allows the ink to flow through the pump supply hole 501. In addition, when the diaphragm 506 is displaced and the inner volume of the pump chamber 503 is decreased to pressurize the pump chamber 503, the check valve 504a comes into close contact with a wall surface surrounding the opening of the pump supply hole 501. As a result, the pump supply hole 501 is brought into a closed state in which the flow of ink is blocked.

On the other hand, when the pressure in the pump chamber 503 is decreased, the check valve 504b comes into close contact with the wall surface surrounding an opening of the pump housing 505, and is brought into a closed state in which the flow of ink through the pump discharge hole 502 is blocked. In addition, when the pump chamber 503 is pressurized, the check valve 504b moves away from the opening of the pump housing 505 toward the space 512b (that is, moves to the right direction in the figure), allowing the ink to flow through the pump discharge hole 502.

It should be noted that the material of each of the check valves 504a and 504b may be any material that can deform in response to the pressure in the pump chamber 503, and can be formed from, for example, an elastic material such as EPDM or elastomer, or a film or thin plate such as polypropylene. However, they are not limitations.

As described above, the pump chamber 503 is formed by bonding the pump housing 505 and the diaphragm 506 together. Accordingly, the pressure in the pump chamber 503 is changed when the diaphragm 506 is deformed. For example, when the diaphragm 506 is displaced toward the pump housing 505 (displaced to the right direction in the figure) and the inner volume of the pump chamber 503 is decreased, the pressure in the pump chamber 503 is increased. As a result, the check valve 504b arranged to face the pump discharge hole 502 is brought into the open state, and the ink in the pump chamber 503 is discharged. At this time, since the check valve 504a arranged to face the pump supply hole 501 is in close contact with the wall surface surrounding the pump supply hole 501, the backflow of the ink from the pump chamber 503 to the pump supply hole 501 is suppressed.

Conversely, when the diaphragm 506 is displaced in the direction in which the pump chamber 503 is expanded, the pressure in the pump chamber 503 is decreased. Accordingly, the check valve 504a arranged to face the pump supply hole 501 is brought into the open state, and the ink is supplied to the pump chamber 503. At this time, the check valve 504b arranged in the pump discharge hole 502 comes into close contact with the wall surface surrounding the opening formed in the pump housing 505 to close the opening. Therefore, the backflow of the ink from the pump discharge hole 502 to the pump chamber 503 is suppressed.

In this manner, in the circulation pump 500, the diaphragm 506 is deformed to change the pressure in the pump chamber 503, thereby performing suctioning and discharging of the ink. At this time, in a case where bubbles are mixed into the pump chamber 503, even if the diaphragm 506 is displaced, the pressure change in the pump chamber 503 is decreased due to the expansion/contraction of the bubbles, and the amount of liquid pumped is decreased. Therefore, the pump chamber 503 is arranged parallel to gravity to make it easier for bubbles mixed in the pump chamber 503 to gather in an upper portion of the pump chamber 503, and the pump discharge hole 502 is arranged above the center of the pump chamber 503. Accordingly, it becomes possible to improve the discharge of bubbles from inside the pump, and to stabilize the flow rate.

### <Flow of Ink Inside Liquid Ejection Head>

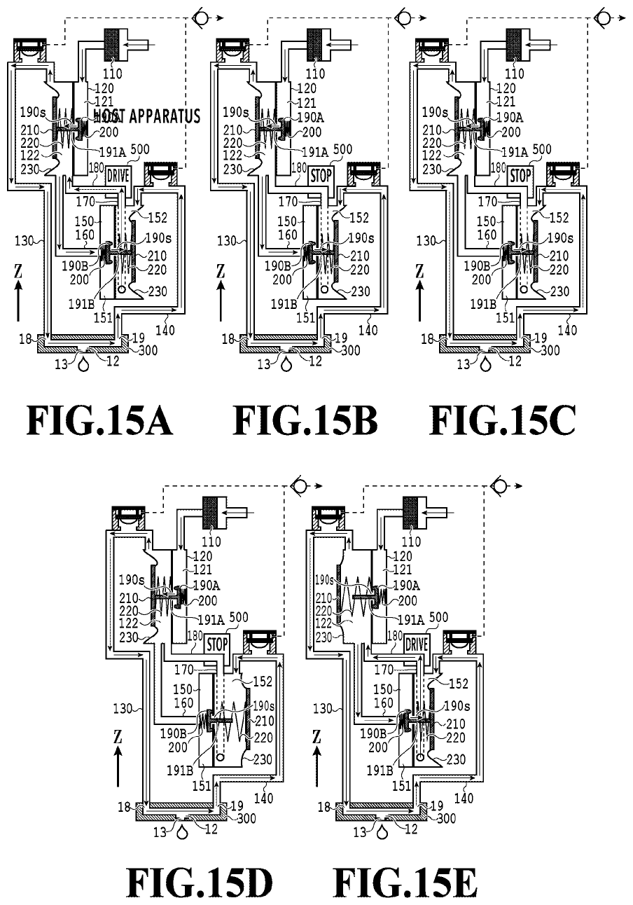

FIGS. 15A to 15E are diagrams illustrating the flow of ink inside the liquid ejection head. The circulation of ink inside the liquid ejection head 1 will be described with reference to FIGS. 15A to 15E. In order to more clearly describe the ink circulation path, the relative positions of the components (the first pressure-adjusting unit 120, the second pressure-adjusting unit 150, the circulation pump 500, and the like) in FIGS. 15A to 15E are simplified. Therefore, the relative positions of the components are different from those in FIG. 9. FIG. 15A schematically shows the flow of ink at the time when a printing operation is performed in which the ink is ejected from the ejection port 13 to perform printing. It should be noted that the arrows in the figure indicate the flow of ink. In the present embodiment, when the printing operation is performed, both the ink supply unit 400 and the circulation pump 500 start being driven. It should be noted that the ink supply unit 400 and the circulation pump 500 may be driven regardless of the printing operation. In addition, the ink supply unit 400 and the circulation pump 500 do not have to be driven in conjunction with each other, and may be driven separately and independently.

During the printing operation, the circulation pump 500 is in an ON state (a driving state), and the ink that has flowed out from the first pressure control chamber 122 flows into the supply flow path 130 and the bypass flow path 160. The ink that has flowed into the supply flow path 130 passes through the ejection module 300, thereafter flows into the first collecting flow path 140, and is thereafter supplied to the second pressure control chamber 152.

On the other hand, the ink that has flowed from the first pressure control chamber 122 into the bypass flow path 160 flows into the second pressure control chamber 152 via the second valve chamber 151. The ink that has flowed into the second pressure control chamber 152 passes through the pump inlet flow path 170, the circulation pump 500, and the pump outlet flow path 180, and thereafter flows into the first pressure control chamber 122 again. At this time, the control pressure by the first valve chamber 121 is set higher than the control pressure by the first pressure control chamber 122 based on the relationship of the above-described equation (2). Accordingly, the ink in the first pressure control chamber 122 does not flow into the first valve chamber 121, but is supplied again to the ejection module 300 via the supply flow path 130. The ink that has flowed into the ejection module 300 passes through the first collecting flow path 140, the second pressure control chamber 152, the pump inlet flow path 170, the circulation pump 500, and the pump outlet flow path 180, and flows into the first pressure control chamber 122 again. In this manner, the ink circulation to be completed within the liquid ejection head 1 is performed.

In the above-described ink circulation, the amount (flow rate) of ink circulating within the ejection module 300 is determined by the pressure difference in the control pressure between the first pressure control chamber 122 and the second pressure control chamber 152. In addition, the pressure difference is set so as to provide a circulation amount that can suppress the thickening of ink near the ejection ports in the ejection module 300. In addition, the ink consumed during printing is supplied from the ink tank 2 to the first pressure control chamber 122 via the filter 110 and the first valve chamber 121. The mechanism by which the consumed ink is supplied will be described in detail. As the ink is decreased from the circulation path by the amount of ink consumed by printing, the pressure in the first pressure control chamber is decreased, and as a result, the ink in the first pressure control chamber 122 is also decreased. With the decrease in the ink in the first pressure control chamber 122, the inner volume of the first pressure control chamber 122 is decreased. This decrease in the inner volume of the first pressure control chamber 122 brings the communication port 191A into the open state, and the ink is supplied from the first valve chamber 121 to the first pressure control chamber 122. Pressure loss occurs when the supplied ink passes through the communication port 191A from the first valve chamber 121, and when the ink flows into the first pressure control chamber 122, the positive pressure ink is switched to a negative pressure state. Then, as the ink flows into the first pressure control chamber 122 from the first valve chamber 121, the pressure in the first pressure control chamber is increased, and the inner volume of the first pressure control chamber is increased, bringing the communication port 191A into the closed state. In this manner, the communication port 191A alternates between the open state and the closed state depending on the consumption of the ink. In addition, when the ink is not consumed, the communication port 191A is maintained in the closed state.

FIG. 15B schematically shows the flow of ink immediately after the printing operation ends and the circulation pump 500 is in an OFF state (a stop state). When the printing operation ends, and the circulation pump 500 is turned OFF, the pressure in the first pressure control chamber 122 and the pressure in the second pressure control chamber 152 are both at the control pressure during the printing operation. Therefore, the movement of ink as shown in FIG. 15B occurs in accordance with the pressure difference between the pressure in the first pressure control chamber 122 and the pressure in the second pressure control chamber 152. Specifically, the flow of ink continues to occur in which the ink is supplied from the first pressure control chamber 122 to the ejection module 300 via the supply flow path 130, and thereafter flows through the first collecting flow path 140 to reach the second pressure control chamber 152. In addition, the flow of ink also continues to occur in which the ink flows from the first pressure control chamber 122 through the bypass flow path 160 and the second valve chamber 151 to reach the second pressure control chamber 152.

The amount of ink that has moved from the first pressure control chamber 122 to the second pressure control chamber 152 due to these flows of ink is supplied from the ink tank 2 to the first pressure control chamber 122 via the filter 110 and the first valve chamber 121. Therefore, the internal content in the first pressure control chamber 122 is kept constant. From the relationship of the above-described equation (2), when the internal content of the first pressure control chamber 122 is constant, the spring force F1 of the valve spring 200, the spring force F2 of the pressure-adjusting spring 220, the pressure-receiving area S1 of the valve 190, and the pressure-receiving area S2 of the pressing plate 210 are kept constant. Therefore, the pressure in the first pressure control chamber 122 is determined in accordance with the change in the pressure (the gauge pressure) P1 in the first valve chamber 121. Thus, when there is no change in the pressure P1 in the first valve chamber 121, the pressure P2 in the first pressure control chamber 122 is kept at the same pressure as the control pressure during the printing operation.

On the other hand, the pressure in the second pressure control chamber 152 is changed over time in accordance with the change in the internal content caused by the inflow of the ink from the first pressure control chamber 122. Specifically, from the state of FIG. 15B until the communication port 191 is brought into the closed state to bring the second valve chamber 151 and the second pressure control chamber 152 into a non-communication state as shown in FIG. 15C, the pressure in the second pressure control chamber 152 is changed according to the equation (2). Thereafter, the pressing plate 210 and the valve shaft 190s are brought into a non-contact state to bring the communication port 191 into the closed state. Then, as shown in FIG. 15D, the ink flows from the first collecting flow path 140 into the second pressure control chamber 152. This ink inflow displaces the pressing plate 210 and the flexible member 230, and the pressure in the second pressure control chamber 152 is changed according to the equation (4) until the inner volume of the second pressure control chamber 152 reaches its maximum. That is, the pressure rises.

It should be noted that when the state of FIG. 15C is reached, no flow of ink occurs from the first pressure control chamber 122 through the bypass flow path 160 and the second valve chamber 151 to the second pressure control chamber 152. Accordingly, after the ink in the first pressure control chamber 122 is supplied to the ejection module 300 via the supply flow path 130, only a flow occurs that reaches the second pressure control chamber 152 via the first collecting flow path 140. As described above, the movement of ink from the first pressure control chamber 122 to the second pressure control chamber 152 occurs in response to the pressure difference between the pressure in the first pressure control chamber 122 and the pressure in the second pressure control chamber 152. Therefore, when the pressure in the second pressure control chamber 152 becomes equal to the pressure in the first pressure control chamber 122, the movement of the ink is stopped.

In addition, in a state where the pressure in the second pressure control chamber 152 becomes equal to the pressure in the first pressure control chamber 122, the second pressure control chamber 152 is expanded to the state shown in FIG. 15D. When the second pressure control chamber 152 is expanded as shown in FIG. 15D, a reservoir portion capable of storing the ink is formed in the second pressure control chamber 152. It should be noted that the time from when the circulation pump 500 is stopped until the state of FIG. 15D is reached is approximately 1 to 2 minutes, although the time may vary depending on the shape and size of the flow path and the properties of the ink. When the circulation pump 500 is driven from the state shown in FIG. 15D in which the ink is stored in the reservoir portion, the ink in the reservoir portion is supplied to the first pressure control chamber 122 by the circulation pump 500. Accordingly, the amount of ink in the first pressure control chamber 122 is increased as shown in FIG. 15E, and the flexible member 230 and the pressing plate 210 are displaced in an expansion direction. Then, when the driving of the circulation pump 500 is continued to be performed, the state in the circulation path is changed as shown in FIG. 15A.

It should be noted that in the above description, FIG. 15A is described as the example during the printing operation, but as described above, the circulation of ink may be performed without the printing operation. Even in this case, the flow of ink as shown in FIGS. 15A to 15E occurs, depending on whether the circulation pump 500 is driven or stopped.

In addition, as described above, in the present embodiment, the example is used in which the communication port 191B in the second pressure-adjusting unit 150 is in the open state when the circulation pump 500 is driven to perform the circulation of ink, and the communication port 191B is in the closed state when the circulation of ink is stopped, but this is not a limitation. The control pressure may be set so that the communication port 191B in the second pressure-adjusting unit 150 is in the closed state even when the circulation pump 500 is driven to perform the circulation of ink. Hereinafter, the role of the bypass flow path 160 will also be specifically described.

The bypass flow path 160 connecting the first pressure-adjusting unit 120 and the second pressure-adjusting unit 150 is provided to prevent the negative pressure generated in the circulation path from affecting the ejection module 300, for example, when the negative pressure becomes stronger than a predetermined value. In addition, the bypass flow path 160 is also provided to supply the ink to the pressure chamber 12 from both the supply flow path 130 and the first collecting flow path 140.

First, an example will be described in which, when the negative pressure becomes stronger than the predetermined value, the negative pressure is prevented from affecting the ejection module 300 by providing the bypass flow path 160. For example, there are cases where the change in the environmental temperature causes the change in the ink characteristics (for example, viscosity). When the viscosity of the ink is changed, the pressure loss in the circulation path is also changed. For example, when the viscosity of the ink is decreased, the amount of the pressure loss in the circulation path is decreased. As a result, the flow rate of the circulation pump 500, which is driven at a constant driving amount, is increased, and the flow rate through the ejection module 300 is increased. On the other hand, since the ejection module 300 is kept at a constant temperature by a temperature adjustment mechanism (not shown), the viscosity of the ink in the ejection module 300 is maintained constant even if the environmental temperature changes. While the viscosity of the ink in the ejection module 300 is not changed, since the flow rate of the ink flowing in the ejection module 300 is increased, the negative pressure in the ejection module 300 is increased due to the flow path resistance. In this manner, when the negative pressure in the ejection module 300 becomes stronger than the predetermined value, there is a risk that the meniscus of the ejection port 13 is destroyed, and outside air is drawn into the circulation path to prevent normal ejection. In addition, even if the meniscus is not destroyed, there is a risk that the negative pressure in the pressure chamber 12 become stronger than the predetermined value, and affects ejection.

Therefore, in the present embodiment, the bypass flow path 160 is formed in the circulation path. By providing the bypass flow path 160, when the negative pressure becomes stronger than the predetermined value, since the ink also flows through the bypass flow path 160, the pressure in the ejection module 300 can be kept constant. Accordingly, for example, the communication port 191B in the second pressure-adjusting unit 150 may be configured to have a control pressure that maintains the closed state even when the circulation pump 500 is being driven. In addition, the control pressure in the second pressure-adjusting unit may be set so that the communication port 191 in the second pressure-adjusting unit 150 is in the open state when the negative pressure becomes stronger than the predetermined value. That is, as long as the meniscus does not collapse even when the pump flow rate is changed due to the change in viscosity caused by environmental changes, or as long as a predetermined negative pressure is maintained, the communication port 191B may be in the closed state when the circulation pump 500 is being driven.

Next, an example will be described in which the bypass flow path 160 is provided to supply the ink to the pressure chamber 12 from both the supply flow path 130 and the first collecting flow path 140. The pressure fluctuations in the circulation path can also occur due to an ejection operation by the ejection element 15. This is because a force that draws the ink into the pressure chamber is generated by the ejection operation.

Hereinafter, a description will be given of a case where when high-duty printing is continued, the ink to be supplied to the pressure chamber 12 is supplied from both the supply flow path 130 side and the first collecting flow path 140. It should be noted that although the definition of duty can change depending on various conditions, here, the state in which a 4 pl ink droplet is ejected onto a 1200 dpi grid for printing is considered to be 100%. High-duty printing means printing at a duty of, for example, 100%.

When high-duty printing is continued, the amount of ink flowing from the pressure chamber 12 into the second pressure control chamber 152 through the first collecting flow path 140 is decreased. On the other hand, since the circulation pump 500 allows outflow of a constant amount of ink, the balance between the inflow and outflow in the second pressure control chamber 152 is lost, the ink in the second pressure control chamber 152 is decreased, the negative pressure in the second pressure control chamber 152 is increased, and the second pressure control chamber 152 shrinks. In addition, as the negative pressure in the second pressure control chamber 152 is increased, the amount of ink flowing into the second pressure control chamber 152 via the bypass flow path 160 is increased, and the second pressure control chamber 152 becomes stable with outflow and inflow being balanced. In this manner, consequently, the negative pressure in the second pressure control chamber 152 is increased in accordance with the duty. In addition, as described above, when the circulation pump 500 is being driven, in the configuration in which the communication port 191B is in the closed state, the communication port 191B is in the open state depending on the duty, and the ink flows from the bypass flow path 160 into the second pressure control chamber 152.

In addition, when printing is continued at a further higher duty, the amount of ink flowing from the pressure chamber 12 into the second pressure control chamber 152 through the first collecting flow path 140 is decreased, and instead, the amount of ink flowing into the second pressure control chamber 152 from the communication port 191B via the bypass flow path 160 is increased. When this state progresses further, the amount of ink flowing from the pressure chamber 12 through the first collecting flow path 140 into the second pressure control chamber 152 becomes zero, and all of the ink flowing out to the circulation pump 500 is the ink flowing in from the communication port 191B. When this state progresses further, the ink flows back from the second pressure control chamber 152 through the first collecting flow path 140 into the pressure chamber 12. In this state, the ink flowing out from the second pressure control chamber 152 to the circulation pump 500 and the ink flowing out to the pressure chamber 12 flow into the second pressure control chamber 152 from the communication port 191B via the bypass flow path 160. In this case, the pressure chamber 12 is filled with the ink from the supply flow path 130 and the ink from the first collecting flow path 140, and ejects the ink.

It should be noted that the backflow of ink that occurs when the printing duty is high is a phenomenon that occurs since the bypass flow path 160 is provided. In addition, although the example has been described above in which the communication port 191B in the second pressure-adjusting unit is in the open state in response to the backflow of ink, the backflow of ink may also occur when the communication port 191B in the second pressure-adjusting unit is in the open state. In addition, even in a configuration in which the second pressure-adjusting unit is not provided, since the bypass flow path 160 is provided, the backflow of ink described above may occur. It should be noted that the bypass flow path 160 may communicate at least one of the first flow path or the first pressure-adjusting unit 120 with the second flow path without passing through the pressure chamber 12.

### <Configuration of Ejection Unit>

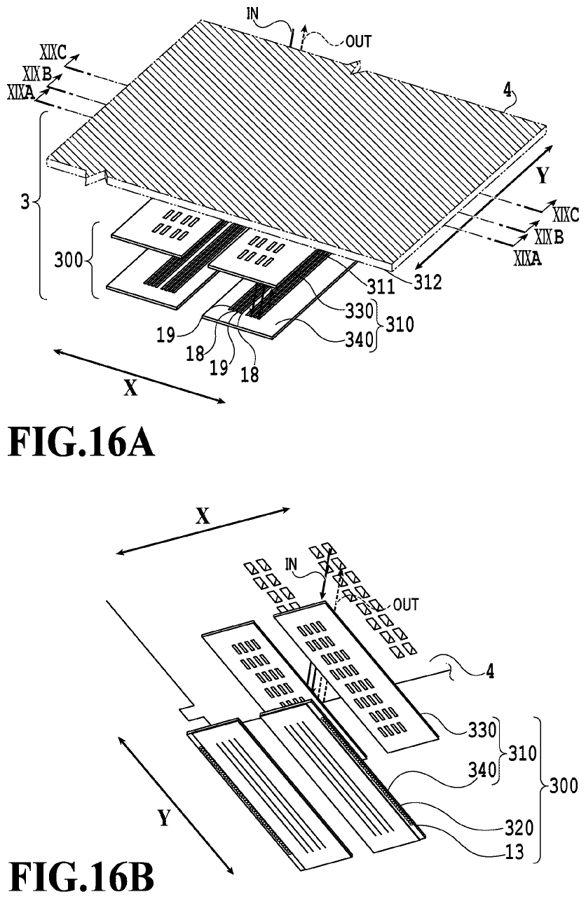

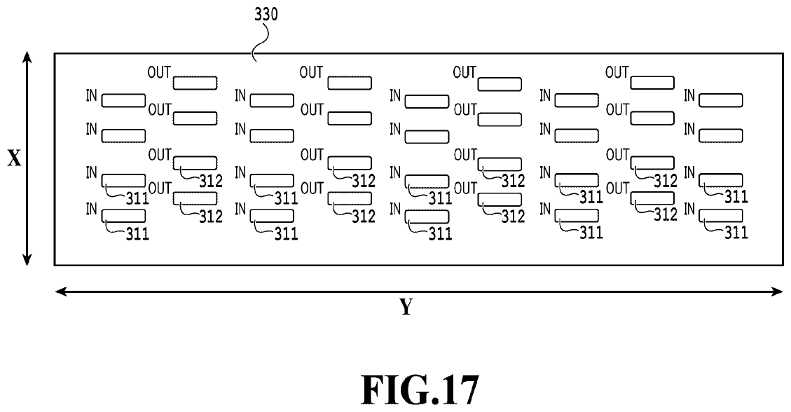

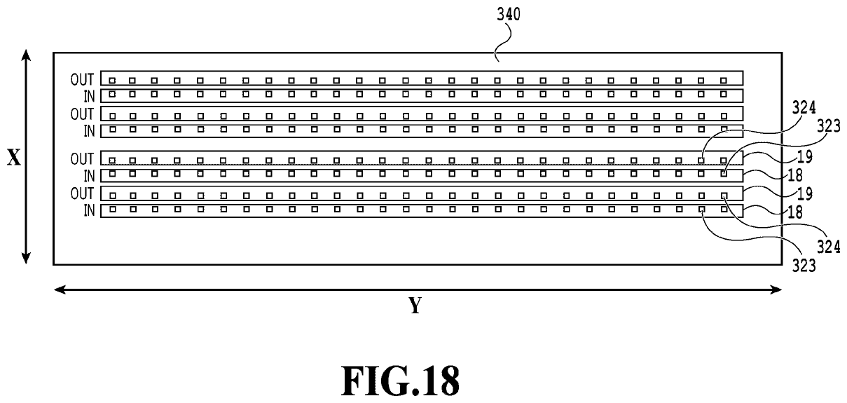

FIGS. 16A and 16B are schematic diagrams showing the circulation path for one color of ink in the ejection unit 3 in the present embodiment. FIG. 16A is an exploded perspective view of the ejection unit 3 as seen from the first support member 4 side, and FIG. 16B is an exploded perspective view of the ejection unit 3 as seen from the ejection module 300 side. It should be noted that the arrows indicated by IN and OUT in the figures indicate the flows of ink, and the flow of ink for only one color will be explained, but the other colors also flow similarly. In addition, illustration of the second support member 7 and the electrical wiring member 5 is omitted in FIGS. 16A and 16B, and is also omitted in the following description of the configuration of the ejection unit. In addition, FIG. 16A shows a cross section of the first support member 4 taken along line XVI-XVI in FIG. 8A. As described above, the ejection module 300 includes the silicon substrate 310 and the plurality of ejection elements 15. The silicon substrate 310 includes an ejection element substrate 340 and an opening plate 330. FIG. 17 is a diagram showing the opening plate 330, and FIG. 18 is a diagram showing the ejection element substrate 340.

The ink is supplied to the ejection unit 3 from the circulation unit 54 via the joint member 8 (refer to FIG. 8A). The path of the ink after the ink passes through the joint member 8 until the ink returns to the joint member 8 will be described. It should be noted that in the following drawings, illustration of the joint member 8 is omitted.

The ejection module 300 includes the ejection element substrate 340 and the opening plate 330 that constitute the silicon substrate 310, and further includes the ejection port forming member 320. The ejection element substrate 340, the opening plate 330, and the ejection port forming member 320 are overlapped and bonded together so that respective ink flow paths communicate with each other, thereby forming the ejection module 300, which is supported by the first support member 4. The ejection module 300 is supported by the first support member 4 to form the ejection unit 3. The ejection port forming member 320 is provided on a surface (a lower surface in FIG. 16B) of the ejection element substrate 340. The ejection port forming member 320 includes a plurality of ejection port arrays, each formed by a plurality of ejection ports 13, and ejects a part of the ink supplied via the ink flow path in the ejection module 300 from the ejection ports 13. The ink that has not been ejected is collected via the ink flow path in the ejection module 300.

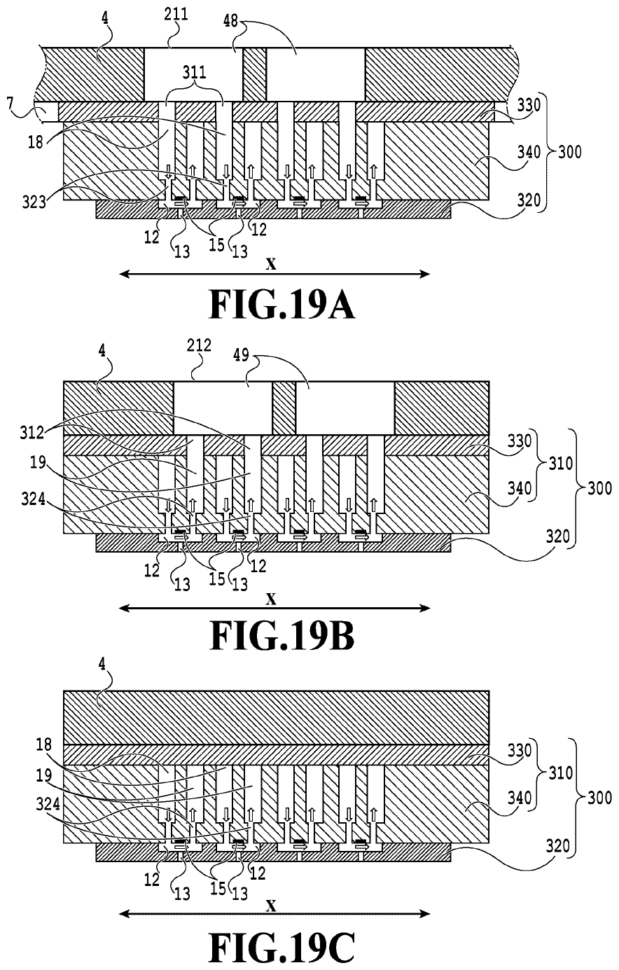

As shown in FIGS. 16A, 16B and 17, the opening plate 330 includes a plurality of ink supply ports 311 arranged in arrays and a plurality of ink-collecting ports 312 arranged in arrays. As shown in FIG. 18 and FIGS. 19A to 19C, the ejection element substrate 340 includes the plurality of supply connection flow paths 323 arranged in arrays and the plurality of collecting connection flow paths 324 arranged in arrays. Furthermore, the ejection element substrate 340 includes the common supply flow paths 18 that communicate with the plurality of supply connection flow paths 323, and the common collecting flow paths 19 that communicate with the plurality of collecting connection flow paths 324. The ink flow paths within the ejection unit 3 are formed by communicating the ink supply flow path 48 and the ink-collecting flow path 49 (refer to FIG. 8A) provided in the first support member 4 with the flow paths provided in the ejection module 300. A support member supply port 211 is a cross-sectional opening that forms the ink supply flow path 48, and a support member collecting port 212 is a cross-sectional opening that forms the ink-collecting flow path 49.

The ink to be supplied to the ejection unit 3 is supplied to the ink supply flow path 48 (refer to FIG. 8A) of the first support member 4 from the circulation unit 54 (refer to FIG. 8A) side. The ink that flows through the support member supply ports 211 in the ink supply flow path 48 is supplied to the common supply flow path 18 of the ejection element substrate 340 via the ink supply flow path 48 (refer to FIG. 8A) and the ink supply ports 311 of the opening plate 330, and enters the supply connection flow path 323. The flow path up to this point serves as a supply side flow path. Thereafter, the ink flows through the pressure chamber 12 (refer to FIG. 8B) of the ejection port forming member 320 to the collecting connection flow path 324, which is a collecting side flow path. The flow of ink in the pressure chamber 12 will be described in detail later.

In the collecting side flow path, the ink that has entered the collecting connection flow path 324 of the ejection element substrate 340 flows into the common collecting flow path 19. Thereafter, the ink flows from the common collecting flow path 19 through the ink-collecting ports 312 of the opening plate 330 to the ink-collecting flow path 49 of the first support member 4, and passes through the support member collecting ports 212 to be collected by the circulation unit 54.

The region of the opening plate 330 where there is no ink supply port 311 or ink-collecting port 312 corresponds to the region for separating the support member supply ports 211 and the support member collecting ports 212 in the first support member 4. In addition, the first support member 4 does not have any openings in this region. The region as described above is used as an adhesive region in a case where the ejection module 300 is bonded to the first support member 4.

As shown in FIG. 17, the opening plate 330 is provided with a plurality of arrays of openings arranged in the Y direction, each array including a plurality of openings arranged in the X direction, and the supply (IN) openings and the collecting (OUT) openings alternately arranged in the Y direction so that they are offset by half a pitch in the X direction. It should be noted that the ink supply ports 311 form the supply (IN) openings, and the ink-collecting ports 312 form the collecting (OUT) openings. As shown in FIG. 18, in the ejection element substrate 340, the common supply flow paths 18 that communicate with the plurality of supply connection flow paths 323 arranged in the Y direction and the common collecting flow paths 19 that communicate with the plurality of collecting connection flow paths 324 arranged in the Y direction are alternately arranged in the X direction. The common supply flow paths 18 and the common collecting flow paths 19 are divided for each type of ink, and the numbers of the common supply flow paths 18 and the common collecting flow paths 19 to be arranged are determined according to the number of ejection port arrays for each color. In addition, the supply connection flow paths 323 and the collecting connection flow paths 324 are also arranged in numbers corresponding to the ejection ports 13. It should be noted that it is not necessary to have a one-to-one correspondence, and one supply connection flow path 323 and one collecting connection flow path 324 may correspond to a plurality of ejection ports 13.

The opening plate 330 and the ejection element substrate 340 as described above are overlapped and bonded together so that respective ink flow paths communicate with each other, thereby forming the ejection module 300, and since the ejection module 300 is supported by the first support member 4, the ink flow path including the supply flow path and the collecting flow path as described above is formed.

FIGS. 19A to 19C are cross-sectional views showing the flow of ink in different portions of the ejection unit 3. FIG. 19A shows a cross-section taken along line XIXA-XIXA in FIG. 16A, the cross-section being a portion where the ink supply flow path 48 and the ink supply ports 311 in the ejection unit 3 communicate with each other. In addition, FIG. 19B shows a cross-section taken along line XIXB-XIXB in FIG. 16A, the cross-section being a portion where the ink-collecting flow path 49 and the ink-collecting ports 312 in the ejection unit 3 communicate with each other. In addition, FIG. 19C is a cross-section taken along line XIXC-XIXC in FIG. 16A, the cross-section being a portion where the ink supply ports 311 and the ink-collecting ports 312 do not communicate with the flow paths of the first support member 4.

In the supply flow path that supplies the ink, as shown in FIG. 19A, the ink is supplied from the portions where the ink supply flow paths 48 of the first support member 4 and the ink supply ports 311 of the opening plate 330 overlap and communicate with each other. In addition, in the collecting flow path that collects the ink, as shown in FIG. 19B, the ink is collected from the portions where the ink-collecting flow paths 49 of the first support member 4 and the ink-collecting ports 312 of the opening plate 330 overlap and communicate with each other. In addition, as shown in FIG. 19C, partially in the ejection unit 3, there is also a region in which no openings are provided in the opening plate 330. In such a region, the ink is not supplied or collected between the ejection element substrate 340 and the first support member 4. The ink is supplied in the regions in which the ink supply ports 311 are provided as shown in FIG. 19A, and the ink is collected in the regions where the ink-collecting ports 312 are provided as shown in FIG. 19B. It should be noted that in the present embodiment, although the configuration using the opening plate 330 has been described as an example, the opening plate 330 may not be used. For example, a configuration may be adopted in which flow paths corresponding to the ink supply flow path 48 and the ink-collecting flow path 49 are formed in the first support member 4, and the ejection element substrate 340 is bonded to the first support member 4.

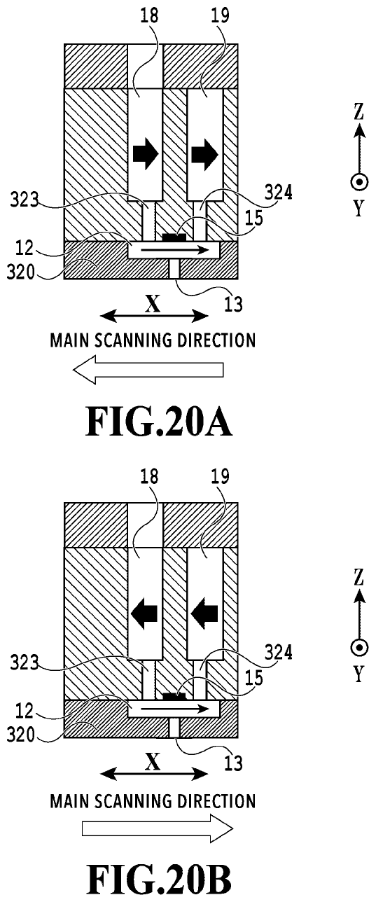

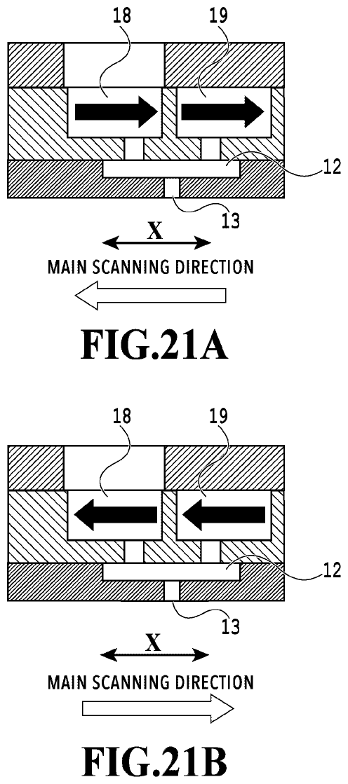

FIGS. 20A and 20B are cross-sectional views showing the vicinity of the ejection port 13 in the ejection module 300. FIGS. 21A and 21B are cross-sectional views showing, as a comparative example, the ejection module having a configuration in which the common supply flow path 18 and the common collecting flow path 19 are widened in the X direction. It should be noted that, in FIGS. 20A, 20B, 21A and 21B, the thick arrows shown in the common supply flow path 18 and the common collecting flow path 19 indicate the oscillation of ink in a mode in which a serial-type liquid ejection apparatus 50 is used. The ink supplied to the pressure chamber 12 via the common supply flow path 18 and the supply connection flow path 323 is ejected from the ejection port 13 when the ejection element 15 is driven. When the ejection element 15 is not driven, the ink is collected from the pressure chamber 12 to the common collecting flow path 19 via the collecting connection flow path 324, which is the collecting flow path.

In the mode using the serial-type liquid ejection apparatus 50, when ejection is performed with the ink circulating in this manner, the ejection of ink is affected to a certain extent by the oscillation of ink in the ink flow path due to the main scanning of the liquid ejection head 1. Specifically, the influence of ink oscillation in the ink flow path may appear as a difference in the amount of ink ejected or a deviation in the ejection direction. As shown in FIGS. 21A and 21B, when the common supply flow path 18 and the common collecting flow path 19 have a cross-sectional shape that is wide in the X direction, which is the main scanning direction, the ink in the common supply flow path 18 and the common collecting flow path 19 is more likely to be subjected to an inertial force in the main scanning direction, causing the ink to be significantly oscillated. As a result, there is a risk that the ink oscillation affects the ejection of ink from the ejection port 13. In addition, if the common supply flow path 18 and the common collecting flow path 19 are widened in the X direction, the distance between the colors is increased, and there is a possibility that the printing efficiency is decreased.

Therefore, in the present embodiment, the common supply flow path 18 and the common collecting flow path 19 extend in the Y direction in both the cross-sections shown in FIGS. 20A and 20B, but are also configured to extend in the Z direction, which is perpendicular to the X direction, which is the main scanning direction. By adopting the configuration as described above, the width of each flow path of the common supply flow path 18 and the common collecting flow path 19 in the main scanning direction can be reduced. By reducing the width of each flow path in the main scanning direction of the common supply flow path 18 and the common collecting flow path 19, the ink oscillation (refer to the thick black arrows in the figures) due to the inertial force acting on the ink in the common supply flow path 18 and the common collecting flow path 19 in the direction opposite to the main scanning direction during the main scanning is reduced. Accordingly, the influence of ink oscillation on ink ejection can be suppressed. In addition, by extending the common supply flow path 18 and the common collecting flow path 19 in the Z direction, the cross-sectional areas of the common supply flow path 18 and the common collecting flow path 19 are increased, and flow path pressure drop is reduced.

As described above, by reducing the width of each flow path in the main scanning direction of the common supply flow path 18 and the common collecting flow path 19, the ink oscillation within the common supply flow path 18 and the common collecting flow path 19 during main scanning is reduced, but the ink oscillation is not eliminated. In the present embodiment, in order to suppress differences in the ejection of each type of ink that may still occur due to reduced ink oscillation, the common supply flow path 18 and the common collecting flow path 19 are configured to be arranged to overlap in the X direction.

As described above, in the present embodiment, the supply connection flow path 323 and the collecting connection flow path 324 are provided corresponding to the ejection port 13, and the supply connection flow path 323 and the collecting connection flow path 324 are in a corresponding relationship in which they are arranged side by side in the X direction by interposing the ejection port 13 between them. Therefore, there are portions where the common supply flow path 18 and the common collecting flow path 19 do not overlap in the X direction, and if the corresponding relationship between the supply connection flow path 323 and the collecting connection flow path 324 in the X direction is disrupted, this will affect the flow and ejection of the ink in the pressure chamber 12 in the X direction. If the influence of ink oscillation is added to this, there is a risk that the ejection of ink from each ejection port is further affected.

Therefore, by arranging the common supply flow path 18 and the common collecting flow path 19 in a position where they overlap in the X direction, the ink oscillation during main scanning in the common supply flow path 18 and the common collecting flow path 19 becomes substantially equal at any position in the Y direction in which the ejection ports 13 are arranged. As a result, the pressure difference between the common supply flow path 18 side and the common collecting flow path 19 side generated in the pressure chamber 12 does not significantly vary, and stable ejection can be performed.

In addition, in some liquid ejection heads that circulate ink, the flow path that supplies the ink to the liquid ejection head and the flow path that collects the ink are configured as the same flow path, but in the present embodiment, the common supply flow path 18 and the common collecting flow path 19 are respective separate flow paths. In addition, the supply connection flow path 323 and the pressure chamber 12 communicate with each other, the pressure chamber 12 and the collecting connection flow path 324 communicate with each other, and the ink is ejected from the ejection port 13 of the pressure chamber 12. That is, the pressure chamber 12, which is a path connecting the supply connection flow path 323 and the collecting connection flow path 324, is configured to include the ejection port 13. Therefore, an ink flow from the supply connection flow path 323 side to the collecting connection flow path 324 side occurs in the pressure chamber 12, and the ink in the pressure chamber 12 is efficiently circulated. Since the ink in the pressure chamber 12 is efficiently circulated, the ink in the pressure chamber 12 that is easily affected by evaporation of the ink from the ejection port 13 can be kept fresh.

In addition, since the two flow paths, i.e., the common supply flow path 18 and the common collecting flow path 19, communicate with the pressure chamber 12, when it becomes necessary to eject the ink at a high flow rate, it is also possible to supply the ink from both flow paths. That is, compared to a configuration in which ink supply and collection are performed by using only one flow path, the configuration in the present embodiment has the advantages of not only being able to efficiently perform circulation, but also being able to handle high flow rate ejection.

In addition, the common supply flow path 18 and the common collecting flow path 19 are less likely to be affected by ink oscillation when they are arranged closer to each other in the X direction. Preferably, the distance between the flow paths is 75 μm to 100 μm.

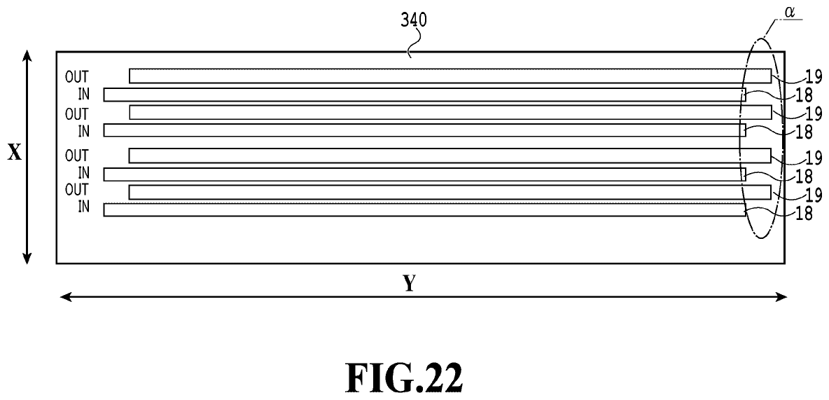

FIG. 22 is a diagram showing the ejection element substrate 340 as a comparative example. It should be noted that in FIG. 22, illustration of the supply connection flow path 323 and the collecting connection flow path 324 is omitted. Since ink that has received thermal energy from the ejection element 15 in the pressure chambers 12 flows into the common collecting flow path 19, the ink with a relatively high temperature compared to the temperature of the ink in the common supply flow path 18 flows through the common collecting flow path 19. At this time, in the comparative example, there is a portion in the X direction of the ejection element substrate 340 where only the common collecting flow path 19 exists, such as a portion a surrounded by a dashed line in FIG. 22. In this case, the temperature may locally rise in that portion, causing temperature unevenness in the ejection module 300 and affecting ejection.

The ink having a relatively low temperature flows through the common supply flow path 18 relative to the common collecting flow path 19. Therefore, when the common supply flow path 18 and the common collecting flow path 19 are adjacent to each other, since some of the temperatures in the vicinity of the common supply flow path 18 and the common collecting flow path 19 are offset, temperature rise is suppressed. Thus, it is preferable that the common supply flow path 18 and the common collecting flow path 19 have substantially the same length, are at overlapping positions in the X direction, and are adjacent to each other.

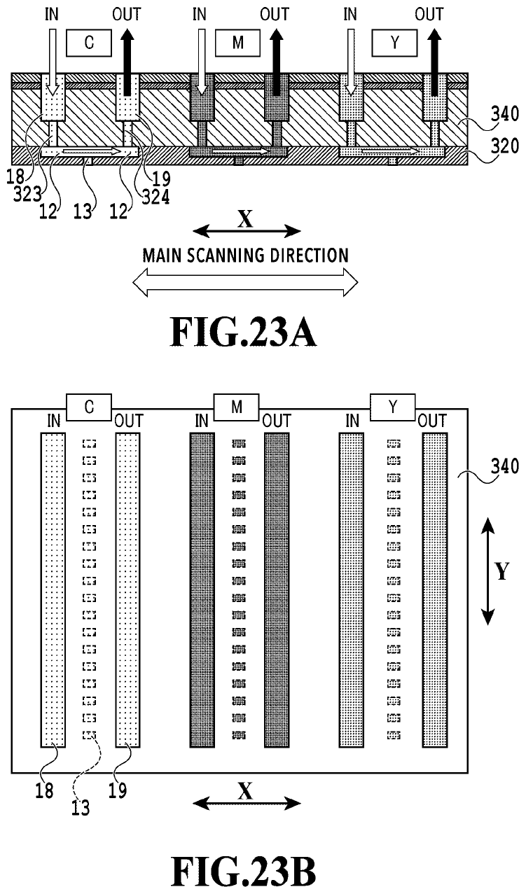

FIGS. 23A and 23B are diagrams showing the flow path configuration of the liquid ejection head corresponding to three types of inks, i.e., cyan (C), magenta (M), and yellow (Y). In the liquid ejection head corresponding to the three types of inks, a circulation flow path is provided for each type of ink as shown in FIG. 23A. The pressure chambers 12 are provided along the X direction, which is the main scanning direction of the liquid ejection head. In addition, as shown in FIG. 23B, the common supply flow path 18 and the common collecting flow path 19 are arranged along the ejection port array in which the ejection ports 13 are arranged, and extend in the Y direction so that the ejection port array is sandwiched between the common supply flow path 18 and the common collecting flow path 19.

### <Ink Backflow Near Ejection Port>

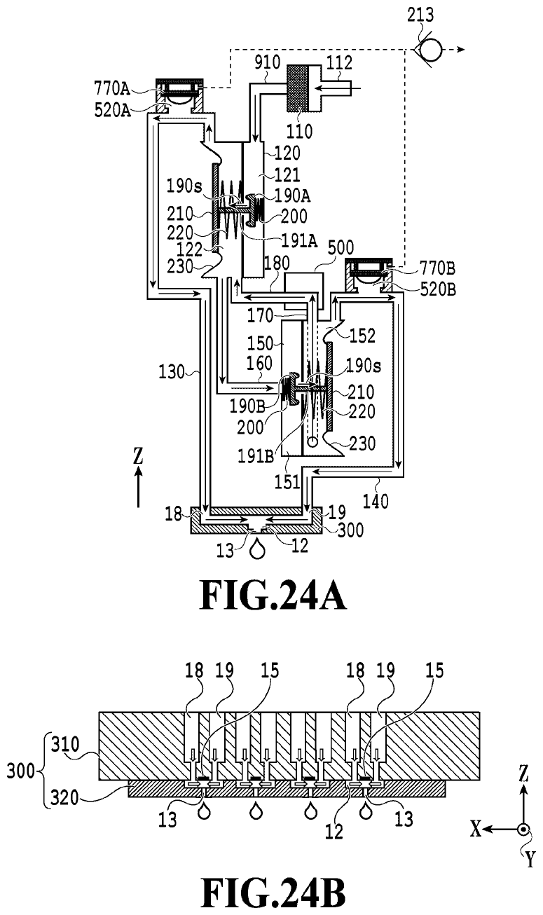

FIGS. 24A and 24B are diagrams schematically showing the backflow of ink near the ejection port. FIG. 24A is a vertical cross-sectional view schematically showing the backflow of ink that occurs in the circulation path shown in FIG. 10A, and FIG. 24B is an enlarged view schematically showing the backflow of ink that occurs in the ejection module 300 shown in FIG. 8B. FIGS. 24A and 24B show the flow of ink in the pressure chamber 12 flowing in from the common supply flow path 18 or the common collecting flow path 19, passing through the pressure chamber 12, and flowing out from the ejection port 13. As described above, when high-duty printing is continued, the ink also flows back into the pressure chamber 12 from the first collecting flow path 140 side. That is, as shown in FIGS. 24A and 24B, the pressure chamber 12 is refilled with the ink from both the supply flow path 130 (the common supply flow path 18) and the first collecting flow path 140 (the common collecting flow path 19). That is, the ink supplied from the first pressure control chamber 122 to the bypass flow path 160 is supplied to the second pressure control chamber 152 via the second valve chamber 151 of the second pressure-adjusting unit 150. Then, a part of the ink supplied to the second pressure control chamber 152 is supplied to the first collecting flow path 140 and to the ejection port 13 via the common collecting flow path 19.

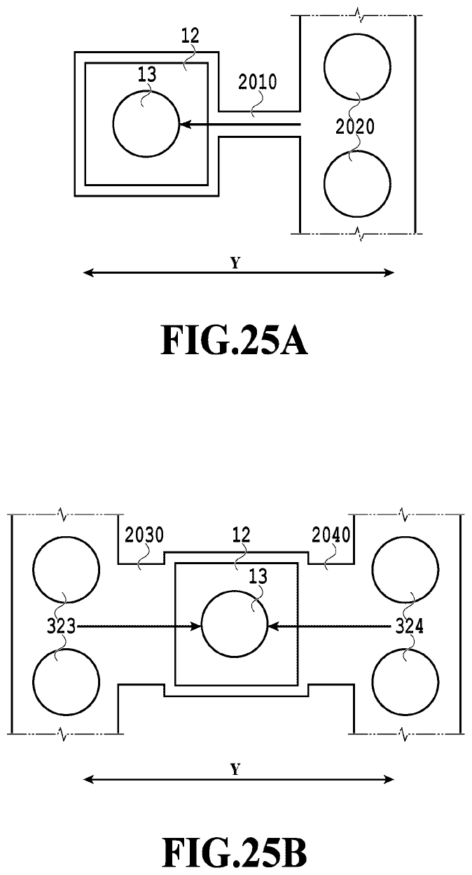

FIGS. 25A and 25B are diagrams illustrating ink supply in the ejection module 300. FIG. 25A is a diagram showing a flow path configuration in the vicinity of the pressure chamber 12, and is a diagram showing a comparative example different from the present embodiment. FIG. 25A shows a configuration in which only one side of the pressure chamber 12 communicates with a flow path 2010. In this configuration, ink supply to the pressure chamber 12 is one-side supply in which ink supply is performed only from the flow path 2010. In the configuration of FIG. 25A, independent supply ports 2020 communicating with the pressure chamber 12 are connected to the common supply flow path 18 or the common collecting flow path 19, or both of them. In particular, when a thermal-type ejection element is used as the ejection element 15, the ink is ejected from the ejection port 13 by bubble generation in the pressure chamber 12. In addition, the pressure chamber 12 is refilled with the ink due to bubble disappearance corresponding to the bubble generation. In the flow path configuration as described above, the width of the flow path 2010 connected to the pressure chamber 12 is narrowed or the length thereof is increased to increase the rear resistance during bubble generation. This results in more symmetrical bubble generation and better droplet formation. On the other hand, in the configuration as shown in FIG. 25A, in a case where the ink is refilled into the pressure chamber 12 when bubbles disappear after ejection, by increasing the rear resistance, the supply performance is decreased. Accordingly, in the flow path configuration shown in FIG. 25A, it is generally difficult to improve the refill frequency. In particular, when performing a printing operation at a high duty, there is a risk that the ink supplied to the ejection port 13 is decreased, and the ejection stability is decreased.

On the other hand, FIG. 25B is a diagram showing the flow path configuration in the vicinity of the pressure chamber 12 in the present embodiment. The supply connection flow paths 323, which are first independent supply ports, connect a first liquid flow path 2030 leading to the pressure chamber 12 with the common supply flow path 18. The collecting connection flow paths 324, which are second independent supply ports, connect a second liquid flow path 2040 leading to the pressure chamber 12 with the common collecting flow path 19. As described above, in the present embodiment, the ink ejected from the ejection port 13 is refilled from the first liquid flow path 2030 and the second liquid flow path 2040. As shown in FIG. 25B, a double-side supply configuration is adopted in which both sides of the pressure chamber 12 are connected to the first liquid flow path 2030 and the second liquid flow path 2040, respectively. In the configuration as described above, as shown in FIG. 25B, even if the width of the flow path leading to the pressure chamber 12 is increased or the length thereof is shortened, the symmetry of the rear resistance during bubble generation makes it easier for bubble generation to become symmetrical. Accordingly, better ink droplet formation is more easily achieved. In addition, in a case where the ink is refilled into the pressure chamber 12 when bubbles disappear after ejection, since the rear resistance is not increased, the ink supply performance can be improved. In this manner, according to the present embodiment, even when a printing operation is performed at a high duty, ejection stability can be improved. That is, it is possible to achieve both better droplet formation and an increased refill frequency.

It should be noted that in the above-described embodiment, the case has been described where the thermal-type ejection element is mainly used, but a piezoelectric ejection element may also be used. However, since it is more difficult to achieve both better droplet formation and an increased refill frequency with the thermal method, the present embodiment is more preferable for the thermal method.

### <Connection Between Main Body and Liquid Ejection Head>

FIG. 26 is a schematic diagram showing a connection state between the ink tank 2 and the ink supply unit 400 provided in a main body portion of the liquid ejection apparatus 50 in the present embodiment and the liquid ejection head 1. The liquid ejection apparatus 50 in the present embodiment has a configuration that allows only the liquid ejection head 1 to be easily replaced when a problem occurs in the liquid ejection head 1. Specifically, a main body-side connecting member 470 and a head-side connecting member 800 are provided, with which the second supply path 112 and the third air flow path 113 connected to the ink supply unit 400 can be easily connected to and disconnected from the liquid ejection head 1. Accordingly, only the liquid ejection head 1 can be easily attached to and detached from the liquid ejection apparatus 50.

As shown in FIG. 26, the head-side connecting member 800 is detachably attached to the head housing 53 of the liquid ejection head 1. The head-side connecting member 800 is connected to the ink supply path (the third supply path 910) in the circulation unit 54 via the filter 110. In addition, the head-side connecting member 800 is connected to the first bubble-removing unit 770A and the second bubble-removing unit 770B via a deaeration flow path 541 in the circulation unit 54.

The main body-side connecting member 470 is provided at tips of the second supply path 112 and the third air flow path 113. It should be noted that the second supply path 112 is also referred to as the ink supply tube 450. The third air flow path 113 is also referred to as the deaeration tube 460. The main body-side connecting member 470 is connected to the second supply path 112 (the ink supply tube 450) and also to the third air flow path 113 (the deaeration tube 460).

The main body-side connecting member 470 is detachably connected to the head-side connecting member 800 attached to the head housing 53. With the main body-side connecting member 470 connected to the head-side connecting member 800, the second supply path 112 communicates with the ink supply path (the third supply path 910) in the circulation unit 54 via the filter 110. In addition, with the main body-side connecting member 470 connected to the head-side connecting member 800, the third air flow path 113 communicates with the deaeration flow path 541 in the circulation unit 54. Accordingly, the second supply path 112 (the ink supply tube 450) and the third air flow path 113 (the deaeration tube 460) connected to the ink supply unit 400 can be easily connected to and disconnected from the liquid ejection head 1. Accordingly, attaching work and detaching work as well as replacement work of the liquid ejection head 1 can be easily performed.

### <Configuration of Bubble-Removing Unit>

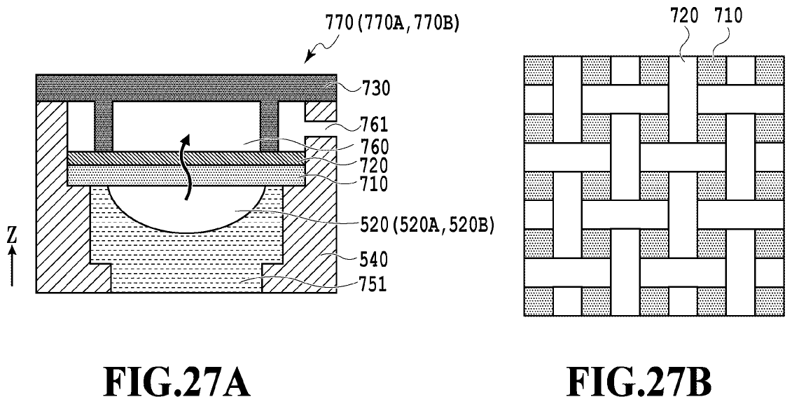

FIGS. 27A and 27B are schematic diagrams of the bubble-removing unit 770. FIG. 27A is a cross-sectional view of the bubble-removing unit 770. FIG. 27B is a schematic diagram of a deformation-suppressing member 720 in the bubble-removing unit 770. It should be noted that the second bubble-removing unit 770B has the same configuration as the first bubble-removing unit 770A. The second bubble reservoir chamber 520B has the same configuration as the first bubble reservoir chamber 520A. Therefore, the first bubble-removing unit 770A and the second bubble-removing unit 770B may be collectively described as the bubble-removing unit 770. The first bubble reservoir chamber 520A and the second bubble reservoir chamber 520B may be collectively described as the bubble reservoir chamber 520. As shown in FIG. 27A, the bubble-removing unit 770 (the first bubble-removing unit 770A and the second bubble-removing unit 770B) includes the bubble reservoir chamber 520 (the first bubble reservoir chamber 520A and the second bubble reservoir chamber 520B) and the decompression chamber 760. Furthermore, the bubble-removing unit 770 includes the gas-permeable membrane 710, the deformation-suppressing member 720, a first communication port 751 for communicating the bubble reservoir chamber 520 with the liquid flow path or the liquid chamber, and a second communication port 761 for communicating the decompression chamber 760 with the ink supply unit 400.

The bubble-removing unit 770 (the first bubble-removing unit 770A and the second bubble-removing unit 770B) communicates with the ink supply unit 400 provided in the main body portion of the liquid ejection apparatus 50, and is depressurized by the operation of the ink supply unit 400. Furthermore, since the third check valve 213 is provided between the bubble-removing unit 770 and the ink supply unit 400, and a depressurized state is maintained even when the liquid ejection apparatus 50 is not operating all the time, a bubble-removing operation can be performed. The third check valve 213 may be provided at each of the branched portions of the third air flow path 113 between the ink supply unit 400 and the first bubble-removing unit 770A and between the ink supply unit 400 and the second bubble-removing unit 770B. The third check valve 213 may be provided at a portion where the third air flow path 113 is concentrated between the ink supply unit 400 and the first bubble-removing unit 770A and the second bubble-removing unit 770B.

As shown in FIG. 10A, the first bubble-removing unit 770A is provided vertically above the supply flow path 130, and the second bubble-removing unit 770B is provided vertically above the first collecting flow path 140, but this is not a limitation. For example, one bubble-removing unit 770 (the first bubble-removing unit 770A) may be provided only for the supply flow path 130. The bubble-removing unit 770 may be provided vertically above the ink tank 2, the first supply path 111, the second supply path 112, the third supply path 910, the filter 110, the pump inlet flow path 170, the pump outlet flow path 180, the bypass flow path 160, the pressure chamber 12, and the like. Furthermore, as shown in FIG. 10B, the first bubble reservoir chamber 520A may communicate with a side surface of the supply flow path 130, and the first bubble-removing unit 770A may be formed to extend laterally from the first bubble reservoir chamber 520A. The second bubble reservoir chamber 520B may communicate with a side surface of the first collecting flow path 140, and the second bubble-removing unit 770B may be formed to extend laterally from the second bubble reservoir chamber 520B. As long as the configuration allows bubbles to be collected and brought into contact with the gas-permeable membrane 710, the bubble reservoir chamber 520 may communicate with a side surface of a fluid communication portion other than the supply flow path 130 and the first collecting flow path 140, and the bubble-removing unit 770 may be formed to extend laterally from the bubble reservoir chamber 520. In other words, the bubble-removing unit 770 may be formed to extend horizontally from the bubble reservoir chamber 520 rather than being provided vertically above the bubble reservoir chamber 520.

### <Gas-Permeable Membrane>

As shown in FIG. 27A, the gas-permeable membrane 710 is provided in a housing portion of the circulation unit 54 that forms the bubble reservoir chamber 520, so as to separate the bubble reservoir chamber 520 from the decompression chamber 760. Hereinafter, the housing portion of the circulation unit 54 that forms the bubble reservoir chamber 520 will be referred to as a unit housing 540. The gas-permeable membrane 710 is bonded to the unit housing 540 by a bonding method such as thermal welding, ultrasonic welding, or laser welding. As long as the liquid (ink) in the bubble reservoir chamber 520 is sealed so as not to leak into the decompression chamber 760, any method of the bonding methods such as thermal welding, ultrasonic welding, and laser welding can be used. The material of the gas-permeable membrane 710 is desirably resin. Specifically, as materials for the gas-permeable membrane 710, there are polypropylene (PP), polymethylpentene (TPX), polytetrafluoroethylene (PTFE), and the like. In order to increase the bubble-removing efficiency, it is desirable that the material of the gas-permeable membrane 710 has high gas permeability. In order to obtain the bubble-removing efficiency required for the product, the material of the gas-permeable membrane 710 is required to have a certain level of gas permeability. In addition, the material of the gas-permeable membrane 710 is required to have productivity, such as being easily bonded to the unit housing 540 by thermal welding. The material of the gas-permeable membrane 710 is required to be reliable against breakage of the gas-permeable membrane 710, peeling of the gas-permeable membrane 710, and the like. The material of the gas-permeable membrane 710 is required to be reliable as a liquid-contacting material. In this manner, it is desirable to select the material of the gas-permeable membrane 710 from the viewpoints of gas permeability, manufacturing method (productivity), and reliability.

The bubbles that flow into the bubble reservoir chamber 520 include initial bubbles (approximately 0.2 cc) that remain after initial filling, tank replacement bubbles that flow in during normal use (approximately 0.015 cc per month), and permeated bubbles that permeate from the outside via gas permeation (approximately 0.001 cc/day). In order to process these bubbles, it is necessary to perform the bubble-removing operation with a permeation amount of bubbles of 0.01 cc/day or more. As defined in “JIS K7126-1,” the permeation amount of gas through the gas-permeable membrane 710 can be verified by the pressure sensor method or the like. The pressure sensor method is a method that measures gas permeability by maintaining a vacuum on one side (a low-pressure side) separated by a test piece, introducing a test gas into the other side (a high-pressure side), and measuring the increase in pressure on the low-pressure side. According to the pressure sensor method, it is possible to calculate the gas permeability coefficient from the gas permeability and the thickness of the test piece. In the pressure sensor method, by measuring the gas permeability using a test piece as a gas-permeable membrane, the permeation amount of gas through the gas-permeable membrane can be verified. During the initial filling of the normal suction, which will be described later, the ink is filled into the liquid ejection head 1, the bubbles in the bubble reservoir chamber 520 are brought into contact with the entire gas-permeable membrane 710, and the liquid ejection head 1 is left at normal temperature and pressure in a state where the gas pressure in the decompression chamber 760 is maintained at a negative pressure of approximately 50 kPa by the ink supply unit 400. During the series of operations as described above, by measuring the amount of bubbles in the bubble reservoir chamber 520 over time using computed tomography (CT) or the like, the permeation amount of bubbles (gas) through the gas-permeable membrane 710 can be verified. In order to weld the gas-permeable membrane 710 to the unit housing 540 to seal the bubble reservoir chamber 520, it is desirable that the material of the gas-permeable membrane 710 is highly reliable in welding the gas-permeable membrane 710 and as a liquid-contacting material. In order to achieve a permeation amount of bubbles of 0.01 cc/day or more, the thickness of the gas-permeable membrane 710 is desirably 0.1 mm or less.

### <Bubble Reservoir Chamber>

As shown in FIG. 10A, the first bubble reservoir chamber 520A is provided vertically above the supply flow path 130 so as to be in fluid communication with the supply flow path 130 via the first communication port 751. The second bubble reservoir chamber 520B is provided vertically above the first collecting flow path 140 so as to be in fluid communication with the first collecting flow path 140 via the first communication port 751. Accordingly, bubbles that are mixed into the ink in the first pressure-adjusting unit 120, the second pressure-adjusting unit 150, the supply flow path 130, the first collecting flow path 140, and the like due to the circulation and the ejection operations can be collected in the bubble reservoir chamber 520, and discharged from the ink by the bubble-removing operation. Bubbles that are mixed into the ink include, for example, upstream bubbles that enter the flow path due to replacement of the ink tank 2, dissolved bubbles that occur in the flow path due to environmental changes, and unexpected bubbles that unexpectedly occur in the flow path. It should be noted that the types of bubbles to be discharged in the bubble-removing operation are not limited to these. When the amount of bubbles is such that it can be collected in the bubble reservoir chamber 520 and a sufficient bubble-removing speed can be achieved, the bubbles mixed in the ink can be discharged to the outside of the liquid ejection head 1.

As materials for the unit housing 540 that forms the bubble reservoir chamber 520, there are polypropylene (PP), polyethylene (PE), and the like. From the viewpoints of reliability in welding the gas-permeable membrane 710 and ease of handling, it is desirable that the material of the unit housing 540 is polypropylene.

### <Decompression Chamber>

As shown in FIG. 27A, the decompression chamber 760 includes an opening portion where the gas-permeable membrane 710 is arranged, an opening portion facing this opening portion for welding the gas-permeable membrane 710, and the second communication port 761. The decompression chamber 760 is formed by being surrounded by the unit housing 540, the gas-permeable membrane 710, and a cover member 730. The second communication port 761 is formed through a side portion of the unit housing 540, and communicates the decompression chamber 760 with the deaeration flow path 541 (refer to FIG. 26). The opening portion for welding the gas-permeable membrane 710 is sealed by bonding the cover member 730, which is a separate member, to the unit housing 540. As bonding methods for the cover member 730, there are thermal welding, ultrasonic welding, laser welding, and the like. As materials for the cover member 730, there are polypropylene (PP), polyethylene (PE), and the like. From the viewpoints of reliability of welding of the cover member 730 and ease of handling, it is desirable that the material of the cover member 730 is the same as the material of the unit housing 540 that forms the bubble reservoir chamber 520.

### <Deformation-Suppressing Member>

As shown in FIG. 27B, the deformation-suppressing member 720 is formed by using a stainless steel (SUS) mesh filter having a mesh-like configuration. It should be noted that in FIG. 27B, the gas-permeable membrane 710 is given a dot pattern to make the deformation-suppressing member 720 easier to see. The dot pattern given to the gas-permeable membrane 710 in FIG. 27B does not represent a cross-section of the gas-permeable membrane 710. When the decompression chamber 760 is depressurized by the ink supply unit 400, the gas-permeable membrane 710 deforms toward the decompression chamber 760. The deformation-suppressing member 720 comes into contact with the gas-permeable membrane 710 that deforms toward the decompression chamber 760, thereby suppressing the deformation of the gas-permeable membrane 710, and preventing breakage or peeling of the gas-permeable membrane 710. The deformation-suppressing member 720 is provided at tip portions of the cover member 730. For example, the deformation-suppressing member 720 is bonded to the tip portions of the cover member 730 by a bonding method such as thermal welding, ultrasonic welding, or laser welding. The deformation-suppressing member 720 is arranged so as to cover the gas-permeable membrane 710 at a position in contact with the gas-permeable membrane 710 or at a position a certain distance away from the gas-permeable membrane 710 in a state where the cover member 730 is bonded to the unit housing 540. As materials for the deformation-suppressing member 720, there are nickel (Ni) and the like in addition to stainless steel (SUS). The material of the deformation-suppressing member 720 is desirably a material that is highly reliable in welding of the deformation-suppressing member 720 and is easy to handle.

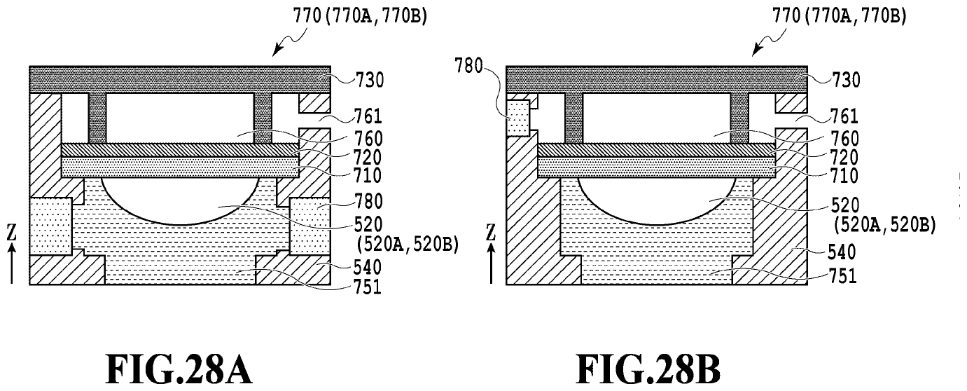

The bubble reservoir chamber 520 is formed by the unit housing 540, but is not limited to this. FIGS. 28A and 28B are diagrams showing a modification of the bubble-removing unit 770. FIG. 28A shows an example in which side films 780 are used in portions of the bubble reservoir chamber 520. FIG. 28B shows an example in which a side film 780 is used in part of the decompression chamber 760. As shown in FIG. 28A, the portions of the bubble reservoir chamber 520 may be formed by the side films 780 welded to the unit housing 540. In order to suppress the increase of bubbles in the bubble reservoir chamber 520, the liquid flow path, the liquid chamber, and the like, the material of the side film 780 is desirably resin with high gas-barrier properties, such as polyethylene terephthalate (PET) or nylon (Ny). The inner volume of the bubble reservoir chamber 520 may be any inner volume that can collect the amount of bubbles determined by the bubble design of the product.

As shown in FIG. 28B, a part of the decompression chamber 760 may be formed by the side film 780 welded to the unit housing 540. In order to reduce the amount of reduction in the degree of decompression in the decompression chamber 760, it is desirable that the material of the side film 780 is resin with high gas-barrier properties, such as polyethylene terephthalate (PET) or nylon (Ny). In addition, the gas-permeable membrane 710 may be arranged with an elastic member sandwiched between it and the unit housing 540 of the bubble reservoir chamber 520 or between it and the unit housing 540 of the decompression chamber 760. In this case, it is not necessary to weld the gas-permeable membrane 710 to the bubble reservoir chamber 520. Therefore, the opening portion of the decompression chamber 760 and the cover member 730 that seals the opening portion are not necessary, and the decompression chamber 760 may be formed by the unit housing 540 or the side film 780. The inner volume of the decompression chamber 760 needs to be an inner volume capable of collecting the amount of bubbles determined by the bubble design of the product.

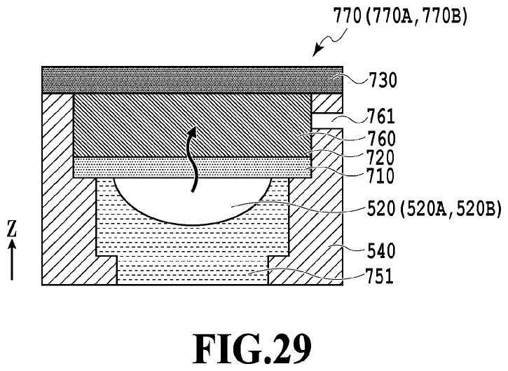

FIG. 29 is a cross-sectional view showing a first modification of the deformation-suppressing member 720. The deformation-suppressing member 720 is not limited to a mesh filter, and may be formed by using, for example, a nonwoven fabric member with densely packed fibers as shown in FIG. 29. In this case, in order to prevent the nonwoven fabric member from being suctioned into the ink supply unit 400 when the decompression chamber 760 is depressurized, it is necessary to use a nonwoven fabric member having a hardness of a certain value or more, or to keep the degree of decompression for the decompression chamber 760 at a certain value or less. In addition, the nonwoven fabric member has a certain degree of elasticity. Therefore, by designing the size of the deformation-suppressing member 720 to be approximately the same as the inner volume of the decompression chamber 760, it is possible to arrange the deformation-suppressing member 720 in the decompression chamber 760, without extending the cover member 730 into the decompression chamber 760.

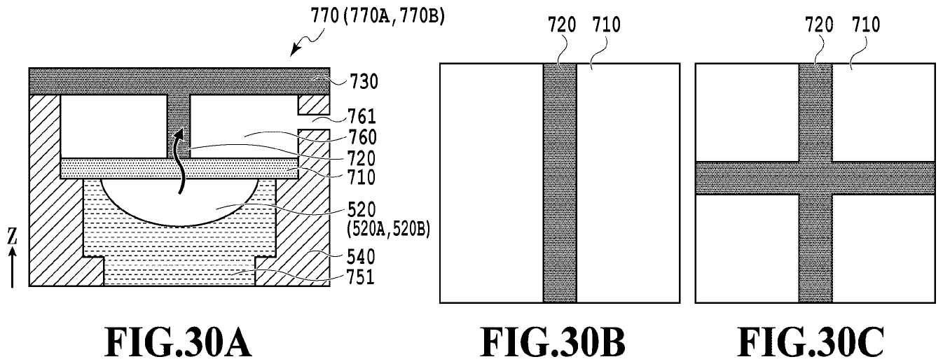

FIGS. 30A to 30C are schematic diagrams showing other modifications of the deformation-suppressing member 720. FIG. 30A is a cross-sectional view showing a second modification of the deformation-suppressing member 720. FIG. 30B is a schematic diagram showing the second modification of the deformation-suppressing member 720. FIG. 30C is a schematic diagram showing a third modification of the deformation-suppressing member 720. As shown in FIG. 30A, the deformation-suppressing member 720 may be a rib-shaped member formed integrally with the cover member 730. The rib shape of the deformation-suppressing member 720 may be a linear rib shape as shown in FIG. 30B. The rib shape of the deformation-suppressing member 720 is not limited to the linear rib shape, and may be a lattice-like rib shape as shown in FIG. 30C. In this case, in order to suppress the maximum deformation amount of the gas-permeable membrane 710, it is desirable that the rib shape of the deformation-suppressing member 720 is a rib shape that contacts the vicinity of the center of the gas-permeable membrane 710. In order to suppress the maximum deformation amount of the gas-permeable membrane 710, it is desirable to increase the number of ribs that constitute the deformation-suppressing member 720. It should be noted that in a case where the deformation-suppressing member 720 is provided at a tip portion of the cover member 730, when the deformation-suppressing member 720 comes into contact with a part of the gas-permeable membrane 710, the effective area for permeating bubbles through the gas-permeable membrane 710 will be reduced, and therefore it is necessary to adjust the configurations of other members and the bubble design of the product. In addition, in a case where the decompression chamber 760 has a configuration that does not require the cover member 730, the deformation-suppressing member 720 may be installed in the unit housing 540 that forms the bubble reservoir chamber 520, or in the unit housing 540 that forms the decompression chamber 760.

### <Principle of Bubble-Removing>

During the bubble-removing operation, by depressurizing the decompression chamber 760, the pressure difference between the pressure of the bubbles in the bubble reservoir chamber 520 and the pressure of the gas in the decompression chamber 760 causes the bubbles to permeate the gas-permeable membrane 710. The permeation amount during the bubble-removing operation is expressed by the following equation (5).

Q=P×p×S×t/L (5)
Q: gas permeation amount
P: permeability coefficient
p: degree of decompression (gauge pressure)
S: bubble contact area
t: time
L: thickness of the gas-permeable membrane 710

The gas permeation amount represented by Q is the permeation amount of gas contained in bubbles due to the bubble-removing operation. The permeability coefficient represented by P is a numerical value determined by the material properties of the gas-permeable membrane 710, and represents the basic speed of the bubble-removing operation. The degree of decompression represented by p is the degree of decompression (gauge pressure) of the decompression chamber 760. The bubble contact area represented by S is the area where bubbles are in contact with the gas-permeable membrane 710. The numerical value represented by L is the thickness of the gas-permeable membrane 710.

### <Initial Filling>

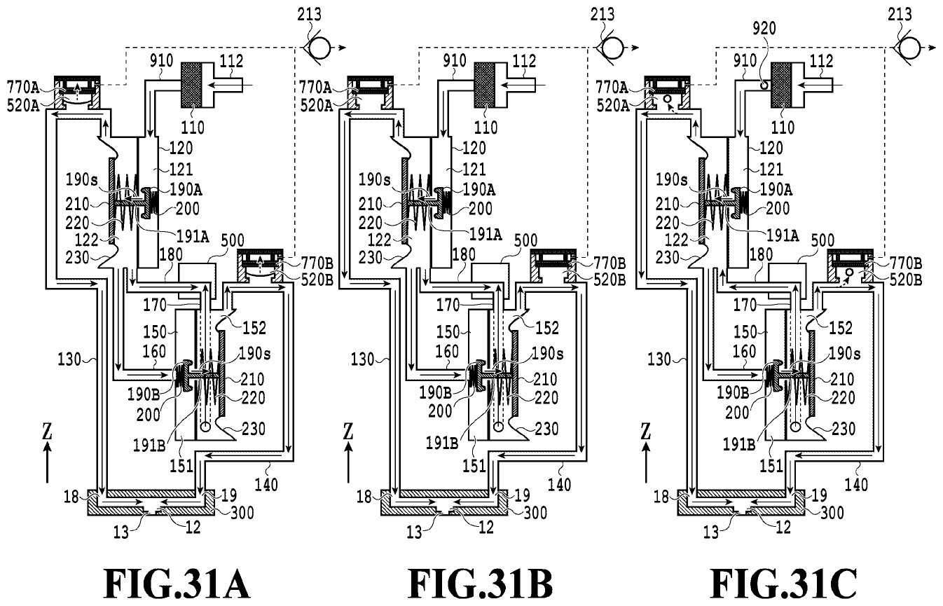

FIGS. 31A to 31C are schematic diagrams showing the operation of the initial filling and bubble-removing unit. FIG. 31A is a schematic diagram showing ink flow and residual bubbles at the time when ink is initially filled into the liquid ejection head 1. The initial filling is performed by tightly contacting the cap member with the ejection port surface where the ejection port of the liquid ejection head 1 is formed, and forcibly suctioning the ink from the ejection port. At this time, negative pressure from a negative pressure source connected to the cap member is applied to the ejection port, thereby forcibly suctioning the ink from the ejection port. When performing the initial filling, when there are locations where the ink flow stagnates due to variations in the molding or assembly of parts, a small amount of bubbles may remain attached to the wall surface or the like. The suction operation includes normal suction and choke suction, and the filling state of the bubble-removing unit is changed depending on the method of the suction operation. In normal suction, since suction is performed without any special operation, in the ink flow path shown in FIG. 31A, the ink is supplied from the upstream side of the ink flow path, thereby performing gas-liquid exchange, and filling most of the ink flow path with the ink. However, since the portion corresponding to the bubble reservoir chamber 520 (the first bubble reservoir chamber 520A and the second bubble reservoir chamber 520B) does not serve as an ink flow path, gas-liquid exchange is not performed, and bubbles remain in most portions of the bubble reservoir chamber 520. In choke suction, the flow path on the upstream side of the ink flow path is closed by a valve or the like to sufficiently depressurize the entire liquid ejection head 1 by the suction operation, and thereafter the upstream-side valve is opened, thereby causing the ink to flow into the liquid ejection head 1 from the upstream side of the ink flow path. Therefore, in the ink flow path shown in FIG. 31A, most of the ink flow path is filled with the ink as in normal suction, and in the bubble reservoir chamber 520, the amount of ink filled is increased as the degree of decompression in the depressurized state due to the suction operation is increased. For example, when choke suction is performed at −50 kPa (gauge pressure), about half of the bubble reservoir chamber 520 is filled with the ink.

### <Operation of Bubble-Removing Unit>

FIG. 31B is a schematic diagram showing the state inside the circulation unit after the initial filling. FIG. 31C is a schematic diagram showing the state of remaining bubbles after the initial filling. After the initial filling, since the bubble reservoir chamber 520 (the first bubble reservoir chamber 520A and the second bubble reservoir chamber 520B) is in a state where bubbles remain, the decompression chamber 760 is depressurized to remove the bubbles. Since gas constantly permeates the bubble reservoir chamber 520 from the outside through the unit housing or the side film, it is necessary to perform a bubble-removing operation in accordance with the bubble design of the product. The decompression chamber 760 is brought into a depressurized state by being depressurized through the second communication port 761 by the ink supply unit 400 in the main body portion of the liquid ejection apparatus 50. The higher the degree of decompression, the greater the amount of bubbles that permeate. Therefore, in order to obtain a sufficient permeation amount of bubbles to process bubbles that are generated during normal use, it is desirable to set the degree of decompression to at least 10 kPa or more. In addition, when the degree of decompression is made excessively high, there is a risk that the gas-permeable membrane 710 is significantly deformed toward the decompression chamber 760, which causes peeling at a welded portion of the gas-permeable membrane 710, and therefore it is desirable to keep the degree of decompression at approximately 70 kPa or less. In addition, since the ink supply unit 400 for depressurizing the decompression chamber 760 utilizes a pressurizing unit of the upstream flow path (for example, the above-described one-way pump 404), the degree of decompression in the decompression chamber 760 is affected by the operation or output of the pressurizing unit. As can be seen from the above description, it is desirable that the degree of decompression appropriate for the operation of the ink supply unit 400 is about 50 kPa, at which a sufficient permeation amount of bubbles can be obtained and the reliability of the gas-permeable membrane 710 is high. By constantly operating the liquid ejection apparatus 50, it is possible to maintain the depressurized state of the decompression chamber 760. When the main body portion of the liquid ejection apparatus 50 is not operated, the third check valve 213 provided between the second communication port 761 (refer to FIG. 27A) and the ink supply unit 400 is used. The third check valve 213 seals the decompression chamber 760 when the decompression chamber 760 reaches a certain degree of decompression. Accordingly, even when the main body portion of the liquid ejection apparatus 50 is in a non-operating state, the bubble-removing operation can be continued by maintaining the depressurized state of the decompression chamber 760, and it is also possible to deal with bubbles that are increased by, for example, leaving the liquid ejection apparatus 50 unused for a longtime. As shown in FIG. 31A, after the initial filling, the decompression chamber 760 is brought into a depressurized state by the ink supply unit 400, and thereafter the depressurized state is maintained by the third check valve 213, thereby causing bubbles in the bubble reservoir chamber 520 to permeate and discharging bubbles from the ink. When an ejection operation is performed, the ink flows in from upstream, and therefore bubbles present upstream also flow in at the same time. In addition, unexpected bubbles, i.e., a small amount of bubbles that remain in stagnant areas of the ink flow during the initial filling, also flow through the flow path due to the ejection operation and the circulation operations. As shown in FIG. 31C, bubbles can be collected through the first communication port 751 (refer to FIG. 27A) of the bubble-removing unit 770 due to the buoyancy of bubbles, and by depressurizing the decompression chamber 760 to perform the bubble-removing operation, bubbles can be discharged from the ink. By repeating this bubble-removing operation, since bubbles that are newly generated during normal use do not flow into the pressure chamber 12, it is possible to reduce the possibility of causing poor ejection. In a case where the decompression chamber 760 is maintained in the depressurized state by the third check valve 213, when the bubble-removing operation is performed, since bubbles permeate into the decompression chamber 760, and the degree of decompression in the decompression chamber 760 is reduced, the bubble-removing efficiency is decreased. The amount of decrease in the degree of decompression is expressed by the following equation (6).

(p2×Q+p1×Q1)/v (6)
p1: atmospheric pressure (absolute pressure)
p2: bubble internal pressure (absolute pressure)
v: the inner volume of the decompression chamber 760
Q1: the permeation amount from the outside

The bubble internal pressure represented by p2 is the same as the pressure of the ink. The larger the inner volume of the decompression chamber 760 represented by v, the smaller the amount of decrease in the degree of decompression due to the bubble-removing operation, and the decrease in the bubble-removing efficiency can be suppressed. The permeation amount from the outside represented by Q1 is the permeation amount of gas that permeates from the outside into the decompression chamber 760, and is determined by the material of the unit housing that forms the decompression chamber 760, the surface area of a portion of the unit housing that comes into contact with the outside air, and the thickness of the unit housing.

When the degree of decompression in the decompression chamber 760 is decreased, by operating the third check valve 213 and the ink supply unit 400 to increase the degree of decompression in the decompression chamber 760, the bubble-removing efficiency can be maintained. It should be noted that the operation of increasing the degree of decompression (for example, the above-described bubble-removing and depressurizing operation) may be performed periodically using a timer. The operation of increasing the degree of decompression may be performed by detecting the degree of decompression in the decompression chamber 760 with a sensor, and using a predetermined decrease in the degree of decompression as a trigger. When the decompression chamber 760 is brought into a depressurizing state and the gas-permeable membrane 710 is deformed toward the decompression chamber 760, the deformation-suppressing member 720 comes into contact with the gas-permeable membrane 710 from the decompression chamber 760 side. The deformation-suppressing member 720 suppresses deformation of the gas-permeable membrane 710 by pressing the gas-permeable membrane 710 in a direction that suppresses deformation of the gas-permeable membrane 710. By suppressing deformation of the gas-permeable membrane 710, the load applied to the welded portion of the gas-permeable membrane 710 can be reduced, and the possibility that the gas-permeable membrane 710 peels off can be reduced.

In the present embodiment, the operation of the bubble-removing unit has been described by taking, as an example, the configuration in which the bubble-removing unit 770 (the first bubble-removing unit 770A and the second bubble-removing unit 770B) includes the bubble reservoir chamber 520 (the first bubble reservoir chamber 520A and the second bubble reservoir chamber 520B), but this is not a limitation. When the space between the pressure chamber 12 and the decompression chamber 760 is used as a liquid reservoir chamber that stores liquid (ink) for supplying the liquid to the pressure chamber 12, the liquid reservoir chamber may be configured so that bubbles are accumulated in a part of the liquid reservoir chamber. In this case, a gas-permeable membrane is formed at a position in contact with the liquid reservoir chamber, and the decompression chamber is adjacent to the liquid reservoir chamber via the gas-permeable membrane.

It should be noted that the configuration of the circulation path in the present embodiment is not limited to the above-described configuration. Therefore, as other configurations of the circulation path, a first configuration example and a second configuration example of the ink path as well as modifications of the circulation path will be described.

### <First Configuration Example of Ink Path>

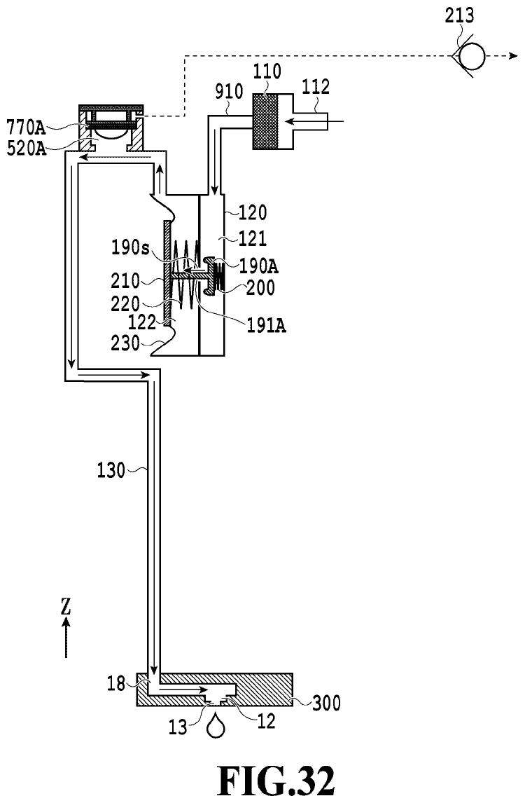

FIG. 32 is a diagram schematically showing the first configuration example of the ink path. The first configuration example of the ink path shows an example in which the second pressure-adjusting unit 150, the second bubble reservoir chamber 520B, the circulation pump 500, the bypass flow path 160, and the first collecting flow path 140 are not arranged. In the first configuration example of the ink path, the circulation of ink is not performed, and the ink supplied from the second supply path 112 flows in the order of the first pressure-adjusting unit 120, the supply flow path 130, and the pressure chamber 12 and is ejected from the ejection port 13. Since the pressure in the first pressure control chamber 122, the supply flow path 130, and the pressure chamber 12 is controlled by the first pressure-adjusting unit 120, stable ink ejection is achieved.

The first bubble reservoir chamber 520A is provided vertically above the supply flow path 130 so as to be in fluid communication with the supply flow path 130, and the first bubble-removing unit 770A is formed to extend vertically upward from the first bubble reservoir chamber 520A. Accordingly, bubbles that are mixed into the ink in the first pressure-adjusting unit 120 or the supply flow path 130 due to the circulation and ejection operations can be collected in the first bubble reservoir chamber 520A, and discharged from the ink by the bubble-removing operation. Bubbles that are mixed into the ink include the above-described upstream bubbles, dissolved bubbles, unexpected bubbles, and the like, but are not limited to these, and it is possible to discharge from the ink an amount of bubbles that can be collected in the bubble reservoir chamber 520 and that provides a sufficient bubble-removing speed. Therefore, the possibility of bubbles entering the ejection ports 13 can be significantly reduced.

The first bubble-removing unit 770A communicates with the ink supply unit 400 in the main body portion of the liquid ejection apparatus 50, and is depressurized by the operation of the ink supply unit 400. Furthermore, since the third check valve 213 is provided between the bubble-removing unit 770 and the ink supply unit 400, and the depressurized state is maintained even if the main body portion of the liquid ejection apparatus 50 is not operating all the time, the bubble-removing operation can be performed. It should be noted that the third check valve 213 may be provided in the third air flow path 113 between the first bubble-removing unit 770A and the ink supply unit 400.

Two or more bubble reservoir chambers 520 and two or more bubble-removing units 770 may be provided. In addition, the bubble reservoir chamber 520 and the bubble-removing unit 770 do not necessarily have to be provided in the supply flow path 130. For example, the bubble reservoir chamber 520 and the bubble-removing unit 770 may be provided vertically above the ink tank 2, the first supply path 111, the second supply path 112, the third supply path 910, the filter 110, the pressure chamber 12, and the like. In addition, the bubble reservoir chamber 520 and the bubble-removing unit 770 do not necessarily have to be provided vertically above the fluid communication portion such as the supply flow path 130. As long as a configuration is adopted in which bubbles can be collected and brought into contact with the gas-permeable membrane, the bubble reservoir chamber 520 may communicate with a side surface of the fluid communication portion, and the bubble-removing unit 770 may be formed to extend laterally from the bubble reservoir chamber 520. This also applies to a case where the bubble reservoir chamber 520 and the bubble-removing unit 770 are provided in a plurality of portions of the fluid communication portion other than the supply flow path 130 and the first collecting flow path 140.

### <First Modification of Circulation Path>

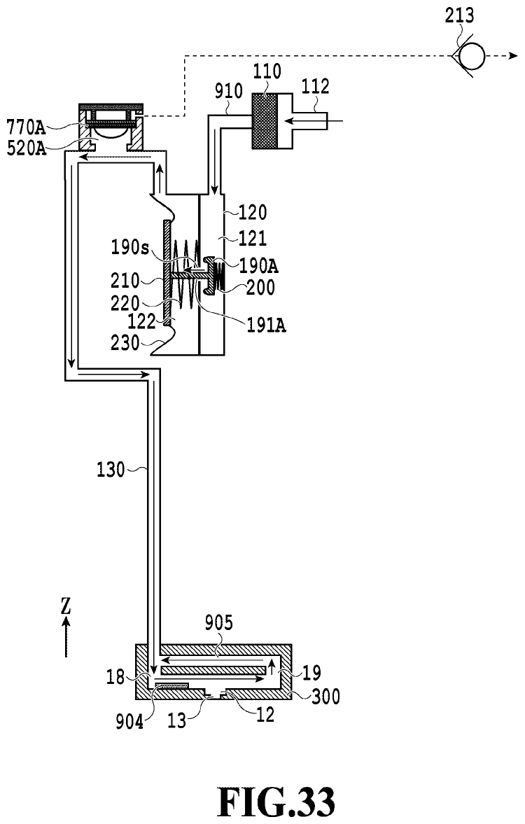

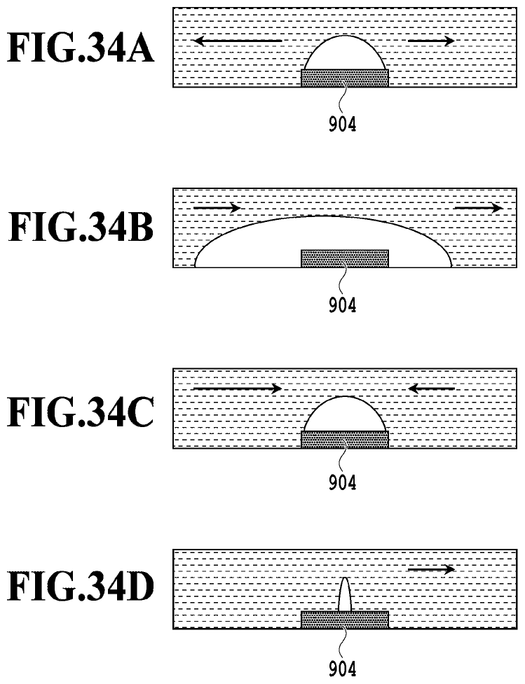

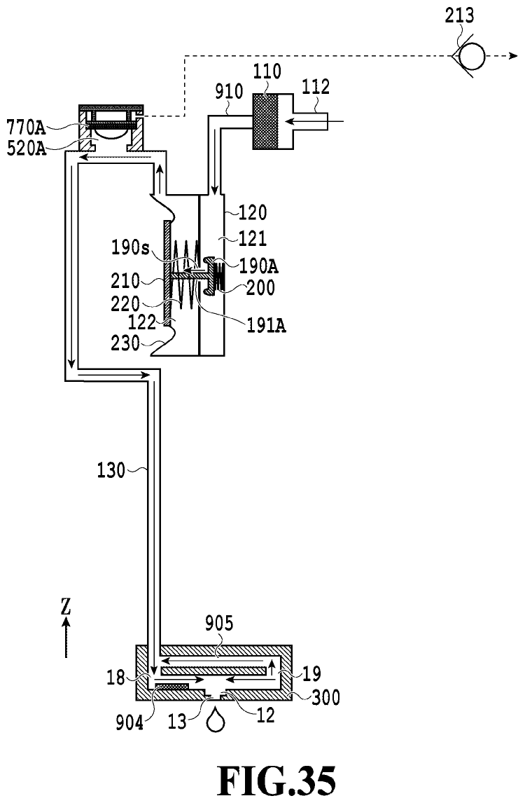

FIGS. 33 and 35 are diagrams schematically showing a first modification of the circulation path. FIG. 33 shows the circulation path in a case where circulation is being performed without performing ejection. FIG. 35 shows the circulation path in a case where high-duty printing is being performed. In addition, FIGS. 34A to 34D are diagrams schematically showing the vicinity of a heating-type circulation pump 904. FIGS. 34A, 34B, 34C, and 34D show the outline of pumping liquid by the heating-type circulation pump 904.

The first modification of the circulation path shows an example in which the second pressure-adjusting unit 150, the second bubble reservoir chamber 520B, the circulation pump 500, the bypass flow path 160, and the first collecting flow path 140 are not arranged. In addition, the first modification of the circulation path shows an example in which, instead of the circulation pump 500 and the like, the heating-type circulation pump 904 provided between the supply flow path 130 and the pressure chamber 12, and a second collecting flow path 905 communicating the pressure chamber 12 and the supply flow path 130 are arranged. In the first modification of the circulation path, during circulation as shown in FIG. 33, the ink is circulated within the ejection module 300 by the heating-type circulation pump 904. In addition, during the ejection operation as shown in FIG. 35, the ink supplied from the second supply path 112 flows in the order of the first pressure-adjusting unit 120, the supply flow path 130 or the second collecting flow path 905, and the pressure chamber 12, and is ejected from the ejection port 13. It should be noted that when high-duty printing is performed, since the ink in the second collecting flow path 905 flows in the direction opposite to the direction at the time of circulation, the ink is supplied to the pressure chamber 12 and the ejection port 13 from both the supply flow path 130 and the second collecting flow path 905. Since the pressure in the first pressure control chamber 122, the supply flow path 130, and the pressure chamber 12 is controlled by the first pressure-adjusting unit 120, stable ink ejection is achieved.

The first bubble reservoir chamber 520A is provided vertically above the supply flow path 130 so as to be in fluid communication with the supply flow path 130, and the first bubble-removing unit 770A is formed to extend vertically upward from the first bubble reservoir chamber 520A. Accordingly, bubbles that are mixed into the ink in the first pressure-adjusting unit 120, the supply flow path 130, the second collecting flow path 905, and the like due to the circulation and ejection operations can be collected in the bubble reservoir chamber 520, and discharged from the ink by the bubble-removing operation. Bubbles that are mixed into the ink include the above-described upstream bubbles, dissolved bubbles, unexpected bubbles, and the like, but are not limited to these, and it is possible to discharge from the ink an amount of bubbles that can be collected in the bubble reservoir chamber 520 and that provides a sufficient bubble-removing speed. Therefore, the possibility of bubbles entering the ejection ports 13 can be significantly reduced.

The first bubble-removing unit 770A communicates with the ink supply unit 400 in the main body portion of the liquid ejection apparatus 50, and is depressurized by the operation of the ink supply unit 400. Furthermore, since the third check valve 213 is provided between the bubble-removing unit 770 and the ink supply unit 400, and the depressurized state is maintained even if the main body portion of the liquid ejection apparatus 50 is not operating all the time, the bubble-removing operation can be performed. It should be noted that the third check valve 213 may be provided in the third air flow path 113 between the first bubble-removing unit 770A and the ink supply unit 400.

Two or more bubble reservoir chambers 520 and two or more bubble-removing units 770 may be provided. In addition, the bubble reservoir chamber 520 and the bubble-removing unit 770 do not necessarily have to be provided in the supply flow path 130. For example, the bubble reservoir chamber 520 and the bubble-removing unit 770 may be provided vertically above the ink tank 2, the first supply path 111, the second supply path 112, the third supply path 910, the filter 110, the pressure chamber 12, the second collecting flow path 905, and the like. In addition, the bubble reservoir chamber 520 and the bubble-removing unit 770 do not necessarily have to be provided vertically above the fluid communication portion such as the supply flow path 130. As long as a configuration is adopted in which bubbles can be collected and brought into contact with the gas-permeable membrane, the bubble reservoir chamber 520 may communicate with a side surface of the fluid communication portion, and the bubble-removing unit 770 may be formed to extend laterally from the bubble reservoir chamber 520. This also applies to a case where the bubble reservoir chamber 520 and the bubble-removing unit 770 are provided in a plurality of portions of the fluid communication portion other than the supply flow path 130 and the first collecting flow path 140.

The heating-type circulation pump 904 is constituted by a heater member capable of heating ink, and heats the ink to generate bubbles from a heater portion to send the ink. First, as shown in FIG. 34A, the ink is rapidly heated by the heater member that constitutes the heating-type circulation pump 904, and bubbles are generated by film boiling and expanded. At this time, the amount of expansion of the bubbles differs between the upstream side and the downstream side of the ink. Next, as shown in FIG. 34B, when the bubbles are expanded to a certain value, heating by the heater is stopped. Next, as shown in FIG. 34C, since heating is stopped, the bubbles contract. At this time, the amount of contraction of bubbles differs between the upstream side and the downstream side of the ink. Finally, as shown in FIG. 34D, since the bubbles completely contract and collapse, the ink flow from the upstream side to the downstream side is generated. By repeating the steps shown in FIGS. 34A, 34B, 34C, and 34D, the ink flow from the supply flow path 130 through the pressure chamber 12 toward the second collecting flow path 905 is regularly generated. It should be noted that the heating-type circulation pump 904 does not necessarily have to be provided between the supply flow path 130 and the pressure chamber 12, and may be provided between the pressure chamber 12 and the second collecting flow path 905.

### <Second Modification of Circulation Path>

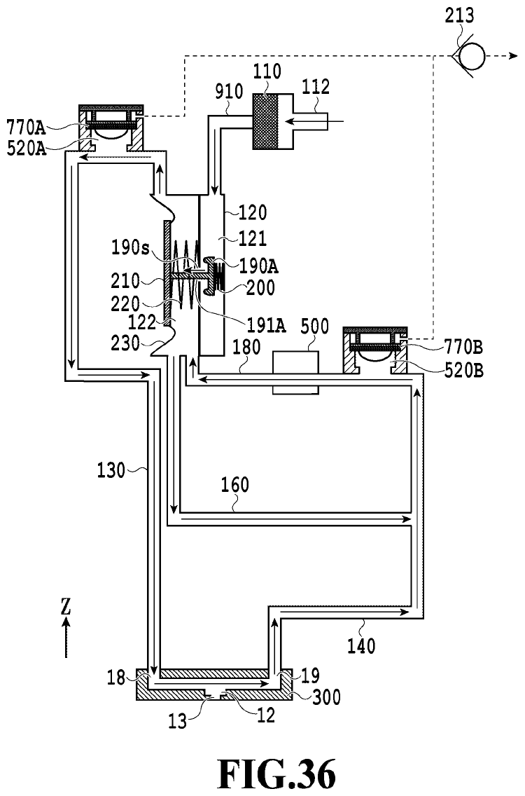

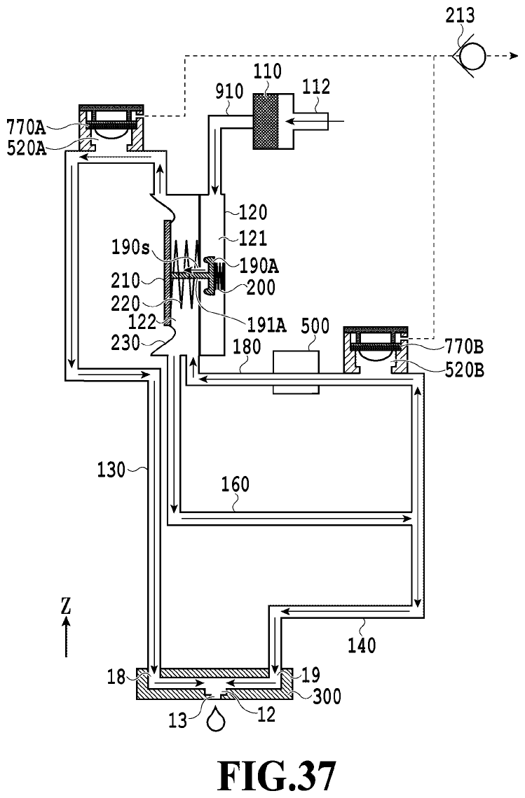

FIGS. 36 and 37 are diagrams schematically showing a second modification of the circulation path. FIG. 36 shows the circulation path in a case where circulation is being performed without performing ejection. FIG. 37 shows the circulation path in a case where high-duty printing is being performed. The second modification of the circulation path shows an example in which the second pressure-adjusting unit 150 is not arranged, and the bypass flow path 160 and the first collecting flow path 140 are directly connected.

In the second modification of the circulation path, it is assumed that the flow path resistance of the ink flow path that flows to the first collecting flow path 140 via the bypass flow path 160 is R1, and the flow path resistance of the ink flow path that flows from the supply flow path 130 to the first collecting flow path 140 via the ejection module 300 is R2. Since the flow rate of the ink flowing through each flow path is the inverse ratio of the flow path resistance, the ratio of the flow rate of the ink in the flow path via the bypass flow path 160 to the flow rate of the ink in the flow path via the ejection module 300 is R2 to R1. According to this relationship, each flow path resistance is set so as to provide a circulation amount that can suppress the increase in viscosity of the ink near the ejection ports 13 in the ejection module 300. That is, each flow path resistance is set so that the flow velocity of the ink in the pressure chamber 12 is equal to or greater than a predetermined flow velocity. The flow path resistance R1 of the flow path via the bypass flow path 160 is controlled by changing the cross-sectional area or length of the flow path, or by providing a restriction in the flow path.

Also in the second modification of the circulation path, when a printing operation is performed at a high duty, as shown in FIG. 37, double-side supply is performed on the pressure chamber 12. That is, the ink supplied from the first pressure control chamber 122 to the supply flow path 130 is supplied to the ejection port 13 via the common supply flow path 18 of the ejection module 300. On the other hand, a part of the ink supplied from the first pressure control chamber 122 to the bypass flow path 160 is supplied to the first pressure control chamber 122 via the circulation pump 500 and the pump outlet flow path 180. In addition, a part of the ink supplied to the bypass flow path 160 is supplied to the first collecting flow path 140, and is supplied to the ejection port 13 via the common collecting flow path 19 of the ejection module 300. Accordingly, the ink to be ejected from the ejection port 13 is supplied from both the supply flow path 130 and the first collecting flow path 140.

The first bubble reservoir chamber 520A is provided vertically above the supply flow path 130 so as to be in fluid communication with the supply flow path 130, and the first bubble-removing unit 770A is formed to extend vertically upward from the first bubble reservoir chamber 520A. In addition, the second bubble reservoir chamber 520B is provided vertically above the first collecting flow path 140 so as to be in fluid communication with the first collecting flow path 140, and the second bubble-removing unit 770B is formed to extend vertically upward from the second bubble reservoir chamber 520B. Accordingly, bubbles that are mixed into the ink in the first pressure-adjusting unit 120, the supply flow path 130, the first collecting flow path 140, and the like due to the circulation and ejection operations can be collected in the bubble reservoir chamber 520, and discharged from the ink by the bubble-removing operation. Bubbles that are mixed into the ink include the above-described upstream bubbles, dissolved bubbles, unexpected bubbles, and the like, but are not limited to these, and it is possible to discharge from the ink an amount of bubbles that can be collected in the bubble reservoir chamber 520 and that provides a sufficient bubble-removing speed. Therefore, the possibility of bubbles entering the ejection ports 13 can be significantly reduced.

The first bubble-removing unit 770A and the second bubble-removing unit 770B are in communication with the ink supply unit 400 in the main body portion of the liquid ejection apparatus 50, and are depressurized by the operation of the ink supply unit 400. Furthermore, since the third check valve 213 is provided between the bubble-removing unit 770 and the ink supply unit 400, and the depressurized state is maintained even if the main body portion of the liquid ejection apparatus 50 is not operating all the time, the bubble-removing operation can be performed. It should be noted that the third check valve 213 may be provided at each of the branched portions of the third air flow path 113 between the ink supply unit 400 and the first bubble-removing unit 770A and between the ink supply unit 400 and the second bubble-removing unit 770B. The third check valve 213 may be provided at a portion where the third air flow path 113 is concentrated between the ink supply unit 400 and the first bubble-removing unit 770A and the second bubble-removing unit 770B.

The bubble reservoir chamber 520 and the bubble-removing unit 770 do not necessarily have to be provided in both the supply flow path 130 and the first collecting flow path 140, and may be provided only in the supply flow path 130, or may be provided only in the first collecting flow path 140. In addition, three or more bubble reservoir chambers 520 and three or more bubble-removing units 770 may be provided. The bubble reservoir chamber 520 and the bubble-removing unit 770 do not necessarily have to be provided in the supply flow path 130 and the first collecting flow path 140. For example, the bubble reservoir chamber 520 and the bubble-removing unit 770 may be provided vertically above the ink tank 2, the first supply path 111, the second supply path 112, the third supply path 910, and the like. The bubble reservoir chamber 520 and the bubble-removing unit 770 may be provided vertically above the filter 110, the pump outlet flow path 180, the bypass flow path 160, the pressure chamber 12, and the like. In addition, the bubble reservoir chamber 520 and the bubble-removing unit 770 do not necessarily have to be provided vertically above the fluid communication portion such as the supply flow path 130. As long as a configuration is adopted in which bubbles can be collected and brought into contact with the gas-permeable membrane, the bubble reservoir chamber 520 may communicate with a side surface of the fluid communication portion, and the bubble-removing unit 770 may be formed to extend laterally from the bubble reservoir chamber 520. This also applies to a case where the bubble reservoir chamber 520 and the bubble-removing unit 770 are provided in a plurality of portions of the fluid communication portion other than the supply flow path 130 and the first collecting flow path 140.

### <Third Modification of Circulation Path>

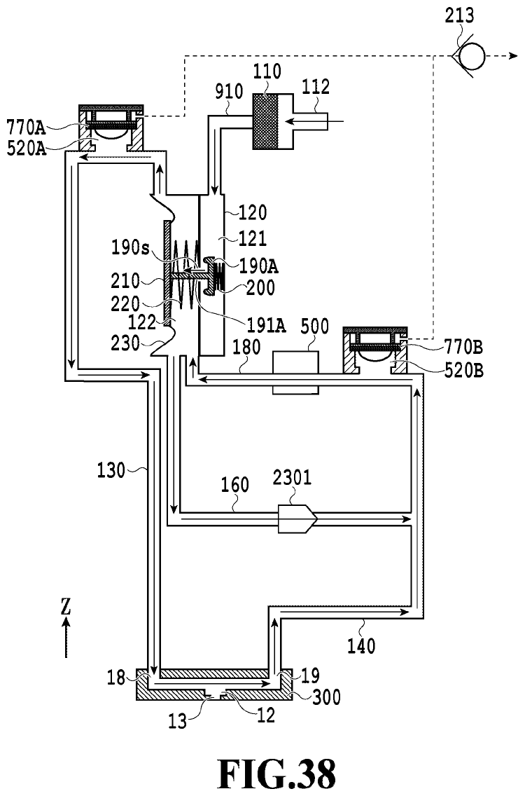

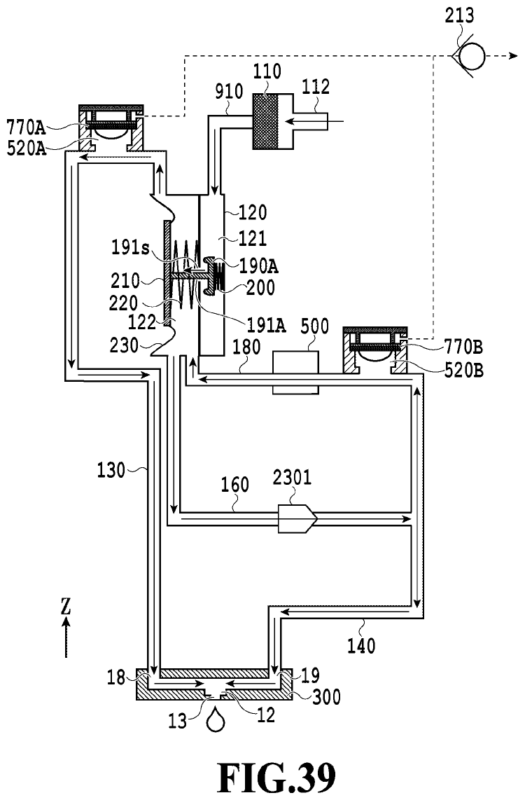

FIGS. 38 and 39 are diagrams schematically showing a third modification of the circulation path. FIG. 38 shows the circulation path in a case where circulation is being performed without performing ejection. FIG. 39 shows the circulation path in a case where high-duty printing is being performed. The third modification of the circulation path shows an example in which the second pressure-adjusting unit 150 is not arranged, the bypass flow path 160 and the first collecting flow path 140 are directly connected, and a relief valve 2301 is arranged in the bypass flow path 160.

The relief valve 2301 is configured such that when the pressure of the ink on the downstream side of the relief valve 2301 becomes a certain value or less, the ink flows from the upstream side to the downstream side of the relief valve 2301. That is, the relief valve 2301 is configured to open when the pressure of the ink on the collecting flow path side is lower than that on the supply flow path side in the relief valve 2301 by the certain value. As shown in FIGS. 38 and 39, the flow of ink in the third modification of the circulation path is basically the same as that in the case where the second pressure-adjusting unit 150 is arranged. The circulation amount in the ejection module 300 is determined by the differential pressure between the control pressure of the first pressure control chamber 122 and the control pressure of the relief valve 2301. The control pressure of the relief valve 2301 is set so as to provide a circulation amount that can suppress the increase in viscosity of the ink near the ejection ports 13 in the ejection module 300.

In the third modification of the circulation path, when a printing operation is performed at a high duty, as shown in FIG. 39, double-side supply is performed on the pressure chamber 12. That is, the ink supplied from the first pressure control chamber 122 to the supply flow path 130 is supplied to the ejection port 13 via the common supply flow path 18 of the ejection module 300. On the other hand, a part of the ink supplied from the first pressure control chamber 122 to the bypass flow path 160 passes through the relief valve 2301, and is supplied to the first pressure control chamber 122 via the circulation pump 500 and the pump outlet flow path 180. In addition, a part of the ink supplied to the bypass flow path 160 passes through the relief valve 2301, is supplied to the first collecting flow path 140, and is supplied to the ejection port 13 via the common collecting flow path 19 of the ejection module 300. Accordingly, the ink to be ejected from the ejection port 13 is supplied from both the supply flow path 130 and the first collecting flow path 140.

The first bubble reservoir chamber 520A is provided vertically above the supply flow path 130 so as to be in fluid communication with the supply flow path 130, and the first bubble-removing unit 770A is formed to extend vertically upward from the first bubble reservoir chamber 520A. In addition, the second bubble reservoir chamber 520B is provided vertically above the first collecting flow path 140 so as to be in fluid communication with the first collecting flow path 140, and the second bubble-removing unit 770B is formed to extend vertically upward from the second bubble reservoir chamber 520B. Accordingly, bubbles that are mixed into the ink in the first pressure-adjusting unit 120, the supply flow path 130, the first collecting flow path 140, and the like due to the circulation and ejection operations can be collected in the bubble reservoir chamber 520, and discharged from the ink by the bubble-removing operation. Bubbles that are mixed into the ink include the above-described upstream bubbles, dissolved bubbles, unexpected bubbles, and the like, but are not limited to these, and it is possible to discharge from the ink an amount of bubbles that can be collected in the bubble reservoir chamber 520 and that provides a sufficient bubble-removing speed. Therefore, the possibility of bubbles entering the ejection ports 13 can be significantly reduced.

The first bubble-removing unit 770A and the second bubble-removing unit 770B are in communication with the ink supply unit 400 in the main body portion of the liquid ejection apparatus 50, and are depressurized by the operation of the ink supply unit 400. Furthermore, since the third check valve 213 is provided between the bubble-removing unit 770 and the ink supply unit 400, and the depressurized state is maintained even if the main body portion of the liquid ejection apparatus 50 is not operating all the time, the bubble-removing operation can be performed. It should be noted that the third check valve 213 may be provided at each of the branched portions of the third air flow path 113 between the ink supply unit 400 and the first bubble-removing unit 770A and between the ink supply unit 400 and the second bubble-removing unit 770B. The third check valve 213 may be provided at a portion where the third air flow path 113 is concentrated between the ink supply unit 400 and the first bubble-removing unit 770A and the second bubble-removing unit 770B.

The bubble reservoir chamber 520 and the bubble-removing unit 770 do not necessarily have to be provided in both the supply flow path 130 and the first collecting flow path 140, and may be provided only in the supply flow path 130, or may be provided only in the first collecting flow path 140. In addition, three or more bubble reservoir chambers 520 and three or more bubble-removing units 770 may be provided. The bubble reservoir chamber 520 and the bubble-removing unit 770 do not necessarily have to be provided in the supply flow path 130 and the first collecting flow path 140. For example, the bubble reservoir chamber 520 and the bubble-removing unit 770 may be provided vertically above the ink tank 2, the first supply path 111, the second supply path 112, the third supply path 910, and the like. The bubble reservoir chamber 520 and the bubble-removing unit 770 may be provided vertically above the filter 110, the pump outlet flow path 180, the bypass flow path 160, the pressure chamber 12, and the like. In addition, the bubble reservoir chamber 520 and the bubble-removing unit 770 do not necessarily have to be provided vertically above the fluid communication portion such as the supply flow path 130. As long as a configuration is adopted in which bubbles can be collected and brought into contact with the gas-permeable membrane, the bubble reservoir chamber 520 may communicate with a side surface of the fluid communication portion, and the bubble-removing unit 770 may be formed to extend laterally from the bubble reservoir chamber 520. This also applies to a case where the bubble reservoir chamber 520 and the bubble-removing unit 770 are provided in a plurality of portions of the fluid communication portion other than the supply flow path 130 and the first collecting flow path 140.

### <Second Configuration Example of Ink Path>

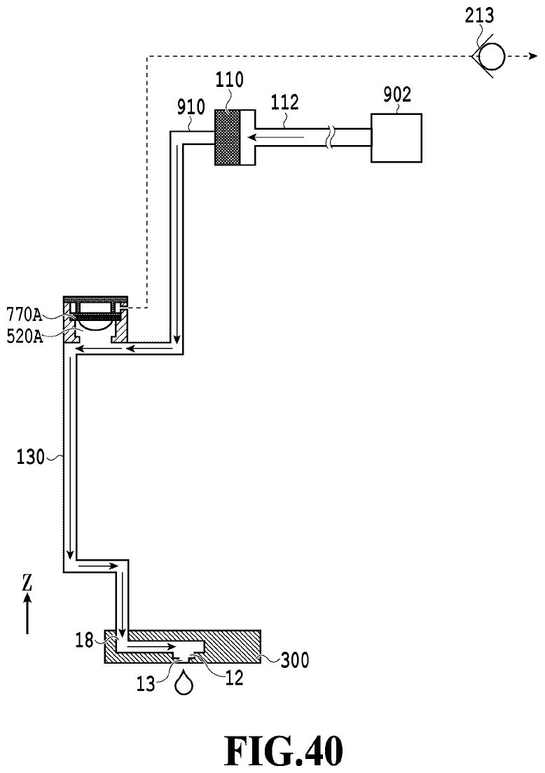

FIG. 40 is a diagram schematically showing a second configuration example of the ink path. The second configuration example of the ink path shows an example in which the first pressure-adjusting unit 120, the second pressure-adjusting unit 150, the second bubble reservoir chamber 520B, the circulation pump 500, the bypass flow path 160, and the first collecting flow path 140 are not arranged. In addition, the second configuration example of the ink path shows an example in which a third pressure-adjusting unit 902 communicating with the second supply path 112 is arranged instead of the first pressure-adjusting unit 120, the second pressure-adjusting unit 150, and the like. In the second configuration example of the ink path, the circulation of ink is not performed, and the ink supplied from the second supply path 112 flows in the order of the supply flow path 130 and the pressure chamber 12 and is ejected from the ejection port 13. Since the pressure in the second supply path 112, the third supply path 910, the supply flow path 130, and the pressure chamber 12 is controlled by the third pressure-adjusting unit 902, stable ink ejection is achieved.

The third pressure-adjusting unit 902 is arranged outside the liquid ejection head 1, and communicates with the third supply path 910 of the liquid ejection head 1 via the second supply path 112. The third pressure-adjusting unit 902 may be of, for example, the water head method that utilizes a water head difference, but can be applied to any method. This modification can also be applied to ink cartridge methods and ink supply methods such as the CISS method.

The first bubble reservoir chamber 520A is provided vertically above the supply flow path 130 so as to be in fluid communication with the supply flow path 130, and the first bubble-removing unit 770A is formed to extend vertically upward from the first bubble reservoir chamber 520A. Accordingly, bubbles that are mixed into the ink in the supply flow path 130 and the like due to the circulation and ejection operations can be collected in the bubble reservoir chamber 520A, and discharged from the ink by the bubble-removing operation. Bubbles that are mixed into the ink include the above-described upstream bubbles, dissolved bubbles, unexpected bubbles, and the like, but are not limited to these, and it is possible to discharge from the ink an amount of bubbles that can be collected in the bubble reservoir chamber 520 and that provides a sufficient bubble-removing speed. Therefore, the possibility of bubbles entering the ejection ports 13 can be significantly reduced.

The first bubble-removing unit 770A communicates with the ink supply unit 400 in the main body portion of the liquid ejection apparatus 50, and is depressurized by the operation of the ink supply unit 400. Furthermore, since the third check valve 213 is provided between the bubble-removing unit 770 and the ink supply unit 400, and the depressurized state is maintained even if the main body portion of the liquid ejection apparatus 50 is not operating all the time, the bubble-removing operation can be performed. It should be noted that the third check valve 213 may be provided in the third air flow path 113 between the first bubble-removing unit 770A and the ink supply unit 400.

Two or more bubble reservoir chambers 520 and two or more bubble-removing units 770 may be provided. In addition, the bubble reservoir chamber 520 and the bubble-removing unit 770 do not necessarily have to be provided in the supply flow path 130. For example, the bubble reservoir chamber 520 and the bubble-removing unit 770 may be provided vertically above the ink tank 2, the first supply path 111, the second supply path 112, the third supply path 910, the filter 110, the pressure chamber 12, and the like. In addition, the bubble reservoir chamber 520 and the bubble-removing unit 770 do not necessarily have to be provided vertically above the fluid communication portion such as the supply flow path 130. As long as a configuration is adopted in which bubbles can be collected and brought into contact with the gas-permeable membrane, the bubble reservoir chamber 520 may communicate with a side surface of the fluid communication portion, and the bubble-removing unit 770 may be formed to extend laterally from the bubble reservoir chamber 520. This also applies to a case where the bubble reservoir chamber 520 and the bubble-removing unit 770 are provided in a plurality of portions of the fluid communication portion other than the supply flow path 130 and the first collecting flow path 140.

### <Fourth Modification of Circulation Path>

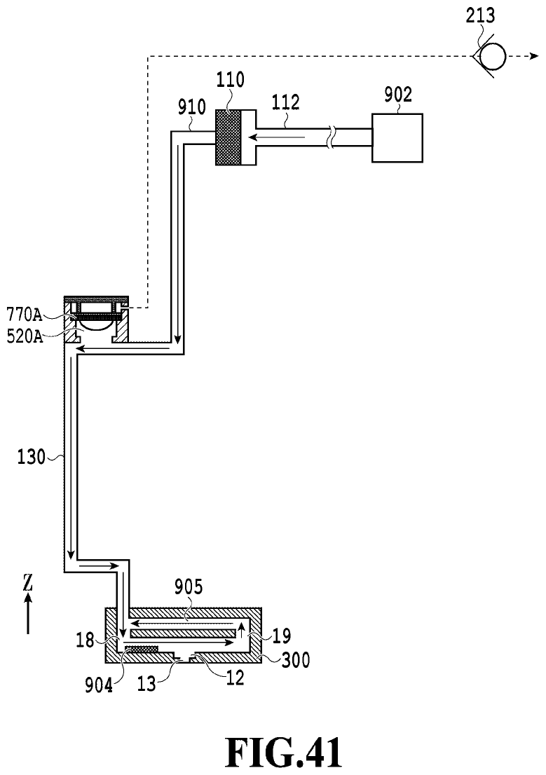

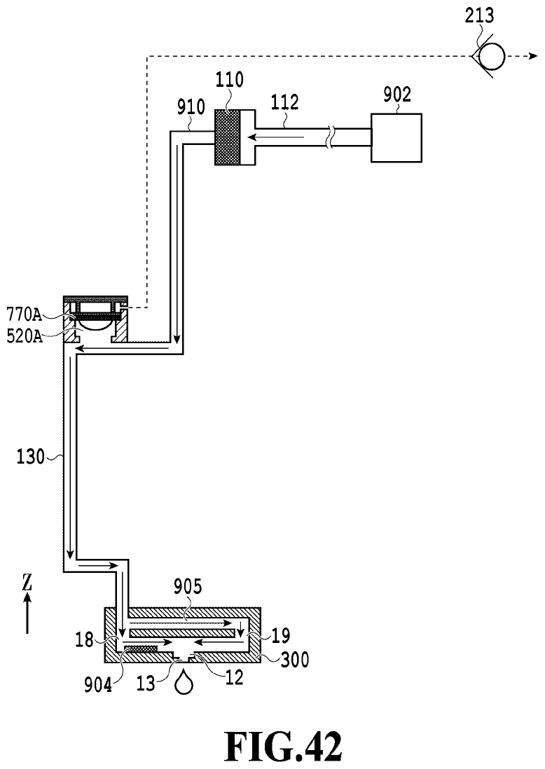

FIGS. 41 and 42 are diagrams schematically showing a fourth modification of the circulation path. FIG. 41 shows the circulation path in a case where circulation is being performed without performing ejection. FIG. 42 shows the circulation path in a case where high-duty printing is being performed. The fourth modification of the circulation path shows an example in which the first pressure-adjusting unit 120, the second pressure-adjusting unit 150, the second bubble reservoir chamber 520B, the circulation pump 500, the bypass flow path 160, and the first collecting flow path 140 are not arranged. In addition, the fourth modification of the circulation path shows an example in which the third pressure-adjusting unit 902 communicating with the second supply path 112, the heating-type circulation pump 904 provided between the supply flow path 130 and the pressure chamber 12, and the second collecting flow path 905 communicating the pressure chamber 12 and the supply flow path 130 are arranged. In the fourth modification of the circulation path, the flow of ink similar to those in FIGS. 33 and 35 is generated. Since the pressure in the second supply path 112, the third supply path 910, the supply flow path 130, and the pressure chamber 12 is controlled by the third pressure-adjusting unit 902, stable ink ejection is achieved.

The third pressure-adjusting unit 902 is arranged outside the liquid ejection head 1, and communicates with the third supply path 910 of the liquid ejection head 1 via the second supply path 112. The third pressure-adjusting unit 902 may be of, for example, the water head method that utilizes a water head difference, but can be applied to any method. This modification can also be applied to ink cartridge methods and ink supply methods such as the CISS method.

The first bubble reservoir chamber 520A is provided vertically above the supply flow path 130 so as to be in fluid communication with the supply flow path 130, and the first bubble-removing unit 770A is formed to extend vertically upward from the first bubble reservoir chamber 520A. Accordingly, bubbles that are mixed into the ink in the first pressure-adjusting unit 120, the supply flow path 130, the second collecting flow path 905, and the like due to the circulation and ejection operations can be collected in the bubble reservoir chamber 520, and discharged from the ink by the bubble-removing operation. Bubbles that are mixed into the ink include the above-described upstream bubbles, dissolved bubbles, unexpected bubbles, and the like, but are not limited to these, and it is possible to discharge from the ink an amount of bubbles that can be collected in the bubble reservoir chamber 520 and that provides a sufficient bubble-removing speed. Therefore, the possibility of bubbles entering the ejection ports 13 can be significantly reduced.

The first bubble-removing unit 770A communicates with the ink supply unit 400 in the main body portion of the liquid ejection apparatus 50, and is depressurized by the operation of the ink supply unit 400. Furthermore, since the third check valve 213 is provided between the bubble-removing unit 770 and the ink supply unit 400, and the depressurized state is maintained even if the main body portion of the liquid ejection apparatus 50 is not operating all the time, the bubble-removing operation can be performed. It should be noted that the third check valve 213 may be provided in the third air flow path 113 between the first bubble-removing unit 770A and the ink supply unit 400.

Two or more bubble reservoir chambers 520 and two or more bubble-removing units 770 may be provided. In addition, the bubble reservoir chamber 520 and the bubble-removing unit 770 do not necessarily have to be provided in the supply flow path 130. For example, the bubble reservoir chamber 520 and the bubble-removing unit 770 may be provided vertically above the ink tank 2, the first supply path 111, the second supply path 112, the third supply path 910, the filter 110, the pressure chamber 12, the second collecting flow path 905, and the like. In addition, the bubble reservoir chamber 520 and the bubble-removing unit 770 do not necessarily have to be provided vertically above the fluid communication portion such as the supply flow path 130. As long as a configuration is adopted in which bubbles can be collected and brought into contact with the gas-permeable membrane, the bubble reservoir chamber 520 may communicate with a side surface of the fluid communication portion, and the bubble-removing unit 770 may be formed to extend laterally from the bubble reservoir chamber 520. This also applies to a case where the bubble reservoir chamber 520 and the bubble-removing unit 770 are provided in a plurality of portions of the fluid communication portion other than the supply flow path 130 and the first collecting flow path 140.

The heating-type circulation pump 904 sends the ink by performing the same operations as those in FIGS. 34A to 34D. It should be noted that the heating-type circulation pump 904 does not necessarily have to be provided between the supply flow path 130 and the pressure chamber 12, and may be provided between the pressure chamber 12 and the second collecting flow path 905.

### <Fifth Modification of Circulation Path>

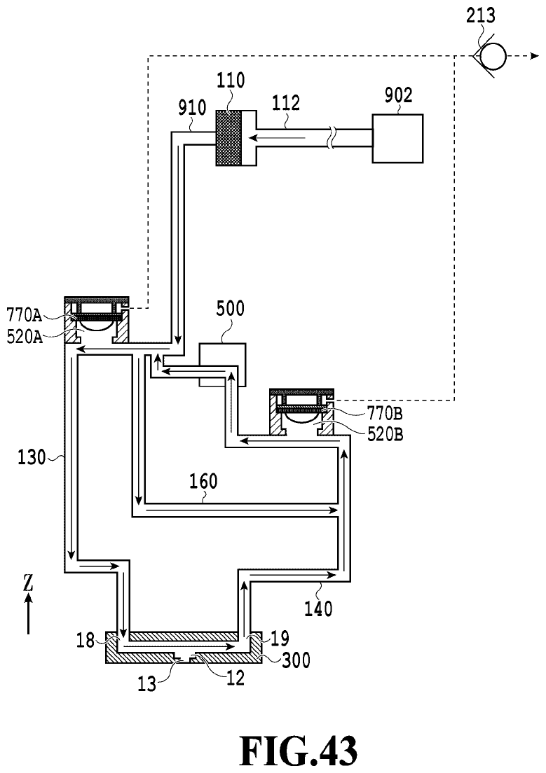

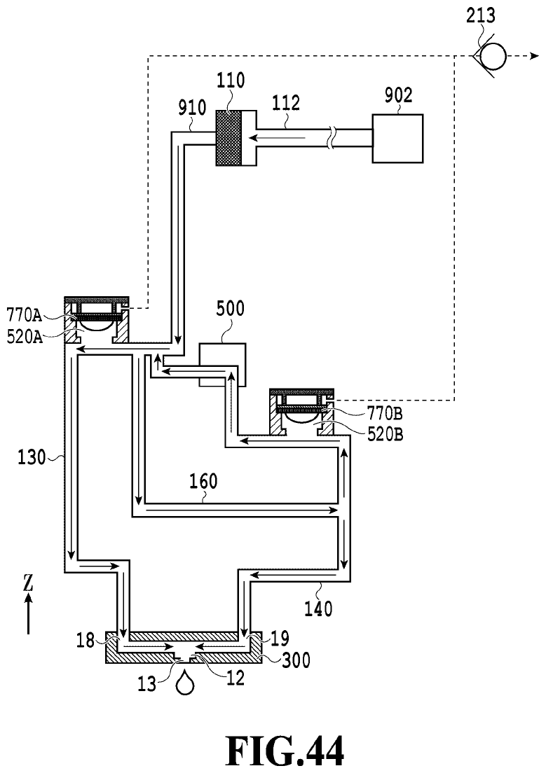

FIGS. 43 and 44 are diagrams schematically showing a fifth modification of the circulation path. FIG. 43 shows the circulation path in a case where circulation is being performed without performing ejection. FIG. 44 shows the circulation path in a case where high-duty printing is being performed. The fifth modification of the circulation path shows an example in which the first pressure-adjusting unit 120 and the second pressure-adjusting unit 150 are not arranged, and the bypass flow path 160 and the first collecting flow path 140 are directly connected.

In the fifth modification of the circulation path, it is assumed that the flow path resistance of the ink flow path that flows to the first collecting flow path 140 via the bypass flow path 160 is R1, and the flow path resistance of the ink flow path that flows from the supply flow path 130 to the first collecting flow path 140 via the ejection module 300 is R2. Since the flow rate of the ink flowing through each flow path is the inverse ratio of the flow path resistance, the ratio of the flow rate of the ink in the flow path via the bypass flow path 160 to the flow rate of the ink in the flow path via the ejection module 300 is R2 to R1. According to this relationship, each flow path resistance is set so as to provide a circulation amount that can suppress the increase in viscosity of the ink near the ejection ports 13 in the ejection module 300. That is, each flow path resistance is set so that the flow velocity of the ink in the pressure chamber 12 is equal to or greater than a predetermined flow velocity. The flow path resistance R1 of the flow path via the bypass flow path 160 is controlled by changing the cross-sectional area or length of the flow path, or by providing a restriction in the flow path.

Also in the fifth modification of the circulation path, when a printing operation is performed at a high duty, as shown in FIG. 44, double-side supply is performed on the pressure chamber 12. That is, the ink supplied from the third supply path 910 to the supply flow path 130 is supplied to the ejection port 13 of the ejection module 300. On the other hand, a part of the ink supplied from the third supply path 910 to the bypass flow path 160 is supplied to the third supply path 910 via the circulation pump 500. In addition, a part of the ink supplied from the third supply path 910 to the bypass flow path 160 is supplied to the first collecting flow path 140, and is supplied to the ejection port 13 of the ejection module 300. Accordingly, the ink to be ejected from the ejection port 13 is supplied from both the supply flow path 130 and the first collecting flow path 140.

The third pressure-adjusting unit 902 is arranged outside the liquid ejection head 1, and communicates with the third supply path 910 of the liquid ejection head 1 via the second supply path 112. The third pressure-adjusting unit 902 may be of, for example, the water head method that utilizes a water head difference, but can be applied to any method. This modification can also be applied to ink cartridge methods and ink supply methods such as the CISS method.

The first bubble reservoir chamber 520A is provided vertically above the supply flow path 130 so as to be in fluid communication with the supply flow path 130, and the first bubble-removing unit 770A is formed to extend vertically upward from the first bubble reservoir chamber 520A. In addition, the second bubble reservoir chamber 520B is provided vertically above the first collecting flow path 140 so as to be in fluid communication with the first collecting flow path 140, and the second bubble-removing unit 770B is formed to extend vertically upward from the second bubble reservoir chamber 520B. Accordingly, bubbles that are mixed into the ink in the supply flow path 130, the first collecting flow path 140, the pump inlet flow path 170, the pump outlet flow path 180, and the like due to the circulation and ejection operations can be collected in the bubble reservoir chamber 520, and discharged from the ink by the bubble-removing operation. Bubbles that are mixed into the ink include the above-described upstream bubbles, dissolved bubbles, unexpected bubbles, and the like, but are not limited to these, and it is possible to discharge from the ink an amount of bubbles that can be collected in the bubble reservoir chamber 520 and that provides a sufficient bubble-removing speed. Therefore, the possibility of bubbles entering the ejection ports 13 can be significantly reduced.

The first bubble-removing unit 770A and the second bubble-removing unit 770B communicate with the ink supply unit 400 in the main body portion of the liquid ejection apparatus 50, and are depressurized by the operation of the ink supply unit 400. Furthermore, since the third check valve 213 is provided between the bubble-removing unit 770 and the ink supply unit 400, and the depressurized state is maintained even if the main body portion of the liquid ejection apparatus 50 is not operating all the time, the bubble-removing operation can be performed. It should be noted that the third check valve 213 may be provided at each of the branched portions of the third air flow path 113 between the ink supply unit 400 and the first bubble-removing unit 770A and between the ink supply unit 400 and the second bubble-removing unit 770B. The third check valve 213 may be provided at a portion where the third air flow path 113 is concentrated between the ink supply unit 400 and the first bubble-removing unit 770A and the second bubble-removing unit 770B.

The bubble reservoir chamber 520 and the bubble-removing unit 770 do not necessarily have to be provided in both the supply flow path 130 and the first collecting flow path 140, and may be provided only in the supply flow path 130, or may be provided only in the first collecting flow path 140. In addition, three or more bubble reservoir chambers 520 and three or more bubble-removing units 770 may be provided. The bubble reservoir chamber 520 and the bubble-removing unit 770 do not necessarily have to be provided in the supply flow path 130 and the first collecting flow path 140. For example, the bubble reservoir chamber 520 and the bubble-removing unit 770 may be provided vertically above the ink tank 2, the first supply path 111, the second supply path 112, the third supply path 910, and the like. The bubble reservoir chamber 520 and the bubble-removing unit 770 may be provided vertically above the filter 110, the pump inlet flow path 170, the pump outlet flow path 180, the bypass flow path 160, the pressure chamber 12, and the like. In addition, the bubble reservoir chamber 520 and the bubble-removing unit 770 do not necessarily have to be provided vertically above the fluid communication portion such as the supply flow path 130. As long as a configuration is adopted in which bubbles can be collected and brought into contact with the gas-permeable membrane, the bubble reservoir chamber 520 may communicate with a side surface of the fluid communication portion, and the bubble-removing unit 770 may be formed to extend laterally from the bubble reservoir chamber 520. This also applies to a case where the bubble reservoir chamber 520 and the bubble-removing unit 770 are provided in a plurality of portions of the fluid communication portion other than the supply flow path 130 and the first collecting flow path 140.

### <Sixth Modification of Circulation Path>

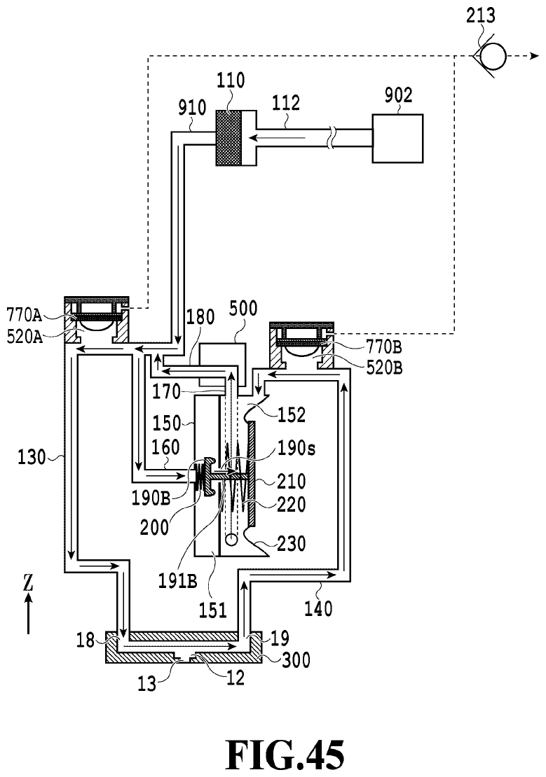

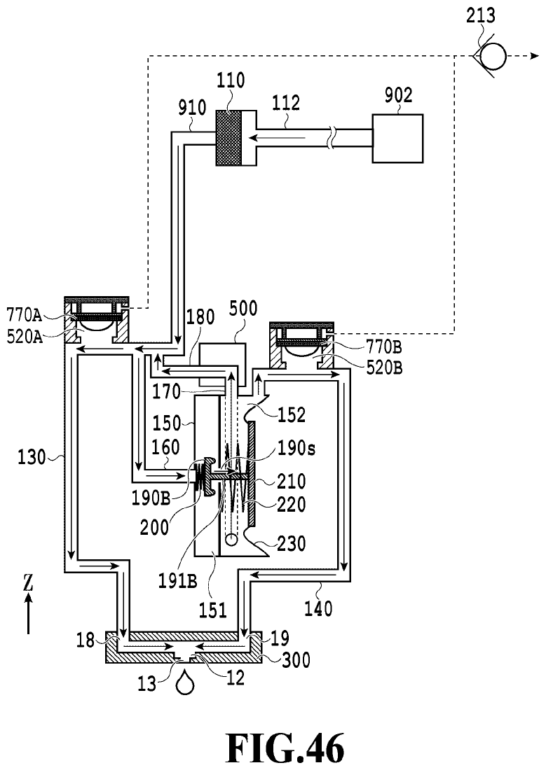

FIGS. 45 and 46 are diagrams schematically showing a sixth modification of the circulation path. FIG. 45 shows the circulation path in a case where circulation is being performed without performing ejection. FIG. 46 shows the circulation path in a case where high-duty printing is being performed. The sixth modification of the circulation path shows an example in which the first pressure-adjusting unit 120 is not arranged, and the third pressure-adjusting unit 902 communicating with the second supply path 112 is arranged.

Also in the sixth modification of the circulation path, when a printing operation is performed at a high duty, as shown in FIG. 46, double-side supply is performed on the pressure chamber 12. That is, the ink supplied from the third supply path 910 to the supply flow path 130 is supplied to the ejection port 13 of the ejection module 300. On the other hand, a part of the ink supplied from the third supply path 910 to the bypass flow path 160 is supplied to the third supply path 910 via the second pressure-adjusting unit 150, the pump inlet flow path 170, the circulation pump 500, and the pump outlet flow path 180. In addition, a part of the ink supplied to the bypass flow path 160 is supplied to the first collecting flow path 140 via the second pressure-adjusting unit 150, and is supplied to the ejection port 13 of the ejection module 300. Accordingly, the ink to be ejected from the ejection port 13 is supplied from both the supply flow path 130 and the first collecting flow path 140.

The third pressure-adjusting unit 902 is arranged outside the liquid ejection head 1, and communicates with the third supply path 910 of the liquid ejection head 1 via the second supply path 112. The third pressure-adjusting unit 902 may be of, for example, the water head method that utilizes a water head difference, but can be applied to any method. This modification can also be applied to ink cartridge methods and ink supply methods such as the CISS method.

The first bubble reservoir chamber 520A is provided vertically above the supply flow path 130 so as to be in fluid communication with the supply flow path 130, and the first bubble-removing unit 770A is formed to extend vertically upward from the first bubble reservoir chamber 520A. In addition, the second bubble reservoir chamber 520B is provided vertically above the first collecting flow path 140 so as to be in fluid communication with the first collecting flow path 140, and the second bubble-removing unit 770B is formed to extend vertically upward from the second bubble reservoir chamber 520B. Accordingly, bubbles that are mixed into the ink in the second pressure-adjusting unit 150, the supply flow path 130, the first collecting flow path 140, the pump outlet flow path 180, and the like due to the circulation and discharge operations can be collected in the bubble reservoir chamber 520, and discharged from the ink by the bubble removal operation. Bubbles that are mixed into the ink include the above-described upstream bubbles, dissolved bubbles, unexpected bubbles, and the like, but are not limited to these, and it is possible to discharge from the ink an amount of bubbles that can be collected in the bubble reservoir chamber 520 and that provides a sufficient bubble-removing speed. Therefore, the possibility of bubbles entering the ejection ports 13 can be significantly reduced.

The first bubble-removing unit 770A and the second bubble-removing unit 770B are in communication with the ink supply unit 400 in the main body portion of the liquid ejection apparatus 50, and are depressurized by the operation of the ink supply unit 400. Furthermore, since the third check valve 213 is provided between the bubble-removing unit 770 and the ink supply unit 400, and the depressurized state is maintained even if the main body portion of the liquid ejection apparatus 50 is not operating all the time, the bubble-removing operation can be performed. It should be noted that the third check valve 213 may be provided at each of the branched portions of the third air flow path 113 between the ink supply unit 400 and the first bubble-removing unit 770A and between the ink supply unit 400 and the second bubble-removing unit 770B. The third check valve 213 may be provided at a portion where the third air flow path 113 is concentrated between the ink supply unit 400 and the first bubble-removing unit 770A and the second bubble-removing unit 770B.

The bubble reservoir chamber 520 and the bubble-removing unit 770 do not necessarily have to be provided in both the supply flow path 130 and the first collecting flow path 140, and may be provided only in the supply flow path 130, or may be provided only in the first collecting flow path 140. In addition, three or more bubble reservoir chambers 520 and three or more bubble-removing units 770 may be provided. The bubble reservoir chamber 520 and the bubble-removing unit 770 do not necessarily have to be provided in the supply flow path 130 and the first collecting flow path 140. For example, the bubble reservoir chamber 520 and the bubble-removing unit 770 may be provided vertically above the ink tank 2, the first supply path 111, the second supply path 112, the third supply path 910, and the like. The bubble reservoir chamber 520 and the bubble-removing unit 770 may be provided vertically above the filter 110, the pump inlet flow path 170, the pump outlet flow path 180, the bypass flow path 160, the pressure chamber 12, and the like. In addition, the bubble reservoir chamber 520 and the bubble-removing unit 770 do not necessarily have to be provided vertically above the fluid communication portion such as the supply flow path 130. As long as a configuration is adopted in which bubbles can be collected and brought into contact with the gas-permeable membrane, the bubble reservoir chamber 520 may communicate with a side surface of the fluid communication portion, and the bubble-removing unit 770 may be formed to extend laterally from the bubble reservoir chamber 520. This also applies to a case where the bubble reservoir chamber 520 and the bubble-removing unit 770 are provided in a plurality of portions of the fluid communication portion other than the supply flow path 130 and the first collecting flow path 140.

### <Other Modifications of Circulation Path>

Next, other modifications of the circulation flow path will be described. As described above, the configuration in which the ink flows back from the first collecting flow path 140 toward the pressure chamber 12 may be provided with the bypass flow path 160. At the same time, the configuration in which the ink flows back from the first collecting flow path 140 toward the pressure chamber 12 may be provided with no mechanism that functions as a check valve between a confluence portion of the bypass flow path 160 and the pressure chamber 12. Therefore, as long as the circulation flow path can maintain this relationship, since double-side supply of the ink can be performed on the pressure chamber 12, ejection stability can be improved.

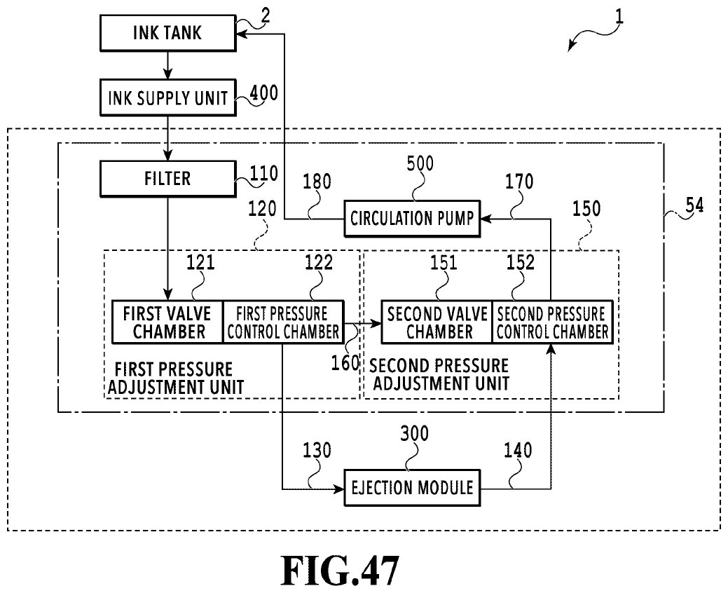

FIGS. 47, 48, and 49 are block diagrams schematically showing other modifications of the circulation path. In FIGS. 47, 48, and 49, illustration of the bubble-removing unit 770 and gas flow paths connected to the bubble-removing unit 770 (for example, the third air flow path 113, and the like) is omitted.

FIG. 47 is an example in which the pump outlet flow path 180 located on the downstream side of the circulation pump 500 is configured to be connected to the ink tank 2 instead of the first pressure control chamber 122. Also in this configuration, ejection stability can be improved as in the configurations described so far.

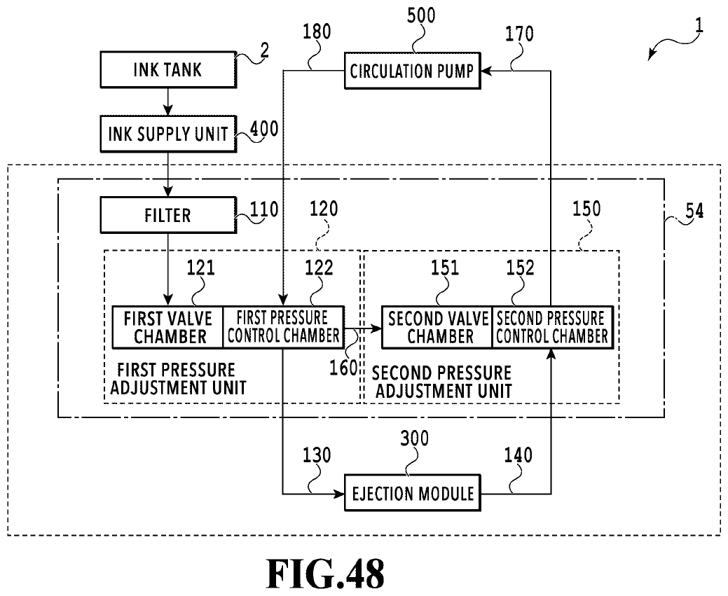

FIG. 48 is an example in which the circulation pump 500, which has been mounted inside the liquid ejection head 1, is installed on the main body side of the liquid ejection apparatus 50. A part of the pump inlet flow path 170 and a part of the pump outlet flow path 180 are also arranged outside the liquid ejection head 1. Also in this configuration, ejection stability can be improved as in the configurations described so far.

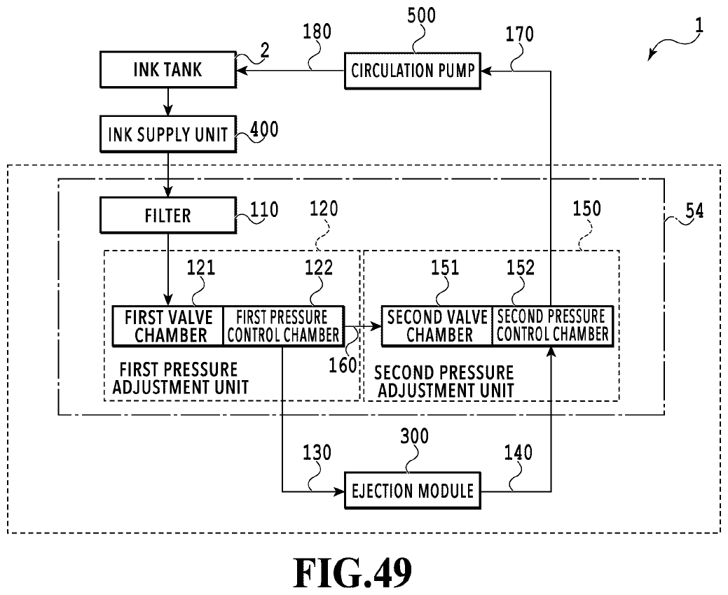

FIG. 49 is an example in which the circulation pump 500, which has been mounted inside the liquid ejection head 1, is installed on the main body side of the liquid ejection apparatus 50, and the pump outlet flow path 180 is connected to the ink tank 2. Also in this configuration, ejection stability can be improved as in the configurations described so far.

### First Embodiment

Hereinafter, a first embodiment of the present disclosure will be described with reference to the drawings. It should be noted that the liquid ejection head 1 to which the present embodiment can be applied as described with reference to FIG. 1A has been illustrated by taking, as an example, the so-called serial type liquid ejection head that ejects ink while moving in the main scanning direction, but this is not a limitation. The liquid ejection head 1 may be a so-called full-line type liquid ejection head in which ejection ports are formed across the entire width direction of the printing medium P, and ejection can be performed across the entire width direction of the printing medium P without movement in the main scanning direction.

A circulation-type liquid ejection head tends to have a larger ink storage volume inside the liquid ejection head due to the influence of a pressure adjustment mechanism and the like, compared to a non-circulation type ejection head. Generally, when the ink storage volume inside the liquid ejection head is increased, the amount of remaining air bubbles at the time when the liquid ejection head is filled with ink tends to be increased. In addition, when the amount of remaining bubbles is large, the amount of air bubbles that enters the inside of the liquid ejection head from the outside of the liquid ejection head due to gas permeation also tends to be increased.

In particular, in a case where a pump that sends liquid by changing its inner volume, such as a piezoelectric pump, is used as a circulation pump inside the liquid ejection head, when air bubbles inside the liquid ejection head enter the piezoelectric pump, there is a possibility that the pressure in a pump chamber during a pump operation is changed, and changes in the discharge flow rate occur. Accordingly, there is a concern that the circulation flow rate in the circulation flow path is changed and poor ejection occurs. For this reason, it is extremely important to efficiently remove bubbles remaining in the liquid ejection head, and to adopt a configuration that makes it difficult for air bubbles to flow into the pump chamber.

In addition, a configuration that can efficiently remove bubbles remaining inside the liquid ejection head can suppress pressure changes inside the liquid ejection head when residual bubbles are expanded due to environmental changes. Therefore, the above-described configuration capable of efficiently removing bubbles is a configuration effective for stably driving the liquid ejection head including a pressure-adjusting unit.

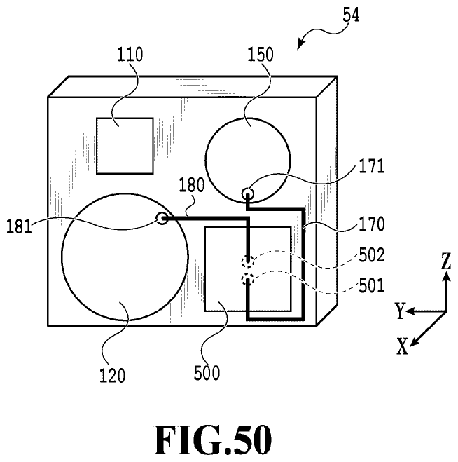

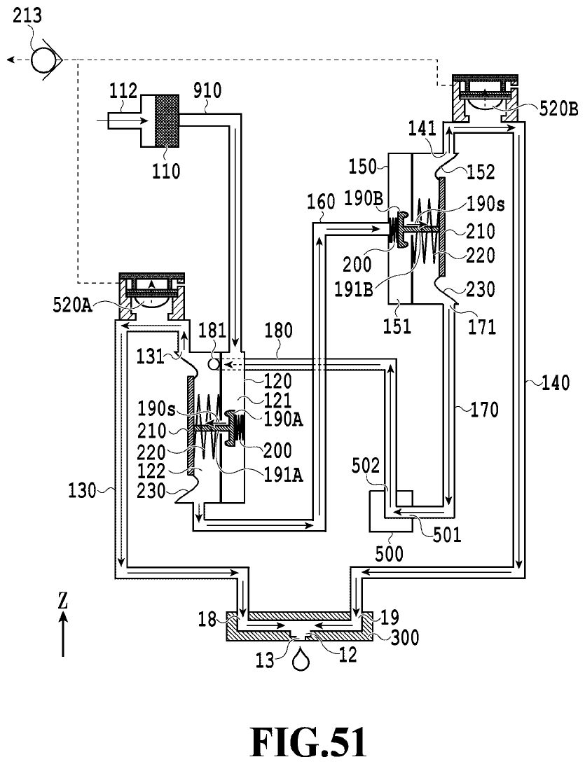

FIG. 50 is a diagram for simply explaining the configurations of flow paths in the circulation unit 54 in the first embodiment. To make the configuration easier to understand, FIG. 50 shows the pump outlet flow path 180 connecting the circulation pump 500 and the first pressure-adjusting unit 120, and the pump inlet flow path 170 connecting the circulation pump 500 and the second pressure-adjusting unit 150. FIG. 51 is a vertical cross-sectional view schematically showing a circulation path constituted in the liquid ejection head 1 in the present embodiment.

When the circulation unit 54 is initially filled with ink, bubbles remain in the first bubble reservoir chamber 520A and the second bubble reservoir chamber 520B in an amount corresponding to the degree of decompression in the depressurized state due to the suction operation. In addition, the first bubble reservoir chamber 520A and the second bubble reservoir chamber 520B contain air bubbles that enter the liquid ejection head from the outside due to the gas permeation described above, air bubbles that get mixed into the flow path when the ink tank 2 is replaced, and dissolved bubbles that accompany an increase in the liquid temperature around the ejection port 13 during printing and temperature adjustment. Such air bubbles and other unexpected bubbles are trapped, due to the influence of buoyancy, in an upper portion of the first pressure control chamber 122 and in the first bubble reservoir chamber 520A, and in an upper portion of the second pressure control chamber 152 and in the second bubble reservoir chamber 520B.

In the configuration in the first embodiment, a second pressure control chamber-side inlet 171 of the pump inlet flow path 170 is arranged vertically above the pump supply hole (a second opening on the pump side) 501. This makes it difficult for bubbles that have entered the second pressure-adjusting unit 150 along the flow during ejection or the like to flow into the circulation pump 500 due to the influence of buoyancy. Furthermore, in the first embodiment, a first pressure control chamber-side connecting portion 181 located on a downstream end of the pump outlet flow path 180 is arranged vertically above the pump discharge hole 502. Accordingly, even if air bubbles enter the circulation pump 500, the air bubbles can be discharged to the pump outlet flow path 180 without being accumulated inside the circulation pump 500.

In addition, in order to make it difficult for air bubbles trapped in the second bubble reservoir chamber 520B to flow into the circulation flow path, it is desirable that a discharge port 141 located at an upstream end of the first collecting flow path 140 is arranged vertically above the second pressure control chamber-side inlet 171. In addition, in order to prevent air bubbles that have entered the second pressure control chamber 152 through the communication port 191B from heading toward the pump inlet flow path 170, it is desirable that the communication port 191B is arranged vertically above the second pressure control chamber-side inlet 171. In addition, it is desirable that the connection portion of the bypass flow path 160 that connects to the second pressure control chamber is located vertically above the first pressure control chamber-side connecting portion 181. Furthermore, it is desirable that the connecting portion of the third supply path 910 that connects to the first pressure control chamber is located vertically above the first pressure control chamber-side connecting portion 181.

In addition, when air bubbles reach the second pressure control chamber-side inlet 171, the bubbles form a meniscus at an inlet portion of the pump inlet flow path 170. When the inlet shape and the cross-sectional shape of the pump inlet flow path 170 are circular, a meniscus is formed on an entire surrounding wall surface, gas and liquid are separated in the circulation direction, and the possibility is increased that bubbles move along the flow toward the circulation pump 500. However, when corner portions are provided in the inlet shape and cross-sectional shape of the pump inlet flow path 170, it becomes difficult for a meniscus to be formed at the corner portions, and a path for liquid is created next to the air bubbles, and the possibility is increased that the bubbles that are subject to buoyancy remain at the inlet portion. Therefore, it is desirable that the shape of the second pressure control chamber-side inlet 171 and the cross-sectional shape (the shape of an inner wall) of the pump inlet flow path 170 have one or more corner portions.

In addition, also in the event that bubbles flow into the circulation pump 500, the first pressure control chamber-side connecting portion 181 located at the downstream end of the outlet flow path 180 is arranged vertically above the pump discharge hole 502, so that the bubbles head toward the pump discharge hole 502 due to the influence of buoyancy and the force exerted by the flow. Accordingly, air bubbles can be discharged to the outlet flow path 180 without being accumulated inside the circulation pump 500. Then, the air bubbles discharged from the outlet flow path 180 enter the first pressure control chamber 122, rise due to buoyancy, and flow into the supply flow path 130 (inside the common flow path) through the supply hole 131 provided in an upper portion of the first pressure control chamber 122. Thus, it is desirable that the supply flow path 130 communicate with means for discharging air bubbles. Here, the first bubble reservoir chamber 520A is provided in the supply flow path 130. In the present embodiment, the first bubble reservoir chamber 520A and the second bubble reservoir chamber 520B or the ejection ports 13 are provided as the means for discharging air bubbles as described above.

In addition, in order to introduce air bubbles into the means for discharging air bubbles, it is desirable that the supply hole 131 located at the upstream end of the supply flow path 130 is arranged vertically above the first pressure control chamber-side connecting portion 181 in the first pressure control chamber 122. In addition, in order to prevent the pressure-adjusting spring 220 from hindering the floating of air bubbles discharged from the outlet flow path 180, it is desirable that the first pressure control chamber-side connecting portion 181 is arranged vertically above the communication port 191A. Furthermore, in order to further improve the bubble-removing performance in the circulation pump 500 by aligning the direction of the force that the air bubbles receive due to the flow with the direction of the force that the air bubbles receive due to buoyancy, it is desirable that the pump discharge hole 502 is arranged vertically above the pump supply hole 501.

It should be noted that the outlet flow path 180, which is the first flow path, may be a flow path that connects the circulation pump 500 and the first pressure control chamber 122, and may include the other liquid chambers between the circulation pump 500 and the first pressure control chamber 122. Similarly, the pump inlet flow path 170, which is the second flow path, may be a flow path that connects the circulation pump 500 and the second pressure control chamber 152, and may include the other liquid chambers between the circulation pump 500 and the second pressure control chamber 152.

In addition, the use state of the liquid ejection head in this specification refers to a state in which printing can be performed on a printing medium by ejecting liquid from the liquid ejection head.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-063927, filed Apr. 8, 2025, which is hereby incorporated by reference herein in its entirety.

What is claimed is:

1. A liquid ejection head comprising:
ejection ports for ejecting a liquid;
a pressure chamber that communicates with the ejection ports, and applies pressure to the liquid ejected from the ejection ports;
a first liquid reservoir chamber that communicates with the pressure chamber;
a second liquid reservoir chamber that communicates with the pressure chamber at a position different from the first liquid reservoir chamber; and
a pump that is arranged in a circulation path including the pressure chamber, the first liquid reservoir chamber, and the second liquid reservoir chamber, and that circulates the liquid in the circulation path,
the circulation path including a first flow path connecting the pump and the first liquid reservoir chamber, and a second flow path connecting the pump and the second liquid reservoir chamber,
wherein in a used state of the liquid ejection head, a first connection portion connecting the first flow path and the first liquid reservoir chamber is located vertically above a second connection portion connecting the first flow path and the pump, and a third connecting portion connecting the second flow path and the second liquid reservoir chamber is located vertically above a fourth connecting portion connecting the second flow path and the pump.

2. The liquid ejection head according to claim 1, wherein the pump circulates the liquid through the pressure chamber by suctioning the liquid from the second flow path and discharging the liquid to the first flow path.

3. The liquid ejection head according to claim 2, wherein the second connecting portion is located vertically above the fourth connecting portion.

4. The liquid ejection head according to claim 2, further comprising:
a first air bubble discharging unit that communicates with the first liquid reservoir chamber and discharges air bubbles,
wherein a fifth connecting portion connected to the first liquid reservoir chamber in a third flow path that connects the first air bubble discharge unit and the first liquid reservoir chamber is located vertically above the first connecting portion.

5. The liquid ejection head according to claim 2, further comprising:
a second air bubble discharging unit that communicates with the second liquid reservoir chamber and discharges air bubbles,
wherein a sixth connecting portion connected to the second liquid reservoir chamber in a fourth flow path that connects the second air bubble discharging unit and the second liquid reservoir chamber is located vertically above the third connecting portion.

6. The liquid ejection head according to claim 2, further comprising:
a bypass flow path that connects the first liquid reservoir chamber and the second liquid reservoir chamber without passing through the pressure chamber or the pump,
wherein a seventh connecting portion connected to the second liquid reservoir chamber in the bypass flow path is located vertically above the third connecting portion.

7. The liquid ejection head according to claim 1, wherein the first liquid reservoir chamber communicates with a liquid supply source capable of supplying the liquid to the circulation path, and
a connecting portion connected to the first liquid reservoir chamber in a fifth flow path that connects the liquid supply source and the first liquid reservoir chamber is located vertically above the first connecting portion.

8. The liquid ejection head according to claim 1, wherein the first liquid reservoir chamber includes a first valve in the first liquid reservoir chamber, and the first connection portion is located vertically above a communication port that is opened and closed by the first valve.

9. The liquid ejection head according to claim 1, wherein the second liquid reservoir chamber includes a second valve in the second liquid reservoir chamber, and a communication port opened and closed by the second valve is arranged vertically above the third connecting portion.

10. The liquid ejection head according to claim 1, wherein a shape of an inner wall of the third connecting portion is a shape that includes at least one corner portion.

11. The liquid ejection head according to claim 10, wherein a cross-sectional shape of an inner wall of the second flow path is a shape that includes at least one corner portion.

12. The liquid ejection head according to claim 1, wherein the pump is a piezoelectric pump that is driven by an operation of a piezoelectric element.

13. The liquid ejection head according to claim 1, wherein the first liquid reservoir chamber includes a first pressure-adjusting unit that adjusts pressure in the circulation path connecting the first liquid reservoir chamber and the pressure chamber.

14. The liquid ejection head according to claim 1, wherein the second liquid reservoir chamber includes a second pressure-adjusting unit that adjusts pressure in the second flow path.

15. The liquid ejection head according to claim 1, wherein the liquid ejection head is a serial-type liquid ejection head that performs printing by ejecting the liquid from the ejection ports while moving.

16. A liquid ejection apparatus comprising:
a liquid ejection head including
ejection ports for ejecting a liquid,
a pressure chamber that communicates with the ejection ports, and applies pressure to the liquid ejected from the ejection ports,
a first liquid reservoir chamber that communicates with the pressure chamber,
a second liquid reservoir chamber that communicates with the pressure chamber at a position different from the first liquid reservoir chamber, and
a pump that is arranged in a circulation path including the pressure chamber, the first liquid reservoir chamber, and the second liquid reservoir chamber, and that circulates the liquid in the circulation path,
the circulation path including a first flow path connecting the pump and the first liquid reservoir chamber, and a second flow path connecting the pump and the second liquid reservoir chamber,
wherein in a used state of the liquid ejection head, a first connection portion connecting the first flow path and the first liquid reservoir chamber is located vertically above a second connection portion connecting the first flow path and the pump, and a third connecting portion connecting the second flow path and the second liquid reservoir chamber is located vertically above a fourth connecting portion connecting the second flow path and the pump;
a carriage that is mounted with the liquid ejection head, and moves in a first direction relative to a printing medium; and
a convey unit that conveys the printing medium in a second direction intersecting the first direction,
wherein the liquid ejection apparatus can perform printing on the printing medium by repeating main scanning in which the carriage is moved in the first direction while ejecting the liquid from the liquid ejection head and a conveying operation by the convey unit.
